(19) United States
(12) Patent Application Publication
(10) Pub. No.: US 2008/0144864 A1
(43) Pub. Date: Jun. 19, 2008

(54) Audio Apparatus And Method

(75) Inventor: Graeme John Huon, Vic (AU)

Correspondence Address: BROOKS KUSHMAN P.C., 1000 TOWN CENTER, TWENTY-SECOND FLOOR, SOUTHFIELD, MI, 48075, US

(73) Assignee: HUONLABS PTY LTD, Mt. Waverley, VIC (AU)

(21) Appl. No.: 11/569,624

(22) PCT Filed: Dec. 22, 2004
(86) PCT No.: PCT/AU2004/001799

§ 371 Date: Mar. 5, 2007

(30) Foreign Application Priority Data
May 25, 2004 (AU) 2004902791
Jun. 25, 2004 (AU) 2004903458

(51) Int. Cl. H04R 5/02; H04R 29/00

(52) U.S. Cl. 381/305; 381/58

(57) ABSTRACT

The invention enables the capture of sound fields with coding and efficient distribution of electrical signals representing the sound fields for subsequent reproduction in a listening environment utilising pairs of non-equidistant apparatus in various defined configurations such that the acoustic distance as well as direction of sound sources is consistently presented with regard to in front of, behind, beside or below from a listening point anywhere in the listening environment and for any listener orientation, thus making the whole listening area a sweet spot and enabling true shared audio experiences, without the need for worn apparatus. New apparatus and methods for capture, distribution and reproduction or render are also disclosed that enable enhanced perception of captured and reproduced sound for shared experiences with both common and individual capture and reproduction apparatus and new communications and control methods and apparatus for multiple users including heightened perception capability and also improved security aspects are also disclosed.

### BACKGROUND OF THE INVENTION

The evolution of sound recording, editing, transmission and reproduction has been driven by the need for the fidelity of the reproduced sound images to approach that of the original reality as observed at the vantage point, and ideally also providing shared audio experiences for multiple listeners as in reality wherein each observer simultaneously receives a different audio perspective based on location, orientation and movement. Over the past 100 years, much progress has been made in the technologies of capture, editing, transmission and reproduction, largely based on the work of Lord Rayleigh in the art defining a human perception model based on time and intensity differences between the listeners' ears. This model and its more recent extensions does not allow for the reproduction of sounds at a set location in space particularly having attributes of perceived distance of sound sources. Consequently, most work in the art has concentrated on delivery of direction clues and primarily through the use of equidistant reproduction equipment and surround sound formats of the art and with the term “surround” being synonymous with an equidistant format including the apparatus of stereo, quad, 5.1, 10.2 and the like and also for the reproduction format of so-called wave field synthesis. For the great majority of these formats the perception of distance is then conveyed by immersive effects such as direct to reverberant sound ratio, known source scaling and attenuation of high frequencies with distance, and terms including ‘immmersiveness’, ‘spatialised’, ‘having openness and airiness’ and the like are used to describe the resulting valid effects. Much work has been done in the art on apparatus and methods creating, capturing or using these effects.

As background to this invention, the commercially private study of human perception of real sound sources by the inventor over many years has revealed necessary extensions to this model to explain the reproduction of sound as perceived by humans and other binaural creatures that has enabled a significant and widely impacting advance the true fidelity or realism of sound reproduction as indicated above thus enabling reproduced sound to be more realistic and further to more directly utilise the human perceptual capabilities evolved over millennia of survival.

In essence, the human has each ear being the combination of the in-head apparatus and the external pinna, head structure, and torso as an apparatus being able to determine direction of real-world sounds having suitable spectral energy profile, the two ears in co-operation with the brain then being able to perceive distance as well as the direction of sounds over a wide range as a learnt experience refreshed daily.

A simple verification of this capability can be had by any listener and with no additional apparatus being required by using finger clicks around the head as a complex source and by blocking and unblocking one ear canal. The blocking of one ear canal destroys the distance perception aspect but the listener retains the directional aspect with the remaining ear. The inventor has been surprised by the apparent widespread lack of awareness of this capability by those in the art, and certainly the widespread lack of apparatus utilising these capabilities.

Said extensions have initiated the development of a whole new and unique range of apparatus and methods herein disclosed, and providing a new basis for future work for those understanding the perceptual model extensions.

Aspects of the direct sound from the source, the early reflections and the reverberant sound field reaching the or each listener and the behaviour of the resulting overall sound field with any or all of these component parts as the listener turns and moves about can now be considered in the light of this extended model. The invention disclosure does this.

One further aspect of the background to the invention is the behaviour of low frequency sounds, said low frequency sounds being below the frequencies where the direction and distance is able to be perceived by the listener, fundamentally because of the relative size of the listener apparatus relative to the wavelengths of these sounds. The invention discloses apparatus that treats these components differently.

The effects used and apparatus so far developed in the art remain valid, the said invention moving on from this base to disclose new apparatus and methods.

### FIELD OF THE INVENTION

The invention relates to the capture, coding, editing transmission, and reproduction of complex arrays sound objects such that the reproduced sound field approaching the fidelity and behaviour of the original sound source field particularly with regard to multiple listeners and moving vantage points when subsequently reproduced and without the undesired need for personal apparatus

### SUMMARY OF THE INVENTION

An object of this invention is to enable the capture of sound fields, the efficient distribution of electrical signals representing the sound fields for subsequent reproduction in a listening environment such that the acoustic distance as well as direction of sound sources is consistently presented with regard to in front of, behind, beside or below.

A further object of the present invention is to enable the whole listening area to be a sweet spot in the art.

A further object of the invention is to reproduce sound that provides true shared audio experiences, each listener in the listening area perceiving a sound presentation or render that has a consistent perspective depending on their location and orientation even whilst moving.

A further object of the invention is to provide sound reproduction without the need for any apparatus being worn by the listener.

A further object of the invention is to provide an apparatus that provides reproduction of direct sound in the listening region including the listening area enabling both correct and consistent behaviour of all sounds for walk-around, walk-up, walk thorough walk within and walk away behaviour by each or all listeners.

A further object of the invention is to provide a flexible method of catering for any loudspeaker configuration in any listening environment or listening area independently of the format of the source signals.

A further object of the present invention is to provide a common efficient audio distribution format including sound signals and data about sound signals.

A further object of the present invention is to provide an apparatus that is compatible with existing formats including the equidistant formats and channel associated distribution such as with mono, stereo, 5.1, 6.1, 7.1, 10.2 and the like being suitable for reproduction of sound with and without accompanying pictures.

A further object of the invention is to enable flexible control over the availability and configuration of various formats including the delivery of distance based reproduction or render from the origin of the material being distributed, the point of use or combinations thereof.

A further object of the invention is to enable control over the configuration of various formats including the user or listener configuration of distance based reproduction or render made available from the origin of the material being distributed.

A further object of the invention is to enable automated configuration of the decoding for different listening bounded regions, rooms and listener area formats and layouts.

A further object of the invention is to enable point of use render (POUR).

A further object of the invention is to provide correct capture and reproduction of early reflections in the art for each or multiple listeners without the need for personal apparatus and thus making the whole listening area a sweet spot in the art.

A further object of the invention is to provide correct capture and reproduction of the reverberant sound field in the art for each or multiple listeners without the need for personal apparatus and thus making the whole listening area a sweet spot in the art.

A further object of the invention is to provide an apparatus that correctly reproduces the reverberant field of the source in any reproduction environment.

A further object of the invention is to provide active masking of the reproduction environment acoustic characteristics.

A further object of the invention is to provide a reproduction loudspeaker that is hard to locate even when walking around.

A further object of the invention is to capture and reproduce low frequency sound with control over the influence of the reproduction environment room modes.

A further object of the invention is to efficiently and effectively provide so-called mode free low frequency reproduction for one listener location

A further object of the invention is to provide simultaneous arrival of low frequency sound for large audiences in zoned areas and with overall reduction in low frequency mode influence.

A further object of the invention is to provide improved low frequency sound reproduction and with controlled emission of sound leakage.

A further object of the invention is to provide improved human perception of sounds and in particular alerts and priorities thereof in the near and far environment, said far environment including being well out of normal or unimproved hearing range.

A further object of the invention is to provide tools to analyse modes and boundary focussing of sounds and assist in placement of low frequency sound reproduction equipment to improve listener perceived performance.

A further object of the invention is to provide correct presentation of sounds generated by the or each listener in the acoustic of the reproduced source environment.

A further object of the invention is to provide listener apparatus that provides the perceptual benefits of the above objectives in any environment, and may include intensive percussive sound protection.

A further object of the present invention is to provide personal apparatus supporting all of the above perceptual objectives when the listener moves around un-tethered.

A further object of the invention is to provide the above perceptual benefits for two or more persons able to communicate whilst moving around un-tethered.

A further object of the present invention is to provide robust, secure, diverse efficient communications facilities supporting the above perceptual and delivered benefits.

### PRIOR ART

Sound recording and reproduction in the art has not recognised the role that distance perception plays in human acoustic source determination. As a result, prior art has concentrated on direction as the prime factor for sound recording and reproduction. This effort has logically led to the evolution of reproduction systems largely based on equi-distant formats such as stereo, 5.1, 10.2 and the like, wherein distance information is not considered. These prior art systems are characterised by a recording, distribution and reproduction chain wherein direction characteristics are captured, processed, distributed and presented to loudspeakers on the basis of strict channel correspondence. Such formats are characterised by one location win the listening area where the reproduction sound closest to that desired, this location being referred to as the sweet spot. Some attempts have been made to enlarge this effective area, but all such attempts have generally moved away from placement of sources by using reverberation effects and other such approaches. As the format of reproduction had a point of preferred listening, the reproduction loudspeaker apparatus was generally designed to uniformly deliver acoustic energy in one general direction, and today most loudspeakers remain assessed on the basis of their so-called on-axis frequency response. Some recent developments that went partly away from this approach include the wave-field synthesis approach, an advanced example of which is the work of the Fraunhofer Institute in Germany. The wave-field synthesis approach of the prior art utilises the principle of Huygens in the art wherein a wavefront can be everywhere characterised by the use of point waves at each point on the said wavefront. The apparatus and method of WFS utilises an encompassing array of loudspeakers to represent an expansive set of point from which to recreate the desired wave-fronts. The apparatus is therefore characterised by very large numbers of loudspeaker sources at reproduction and is still influenced by the equidistant or so-called surround concepts of the art wherein the arrayed loudspeakers are placed symmetrically on the boundary to the listening area and are thus again seen as apparatus equidistant from the centre of the listening area. The said WFS approach is also very audio processing-intensive as each loudspeaker used requires a separately processed stream of audio.

Further, WFS does not consider the issues of compatibility or of the requirements for the whole production chain including media creation and distribution and direct distribution. WFS presently uses available source material, channel associated distribution and proprietary processing platforms to place reproduced sounds in space.

For the recording aspect of general audio, many arrays and microphone configurations have been considered. Amongst these is the so-called soundfield microphone of Gerzon and Craven of UK which remains in widespread use. This apparatus internally used a common format of signals at the point of recording, but this common format was then immediately used to create channel associated equi-distant formats of the art for subsequent editing and distribution in channel associated form.

Other recent audio developments include Head Related Transfer Function render. HRTF again places sound in directions, not at distances and hence does not consider the wavefront divergence and convergence issues.

The discovery by the present inventor of the role distance perception plays in human hearing went part of the way to by identifying a new requirement for sound reproduction, and the invention of the apparatus and method of capture and reproduction herein described as non equidistant vector wavefront completed the capability.

In the field of early reflection reproduction, the nature of the said reflections has recently been further characterised but little work has been done on the correct placement and reproduction of early reflections, and certainly not for shared audio reproduction experiences.

In the field of reverberant field reproduction, all prior art found has concentrated on the processing of sounds for immersive effects delivered by means of equidistant or surround apparatus. The issues of correct reproduction whilst moving around have been tackled by some inventions relating to so-called electronic architecture but these invariably use multiple loudspeaker apparatus being fed discrete signals and using extensive electronic processing. None have developed an apparatus that can reproduce the reverberant characteristics of a source environment consistently in any reproduction environment including reverberant environments with their own characteristics, and none have developed an apparatus that efficiently reproduces the reverberant sound field from a single apparatus such that the apparatus cannot be located even when immediately adjacent to it as wound be the requirement for true reverberant field reproduction when moving around.

No single apparatus that can provide active room acoustic characteristics masking has been found.

For consistent low frequency reproduction, much discussion can be found on the use of multiple low frequency apparatus and their placement for statistically optimal reproduction is a zone or region, thus recently recognising that location for low frequency sound is important but none have determined the optimum requirements for placement and none have developed the necessary apparatus to assist with this placement or the appropriate source apparatus required to deliver sound with controlled influence of low frequency room modes in any reproduction environment.

None found have developed apparatus that can assist in the design of rooms for control of mode delivery to a listening area and none found have apparatus for delivery of simultaneous arrival low frequency reproduction for large audiences without personal apparatus, nor such apparatus used in zoned areas such as cinema floors, balconies and stalls simultaneously.

None found have developed an apparatus enabling the control over unwanted leaked low frequency sound in any building, said apparatus enabling zoned reproduction of low frequencies.

No common vector wavefront distribution format that suits all reproduction formats including surround systems being channel associated has been found, whether including metadata for authorisation control of format availability and configuration, parametric reverberation, parametric early reflection determination and controlled user configuration of placement, and certainly not including the ability to render sound sources in space with correct behaviour of beside, above, or in front of each other as perceived.

No capture or reproduction apparatus or method that supports the ability to render sound sources in space with correct-behaviour of beside, above, or in front of each other as perceived has been found whether or not using vector wavefront distribution format suiting all reproduction formats including surround systems being channel associated has been found, whether including metadata for authorisation control of format availability and configuration, parametric reverberation, parametric early reflection determination and controlled user configuration of placement.

No personal reproduction apparatus or method that supports the ability to render sound sources in space with correct behaviour of beside, above, or in front of each other as perceived has been found whether or not using vector wavefront distribution format suiting all reproduction formats including surround systems being channel associated has been found, whether including metadata for authorisation control of format availability and configuration, parametric reverberation, parametric early reflection determination controlled user configuration of placement or percussive sound protection in any environment for the listener or user.

No apparatus has been found that enables the render of intentional or unintentional sounds made by the or each listener into the acoustic of the presented scene for consistent perception by the or each listener in the listening area with regards to early reflections, reverberant field and said placement with regard to beside, in front of or above.

No apparatus to provide the above personal apparatus and perceptual capability for sharing between multiple users whether un-tethered or tethered has been found.

No enhanced personal perception apparatus that enables easily interpreted human perception of sounds and in particular alerts and priorities thereof in the near and far environment, said far environment including being well out of normal or unimproved hearing range has been found. The microphone art includes a wealth of apparatus for capturing sound fields but almost all target the equidistant formats of the art for reproduction and are thus are non-contentious. The patents of Gerzon covering the soundfield microphone apparatus and the B format in particular provide a more general capability in the apparatus and method (Gerzon, U.S. Pat. No. 5,757,927 May 1998; U.S. Pat. No. 3,997,725; December 1976; U.S. Pat. No. 4,414,430, November 1983; U.S. Pat. No. 4,151,369 April, 1979; and U.S. Pat. No. 4,095,049 June, 1978, and Craven et al. U.S. Pat. No. 4,042,779 August, 1977) These generally disclose specific microphone and related apparatus interpreted for reproduction on specific configurations of loudspeakers being equidistant and make no claims with regard to capturing distance of the or each sound source for subsequent reproduction even though their apparatus may or may not do so, but restricting claims to capturing the plurality of sources correctly with regard to directional encoding which is claimed.

The patents of McGrath U.S. Pat. No. 6,259,795, July, 2001; utilises direction only and particularly U.S. Pat. No. 6,628,787 September 2003 consider direction and head related transfer functions (HRTF) thereof.

The term spatilised or spatial in the audio art is taken to specifically mean placed in a direction, and in some but not all cases adding the interpretation qualification that the perception is outside the head. The terms do not mean placed at a specific or controllable distance, though this interpretation can be hard to discern from the descriptions and claims of the art. Examples of spatialised apparatus and method so constrained include Rimell, U.S. Pat. No. 6,694,033 February 2004 wherein the existence of a single sweet spot claim precludes the invention, and the claims on location are restricted to being away from the reproducing loudspeakers and not claimed to be able to be placed at a specific distance and direction.

Some loudspeaker apparatus for sound projection and de-correlation treatment exists but such apparatus are of limited frequency range capability, or require long range listener distances such as in the case of Belisle U.S. Pat. No. 4,776,4128, October, 1988.

The personal apparatus found in the art also does not consider the render of distance information nor does the art consider an intentionally non-equidistant reproduction apparatus for each ear. Kim, U.S. Pat. No. 6,817,440 November, 2004; Greuzand et al. February 1974; Fixler, U.S. Pat. No. 3,609,240; September, 1971, Yoshimura U.S. Pat. No. 3,984,885 October 1976, Hanson U.S. Pat. No. 3,900,707 August 1975, Turner U.S. Pat. No. 3,984,636, October 1976; Fosgate U.S. Pat. No. 5,301,237, April 1994 and Myers, U.S. Pat. No. 4,817,149, March 1989 are selected examples of the generally equi-distant format utilising two or more electro-acoustic apparatus placed in front of and behind or generally around each ear with the intention of reproducing channel associated or channel derived sound conveying direction.

Encoders and decoders including Lowe et al. U.S. Pat. No. 5,046,097 September 1991; Lowe U.S. Pat. No. 5,105,462, April 1992; use equidistant reproduction apparatus and make no claim on actual distance of recreated sound objects but do allude to this using the term ‘spatialised’. Melchoir, WO 2004/073352, August 2004 use wave field synthesis techniques which are still generally equidistant.

Gefvert U.S. Pat. No. 5,850,457 December 1998 and Goldfarb U.S. Pat. No. 5,764,777 June 1998; use reverberation effects to give a feeling of spaciousness or general immersive distance.

Apparatus supporting robust, secure, diverse efficient communications facilities, but none have been necessarily adapted to support the above perceptual and delivered benefits.

### DETAILED DESCRIPTION OF THE INVENTION

According to the said invention, An apparatus comprising an arrangement of electro-acoustic transducers for receiving sound and electronic equipment generating a set of mutually consistent electrical signals representing the divergence of a direct wave from an acoustic source as observed at a measuring point of occurrence in space, wherein said electrical signals specifically incorporate distance as well as direction data, said electrical signals being suitable for transmission, or storage and later transmission.

The apparatus according to claim 1, generating a set of mutually consistent electrical signals representing the divergence of the or each direct wave from the or each acoustic source as observed at the or each point of occurrence in space wherein said electrical signals specifically incorporate distance as well as direction data being suitable for later recreating the or each sources consistently.

The apparatus according to claims 1, or 2 generating a set of mutually consistent electrical signals representing the divergence of the or each direct wave from the or each acoustic source as observed at the or each point of occurrence in space wherein said electrical signals specifically incorporate distance as well as direction data being suitable for later recreating the or each source consistently when listened to from a defined listening area.

The apparatus according to claims 1, 2, or 3, generating a set of mutually consistent electrical signals representing the divergence of the or each direct wave from the or each acoustic source as observed at the or each point of occurrence in space wherein said electrical signals specifically incorporate distance as well as direction data being suitable for later recreating the or each source consistently when the reproduction apparatus is not necessarily at the or any point of origin of the original occurrence of the sound source, particularly with respect to distance.

A signal processing apparatus able to receive a set of mutually consistent electrical signals representing the divergence of a direct wave from an acoustic source as observed at a point of occurrence in space wherein said electrical signals specifically incorporate distance as well as direction data being suitable for recreating the or each source consistently, said signal processing apparatus being at or near the location of a point of use for reproduction of the or each source, particularly with regard to distance.

The apparatus according to claim 5 wherein multiple formats of source signals including channel associated sources such as but not restricted to stereo, 5.1, 6.1, 7.1, 10.2 in the art are also catered for.

The apparatus according to claim 5 wherein the signal source may be from a direct or on-line source in the art or may be from a local storage and retrieval system in the art such as CD, DVD, hard drive, flash drive or the like.

The apparatus according to claim 5 wherein operation can in part or totally be controlled by a form of source associated authorisation.

The apparatus according to claim 5 wherein the or each form of user control over a format of decoding is provided thus enabling control of placement of the acoustic sources to new vantage points in the listening area.

The apparatus according to claim 9 wherein user control over the decoding format is provided thus enabling the control of placement of the acoustic sources to form new vantage points in the listening area subject to being also controlled in part or totally by some form of source associated authorisation, having but not limited to the ability to operate without authorisation for channel associated decoding but requiring authorisation for paired electro-acoustic transducer decoding.

An apparatus able to create a set of formatted electrical signals by decoding a set of mutually consistent electrical signals representing divergence of a direct wave from an acoustic source at a point in space said formatted electrical signals representing the divergence of the or each direct wave being suitable for recreating the or each source consistently with a set of electro-acoustic transducers, said formatted electrical signals being produced in pairs with specified amplitude and phase between said pairs specifically for feeding to a set of electro-acoustic transducer pairs being of suitable form; and number of said electro-acoustic transducers, not directly linked to the number of source or distributed channels and not restricted in any manner other than to form said multiple pairs, but said decoding using the actual location of the electro-acoustic transducers in the reproduction environment in order to recreate the desired fields and reproduced source locations, and said channels being paired.

The apparatus according to claim 11 wherein multiple formats of source signals including channel associated sources such as but not limited to mono, stereo, 5.1, 6.1, 7.1, 10.2 of the art are also catered for.

The apparatus according to claim 11 wherein the signal source is from a direct on-line source or from a local storage and retrieval system in the art such as CD, DVD, hard drive, flash drive or the like of the art.

The apparatus according to claim 11 wherein operation can be controlled in part or totally by a source associated authorisation, having the ability to operate without authorisation for channel associated decoding but requiring authorisation for the paired decoding.

The apparatus according to claim 11 wherein a configuration of electro-acoustic transducers can be discovered and the decoding then configured for the number and layout of the electro-acoustic transducers or transducer pairs, subject to being also controlled in part or totally by some form of source associated authorisation, having but not limited to the ability to operate without authorisation for channel associated decoding but requiring authorisation for the paired electro-acoustic transducer decoding.

The apparatus according to claim 11 wherein a form of user control over the decoding is provided thus enabling the control of placement of the acoustic sources to form new or different vantage points in the listening area.

The apparatus according to claim 11 wherein user control over the decoding is provided thus enabling the control of placement of the acoustic sources to form new vantage points in the listening area subject to being controlled in part or totally by some form of source associated authorisation, having but not limited to the ability to operate without authorisation for channel associated decoding but requiring authorisation for the paired electro-acoustic transducer decoding.

The decoding apparatus according to claim 11 utilising pairs of electro-acoustic transducers such that the desired sound field is reproduced consistently as in the original source when viewed from anywhere in the listening area thus enabling shared audio experiences for multiple listeners over an extended listening area without a need for any personal apparatus and thus making the whole listening area a sweet spot in the art.

The apparatus according to claim 11, together with two or more pairs of electro-acoustic transducers placed in a reproduction environment optionally in association with a picture or image of defined extent; said apparatus and electro-acoustic transducer pair location preserving the source locations of sound when listened to anywhere in the listening area and with any listener orientation thus enabling shared audio experiences for multiple listeners over an extended listening area without a need for any personal apparatus and thus making the whole listening area a sweet spot in the art.

The apparatus according to claim 11, together with three or more pairs of electro-acoustic transducers placed within a reproduction environment in a region of space of defined extent said region containing an image or object, said apparatus, and electro-acoustic transducer pair placements preserving the source locations of sound when listened to from anywhere outside the said region and with any listener orientation, thus enabling shared audio experiences for multiple listeners over an extended area without the need for any personal apparatus and thus making the whole listening area a sweet spot in the art.

The apparatus according to claim 11, together with three or more pairs of electro-acoustic transducers placed outside a region in space so as to partition off the listening area in the centre of said region said region which may or may not contain any other image or object in addition to the or each listener, the apparatus, method and placement of the electro-acoustic apparatus preserving the source locations of sound and the acoustic horizon or vanishing point when viewed from anywhere inside the listening region and with any listener orientation thus enabling shared audio experiences for multiple listeners over an extended area without a need for any personal apparatus and thus making the whole listening area a sweet spot in the art.

A sound reproduction apparatus comprised of one electro-acoustic transducer so designed to present a uniform radiation of phase consistent acoustic energy to cover an intended listening area at all frequencies of interest, said electro-acoustic apparatus incorporating a controlled source size or aperture formed by active surface area of said electro-acoustic transducer directly, size of said aperture being set by the highest frequency of interest, said apparatus providing uniformly controlled reproduction over the listening area, enabling shared audio experiences for multiple listeners over an area without the need for any personal apparatus and thus making the whole listening area a sweet spot in the art.

The sound reproduction apparatus according to claim 22 comprising two or more said electro-acoustic transducers each intended to cover a specific range of frequencies said apparatus being so designed to present a consistent radiation of phase consistent acoustic energy over the extent of the intended listening area at all frequencies of interest, said system enabling shared audio experiences for multiple listeners over an extended listening area without the need for any personal apparatus and thus making the whole listening area a sweet spot in the art.

The sound reproduction apparatus according to claim 22 comprising one or more enclosed electro-acoustic transducers intended to cover a specific range of frequencies said apparatus so designed as to present a minimal acoustic obstruction to any similar unit placed behind or in front whilst maintaining uniformly controlled reproduction over the listening area enabling shared audio experiences for multiple listeners over an extended area without the need for any personal apparatus and thus making the whole listening area a sweet spot in the art.

A sound reproduction apparatus comprising the combination of an electro-acoustic transducer with an active surface referred to as a piston or cone in the art and a separate acoustic filter said acoustic filter comprising a cavity formed by the bounding of one side of the active surface by the said acoustic filter, said acoustic filter with an aperture being the only means of conveying sound, and of restricted dimensions so as to present a controlled source size in a desired acoustic radiation direction independently of the active surface size thus controlling the polar pattern of the acoustic energy radiation of the combined electro-acoustic transducer in each or all directions at all frequencies and in particular the highest frequency of interest, said apparatus may serve to increase the acoustic efficiency of the electro-acoustic transducer at certain frequencies and said acoustic filter providing a low pass filter function in the art thus reducing harmonic distortion products outside the range of frequencies of interest the desired overall frequency response maintained by an electrical equalisation circuit.

An electro-acoustic transducer apparatus comprising the combination of an active surface described as a piston or cone in the art, and an integral acoustic filter essentially comprising a cavity and an aperture being the only means of conveying sound, and being of restricted dimensions so as to present a controlled source size in each desired acoustic radiation direction thus controlling the polar pattern of acoustic energy radiation in all directions at all frequencies of interest and in particular the highest frequency of interest, whilst the acoustic filter acts as a low pass filter thus reducing harmonic distortion products outside the band of reproduction interest and may serve to increase the acoustic efficiency of the apparatus at certain frequencies whilst the desired frequency response is maintained by design of the electro-acoustic transducer and the acoustic filter design said design also using an external electrical equalisation circuit as required for the desired frequency response.

A sound reproduction apparatus wherein two or more of the apparatus according to claim 26 are used each covering a separate band of desired frequencies, said total output being maintained by a crossover circuit and an equalisation circuit in the art, said apparatus according to claim 26 being co-axially mounted and each forming part of the acoustic filter cavity and the aperture.

The sound reproduction device according to claim 22 wherein the operating frequency of interest is ultrasonic.

The sound reproduction device according to claim 22 wherein the operating frequency of interest is infrasonic.

A sound reproduction device comprised of two or more electro-acoustic transducers so configured to provide a uniform radiation of phase consistent acoustic energy over an extended listening area at all frequencies of interest and with minimum variations in level over the extent of the said listening area when all transducers are operated and enabling the operation of each said electro-acoustic transducer set independently.

The sound reproduction device according to claim 30 wherein the device is designed for mounting on a boundary surface thus utilising the images formed for coverage of the said listening area.

A sound reproduction device comprised of two or more electro-acoustic transducers so configured to provide a uniform radiation of phase consistent acoustic energy over a listening area in any direction from said device at all frequencies of interest and with minimum variations in level over the extent of the said listening area when all transducers are operated and enabling the operation of each said electro-acoustic transducer set independently.

The sound reproduction device according to claim 32 wherein the device is designed for mounting on a boundary surface thus utilising the images formed for coverage of the said listening area.

The sound reproduction device comprised of two or more electro-acoustic apparatus according to claim 25 so configured to provide a uniform radiation of phase consistent acoustic energy over an extended listening area at all frequencies of interest and with minimum variations in level over the extent of the said listening area when all transducer sets are operated and enabling the operation of each said electro-acoustic transducer set independently.

The sound reproduction device comprised of two or more electro-acoustic apparatus according to claim 26 so configured to provide a uniform radiation of phase consistent acoustic energy over an extended listening area at all frequencies of interest and with minimum variations in level over the extent of the said listening area when all transducers are operated and enabling the operation of each said electro-acoustic transducer set independently.

The sound reproduction device comprised of two or more electro-acoustic apparatus according to claim 27 so configured to provide a uniform radiation of phase consistent acoustic energy over an extended listening area at all frequencies of interest and with minimum variations in level over the extent of the said listening area when all transducers are operated and enabling the operation of each said electro-acoustic transducer set independently.

A control unit capable of decoding the appropriate signals for any or all of the apparatus according to any one of claims 30, 31, 32 33 34, 35 or 36.

A control unit capable of decoding the appropriate signals for any or all of the apparatus according to any one of claims 30, 31, 32 33 34, 35 or 36. from a common set of signals according to any one of claims 1, 2, 3 or 4.

A control unit capable of decoding the appropriate signals for any or all of the apparatus according to any one of claims 30, 31, 32 33 34, 35 or 36. from a common set of signals according to any one of claims 1, 2, 3 or 4, said control unit having a user interface enabling static or dynamic adjustment of the rendered sound characteristics.

A control unit capable of decoding the appropriate signals for any or all of the apparatus according to any one of claims 30, 31, 32 33 34, 35 or 36. from a common set of signals according to any one of claims 1, 2, 3 or 4, said control unit being fed a set of channel associated signals in the art, whether or not being transmitted, recreated or decoded by any electronic means in the art.

A sound reproduction device comprised of two electro-acoustic apparatus sets according to any one of claims 30, 31, 32 33 34, 35 or 36. configured to have at least three sectors and to provide a uniform radiation of phase consistent acoustic energy over an extended listening area at all frequencies of interest and with minimum variations in level over the extent of the said listening area when all transducers are operated and enabling the operation of each of the said three sectors of electro-acoustic transducer sets independently, together with a corresponding number of sound reproduction devices according to any one of claims 22, 23, 24, 25, 26 or 27 so placed to form electro-acoustic transducer set pairs about the apparatus according to claims 30, 31, 32 33 34, 35 or 36. and being placed in correspondence with each sector thereof, each said sound reproduction device reproducing acoustic wave-fields for sound objects that are everywhere consistent for the or each listener of at any location and for any orientation in the said listening area without any worn apparatus being required for the or each listener.

The electro-acoustic device according to claim 41 wherein the consistent presentation of the direct sound of the or each reproduced acoustic object in space throughout a listening environment for the or each listener in all directions at all frequencies of interest is maintained in front of, when passing and behind any of the or each electro-acoustic apparatus without the need for any worn apparatus for the or each listener.

The electro-acoustic device as described in either of claims 41 or 42 wherein the consistent presentation of the direct sound of the or each reproduced acoustic object in space throughout a listening environment for the or each listener in all directions at all frequencies of interest is maintained with a minimum of six sectors, said apparatus capable of providing uniform sound radiation pattern in all directions of interest or to all locations in the listening area.

The electro-acoustic device as described in either of claims 41 or 42 wherein the consistent presentation of the direct sound of the or each reproduced acoustic object in space throughout a listening environment for the or each listener in all directions at all frequencies of interest is maintained with a minimum of six sectors utilising one or more listening region boundaries including but not restricted to the floor and ceiling as well as walls, partitions or other structures and the meeting lines and points thereof to form the or each point source image.

A control unit capable of decoding the appropriate signals for render to any particular device described in any one of claims 41, 42, 43 or 44.

A control unit capable of decoding the appropriate signals for render to any particular set of devices described in any one of claims 41, 42, 43 or 44, said control unit being fed a common set of signals according to claim 1.

A control unit capable of decoding the appropriate signals for render to any particular device described in any one of claims 41, 42, 43 or 44, said control unit having a user interface enabling static or dynamic adjustment of the rendered sound characteristics.

A control unit capable of decoding the appropriate signals for render to any particular device described in any one of claims 41, 42, 43 or 44, said control unit being fed a set of channel associated signals in the art, whether or not being transmitted, recreated or decoded by any electronic means in the art.

An audio electronic device that derives the parameters of location, specular and diffusive component parts and spectrum behaviour with time from measurement of an early reflection in a source environment in a format suitable for subsequent recreation or render at the point of use, said apparatus to be used with a signal processing device capable of reproduction of the direct sound of said early reflection placed in space in a listening environment for correct perception by a listener anywhere and at any orientation in a listener area without any worn apparatus being required for the or each listener.

An audio electronic device that combines the or each early reflection according to claim 1 for transmission and subsequent recreation or render at the point of use, with a signal processing device capable of reproduction of the direct sound of said early reflection placed in space in a listening environment for correct perception by a listener anywhere and at any orientation in a listener area without any worn apparatus being required for the or each listener.

An audio electronic device that derives parameters of early reflection with regard to location, specular and diffusive directional component parts and spectrum behaviour with time by using measurements of the considered environment for transmission and subsequent recreation or render at the point of use, with a signal processing device capable of reproduction of the direct sound of said early reflection placed in space in a listening environment for correct perception by a listener anywhere and at any orientation in a listener area without any worn apparatus being required for the or each listener.

The electronic apparatus for transmission of parameters according to claim 51, for subsequent recreation or render at the point of use, with a signal processing device capable of reproduction of the direct sound of said early reflection placed in space in a listening environment for correct perception by a listener anywhere and at any orientation in a listener area without any worn apparatus being required for the or each listener.

A parameterised early reflection produced by claims 51 or 52.

An acoustic apparatus placing and rendering the early reflection as a reproduced acoustic object placed anywhere in space throughout a listening environment according to the parameters of the or each early reflection each said object to be correctly perceived by a listener anywhere in a listening area and at any orientation without any worn apparatus being required for said listener.

An acoustic apparatus whereby regions of predominantly divergent or convergent acoustic field particle velocity in one direction in a sound field can be indicated at any particular frequency of interest by movement of the said apparatus in the sound field, said apparatus indicating with a suitably varying display.

An apparatus using two or more point microphone elements in the art and suitable electronics, said microphone elements being separated by a suitable distance and associated electronic signal processing of the pressure related signals therefrom to determine the nature of the sound field particle velocity in a listening area along the line between the microphone elements and in particular the divergent or convergent or gradient nature and indicate when the gradient nature is minimised thus showing alignment of the general axis of the microphones with a line of pure convergence or divergence of the field, said electronic processing analysing the phase of the two signals in a predominantly differential fashion as well as the amplitude in a predominantly scalar fashion.

The method of use of the apparatus according to claim 56 to determine the location of predominantly convergent or divergent field locations at the or each frequency of interest in a listening area by use of the apparatus to inspect the region of the sound field both by varying location and orientation until the appropriate condition is indicated, said location being indicated when predominantly convergent or divergent and also including node or anti-node points related to forward and reflected acoustic energy of the sound field, and said apparatus locating said node or anti-node points at the corresponding frequency.

The combination of two or more apparatus according to claim 57 in a new apparatus to locate the intersection of two or more lines of general convergence or divergence at a particular frequency in a listening area, said point of intersection defining said node or anti-node point without the need to inspect the field by rotation of the apparatus of claim 57, but using the said new apparatus for inspection predominantly by translation or translocation.

The combination of two or more apparatus according to claim 57 in a new apparatus to locate the intersection of two or more lines of general convergence or divergence at a particular frequency in a listening area, said point of intersection defining said node or anti-node point without the need to inspect the field by rotation of the apparatus of claim 58, but using the said new apparatus for inspection predominantly by translation or translocation. and wherein one or more microphone elements are common to more than one apparatus of claim 57 in the said new apparatus.

The use of a particle velocity microphone element in the art including but not limited to the broadband differential hot wire technology in the art and suitable electronics in an apparatus to directly determine the alignment of particle velocity maxima or more particularly minima in the sound field by inspection of the region of the sound field in a listening area by varying both location and orientation of the said microphone until the appropriate condition is indicated, said alignments being orthogonal to node or anti-node lines related to forward and reflected acoustic energy of the sound field, and said apparatus locating said predominantly convergent or divergent gradient lines and said points also including node or anti-node points at the corresponding frequency by translation and rotation by means of the varying display.

A method of utilising the or each sound field gradient apparatus of any one of claims 57, 58, 59, or 60 to locate the corresponding predominantly convergent sound field location of a sound field created by the or each low frequency loudspeaker in a listening area and having its initial or early or early reflected wave focused by the or each barrier to sound of the listening area.

A method of utilising the or each sound field gradient apparatus of any one of claims 57, 58, 59, 60 or 61 to find the appropriate location for the or each woofer to ensure a corresponding predominantly convergent sound field at a desired listening location in the listening environment created by the low frequency loudspeaker in a listening area and having its initial or early or early reflected wave focused by the barrier to sound of the listening area to best deliver a convergent or divergent sound field to the desired listening area said method also utilising sound field reciprocity of the art.

An electronic apparatus to model the wave focussing effect of the boundaries of a listening area and determine the early sound field wave delivery to any point or through any region in space with time and to alter improve or otherwise optimise the wave delivery to any point or region in time and space in the listening region by variation of the nature and geometry of the listening area boundaries.

An apparatus and method for determining low frequency acoustic loss in or from an acoustically bounded listening area by comparison of the modelled theoretical energy of the focussing of the early sound field wave at the listening location by the boundaries using the apparatus according to claim 65 compared to the measured coupling utilising the sound field gradient apparatus of claims 57, 58, 59, 60 and 61 to find the appropriate location for the or each woofer to ensure a corresponding predominantly convergent sound field at a desired listening location in the listening environment created by the or each low frequency loudspeaker in a listening area and having its initial wave focused by the or each barrier to sound of the listening area to best deliver a convergent or divergent early sound field to the desired listening area said method also utilising sound field reciprocity of the art, and said loss being represented by the difference between theoretical and measured.

An apparatus and method for minimising the influence of room modes of the art on the reproduction of low frequency sound whereby the listening location, the low frequency loudspeaker location and the spatial presence of room modes are changed so as to provide minimal influence of the room modes at the desired listening location, said apparatus comprising the each or several of the claims 57, 58, 59, 60 and 61, and the modelling apparatus comprising the apparatus of claim 60, recognising that the wave focusing of the early sound from the loudspeaker to the listening location by the listening area reflecting boundaries is independent of the listening area boundary mode locations even though the room mode locations at all frequencies and the wave focussing effect at all frequencies are both primarily controlled by the listening area boundaries.

A low frequency loudspeaker reproduction apparatus comprising a plurality of electro-acoustic transducers with associated enclosures presenting an equivalent acoustic source size less than or equal to the intended target listening area within a bounded listening environment, said environment having rigid reflecting acoustic boundaries, the combination so designed that the location of the target listening area and the location of the equivalent woofer source are placed as near as practically possible to be linearly radially equidistant from the gas centroid of the said bounded listening environment as calculated in the art.

A low frequency loudspeaker reproduction apparatus and method comprising a bounded listening environment having rigid reflecting acoustic boundaries so designed that the desired listening area and the desired woofer location are placed as near as practically possible to be linearly radially equidistant from the gas centroid of the said bounded listening environment, said design of the listening apparatus being such to avoid room modes in the listening area over the range of desired frequencies of reproduction by the said woofer.

A low frequency loudspeaker reproduction apparatus that largely eliminates room modes in the reproduction environment comprising a bounded listening environment having largely rigid reflecting acoustic boundaries so shaped and placed by design that some focusing of the early arrival sound from the low frequency loudspeaker source to the listening area occurs and using the centroid method of claims 67 and 68 for source and listening area location and where the low frequency loudspeaker source is fed a signal that is initially the desired sound to be reproduced and then uses suitable signal processing to create a time delayed signal that annihilates the on-reflected wave returning from the listening environment to the low frequency loudspeaker source after two propagation periods by the means of anti-phase signal of suitably scaled magnitude and phase, said apparatus removing most acoustic energy from the reproduction environment prior to the formation of excited room modes.

A low frequency loudspeaker reproduction apparatus that largely eliminates room modes in the reproduction environment comprising a bounded listening environment having a largely rigid reflecting acoustic boundary for the boundary opposite the loudspeaker sources, said loudspeaker sources so designed and arrayed to produce a largely plane wave low frequency sound field over all of the reproduction environment including the target listening area, said sound field propagating past all listeners and returning to the source loudspeaker array as a largely planar wave which is then annihilated by suitable signal processing after two propagation periods, thus effectively reducing or eliminating the influence of room modes.

An apparatus according to claim 69 wherein the source is the ceiling or roof and the reflecting boundary is the floor, the or each listener seated or standing in the listening area thus receiving two passes of the low frequency wave in quick succession below the level of temporal perception of the waves as separate events and all listeners receiving simultaneous arrival of the wave field, the arrival time of which can also be adjusted by the apparatus controlling the annihilation.

An apparatus according to claim 69 wherein the listening environment is zoned, with each zone having its own ceiling source array and floor as reflector, the listener seated or standing in the zoned listening area thus receiving two passes of the low frequency wave in quick succession below the level of temporal perception of separate events and all listeners in each zone receiving simultaneous arrival of the wave field, the arrival time of which can also be adjusted independently for each zone by the apparatus controlling the annihilation for each zone separately, thus enabling simultaneous arrival for all zones.

An apparatus and method according to claim 71 wherein the source array directional and wave-front creation and annihilation properties can be independently controlled by the feeding of separate suitably processed amplitude and phase signals from the controller separately adjusted for generation and annihilation.

An apparatus according to claim 72 wherein the round trip delay is automatically adjusted by the technique of timed test signal transmission and reception.

An apparatus according to claim 72 wherein the round trip delay is automatically adjusted by the technique of signal correlation in the art.

A loudspeaker apparatus comprising multiple electro-acoustic transducers each covering the same band of frequencies and said transducers mounted so as to couple the wave from one side of the electro-acoustic transducer active surface to a common chamber by whatever means, wherein a restriction in the form of an orifice is introduced in acoustic proximity to said active surface thus forming a chamber acoustically towards said active surface with respect to the said common chamber the combination forming a generally low-pass filter in the art so designed as to allow generally unrestricted alternating gas flow in the pass-band of the art towards the common chamber, said orifice then presenting a restriction to alternating gas flow in the art for said alternating gas flow from said active surface towards the, each or all other electro-acoustic transducer active surface accessing the common chamber being suitable for increasing the efficiency of the overall apparatus for the reproduction of sound in the desired pass-band.

A loudspeaker apparatus with multiple electro-acoustic transducers wherein the said transducers cover essentially the same band of frequencies and said drivers are mounted so as to couple the wave from one side of the electro-acoustic transducer active surface to a common chamber, whereon a restriction in the form of an orifice is constructed in acoustic proximity to said active surface as part of or added to each said driver to from a composite electro-acoustic transducer apparatus with a chamber acoustically towards said active surface with respect to the said common chamber said combination forming a generally low-pass filter in the art so designed as to allow generally unrestricted alternating gas flow in the pass-band towards the common chamber, said orifice then presenting a restriction to alternating gas flow in the art for said alternating gas flow from said active surface towards the other electro-acoustic transducer active surfaces accessing the common chamber being suitable for increasing the efficiency of the overall apparatus for the reproduction of sound in the desired pass-band.

A loudspeaker apparatus comprising two or more electro-acoustic transducers the or each said driver covering the same band of frequencies and said drivers mounted so as to couple the wave from one side of the electro-acoustic transducer active surface to a common chamber, the or each said electro-acoustic transducer being constructed of multiple independent or non-independent active surfaces whereon restrictions in the form of orifices are constructed in acoustic proximity to the active surface as part or added to each said transducer to form a composite electro-acoustic transducer apparatus with a chamber acoustically towards said active surface with respect to the said common chamber said combination forming a generally low-pass filter in the art so designed as to allow generally unrestricted alternating gas flow in the pass-band of the art towards the common chamber, said orifice then presenting a restriction to alternating gas flow in the art for said alternating gas flow from said active surface towards the, other electro-acoustic transducer active surface accessing the common chamber being suitable for increasing the efficiency of the overall apparatus for the reproduction of sound in the desired pass-band.

A loudspeaker apparatus comprising wholly or in part multiple electro-acoustic transducers, the or each said driver covering the same band of frequencies and said drivers mounted so as to couple the wave from one side of the electro-acoustic transducer active surface to a common chamber, wherein a restriction in the form of an orifice of generally restricted size relative to the said active surface and being the only access path for alternating gas flow is constructed in acoustic proximity to said active surface of the or each electro-acoustic driver as part or added to each said driver to from a composite electro-acoustic transducer apparatus with a chamber acoustically towards said active surface with respect to the said common chamber said combination forming a generally low-pass filter in the art so designed as to allow generally unrestricted alternating gas flow in the pass-band of the art towards the common chamber, said chamber being so constructed to use the method of gas centroids according to claims 68 and 69 to couple acoustic energy to the or each exit orifice from said chamber acoustically towards the listening area, wherein said gas centroid location so calculated is that for the said chamber being suitable for improving the efficiency and effectiveness of said apparatus over the desired frequency range.

Any combination of the apparatus according to claim 78 wherein an acoustic cascade of the or each said chamber in parallel or in series or in combinations of the art is used, each chamber entry and exit pair or combination using the method of gas centroids so claimed.

A low frequency electro-acoustic transducer having high particle velocity output wherein advantage is taken of a Helmholz resonator structure between one active surface and the listener area to greatly increase the effective delivered sound energy over a desired band of frequencies required by the program material in particular the overall frequency response being created at least in part by a-complementary electrical filter or equaliser of the art wherein the transfer function for the electro-acoustic apparatus response is factored by the denominator of the transfer function of the equaliser response, and said response being able to be exactly flat of the art across the desired band, said apparatus having any number of said electro-acoustic transducers and said apparatus achieving efficiencies of over 100 dB per watt measured at 1 metre in half space of the art in the desired low frequency band.

A loudspeaker apparatus according to any one of claims 75 to 80 wherein the electro-acoustic transducers are so placed relative to each other such that the net force on the overall apparatus from the movement of the or each active surface is intentionally minimised, conveying minimum net acceleration force to the enclosure or the overall apparatus or surroundings of the apparatus, minimising undesirable vibrations in the art.

A loudspeaker apparatus according to any one of claims 75 to 81 wherein the electro-acoustic transducers are so placed in pairs relative to each other such that the movement of the active surface of each active surface is opposing and net force on the overall apparatus from the movement of the or each active surface is thus intentionally minimised, conveying minimum net acceleration force to the enclosure or the overall loudspeaker or surroundings of the or each loudspeaker, minimising undesirable vibrations in the art.

The electro-acoustic transducer apparatus according to any one of claims 75 to 81 wherein the electro-acoustic transducer active surfaces are so placed relative to each other such that the net force on the overall said apparatus from the movement of the or each electro-acoustic transducer apparatus active surface is intentionally minimised, conveying minimum net acceleration force to the enclosure or the overall loudspeaker or surroundings of the or each loudspeaker, minimising undesirable vibrations in the art.

The electro-acoustic transducer apparatus of any one of claims 77 to 82 wherein the electro-acoustic transducer active surfaces are so placed in pairs relative to each other such that the movement of the active surface of each electro-acoustic transducer pair is opposing and net force on the overall apparatus from the movement of the active surfaces is thus intentionally minimised, conveying minimum net acceleration force to the enclosure or the overall loudspeaker or surroundings of the or each loudspeaker, minimising undesirable vibrations in the art.

The low frequency electro-acoustic transducer apparatus according to any one of claims 77 to 82 wherein the only means of overall output coupling into the bounded region including the listening area is by means of an aperture or orifice including but not restricted to a tube is intentionally of area less than that of the total active surface of the apparatus and is intentionally minimised, such minimisation changing the acoustic driving point impedance of the apparatus to be higher in acoustic impedance and thus more current source like and so providing more effective and consistent coupling of acoustic energy to the said bounded region, being less affected by variations in the or each presented load of the said bounded region.

The set of one or more devices containing apparatus of any one of claims 77 to 82 wherein the only means of overall output coupling into the bounded region including the listening area for each apparatus is by means of an aperture or orifice including but not restricted to a tube is intentionally of area less than that of the total active surface of each apparatus and each is intentionally minimised, such minimisation changing the acoustic driving point impedance of the apparatus to be higher in acoustic impedance and thus more current source like of the art and so providing more effective and consistent coupling of acoustic energy to the said bounded region, being less affected by variations in the presented load of the said bounded region.

The low frequency electro-acoustic transducer apparatus of any one of claims 77 to 82 wherein the other side of the active surface presents to a region outside the boundary of the bounded region including the listening area also by the apparatus according to any one of claims 77, 78, 79, 80, 81 and 82, but with the active surface acoustically towards the outside of the bounded region that includes the listening area is treated differently by means of intentionally increasing the size of the or each aperture or orifice including but not restricted to a tube and intentionally increasing the separation between any two such orifices such that the subsequent concentration of acoustic energy in the region outside the boundary of the bounded region including the listening area is minimised in any bounded region thereon according to either claims 68 or 69 relating to gas centroids of the or any region outside the boundary of the bounded region that includes the listening area, whilst still accurately preserving the total gas volume velocity in the art to be the same to both regions.

The low frequency apparatus including the electro-acoustic transducer apparatus and configuration according to claim 87, the bounded region including the listening area and all bounded regions outside the bounded region including the listening area that acoustically communicate with the active surface acoustically away from the listening environment wherein the acoustic impedance presented to the two said bounded regions is adjusted according to claims 86 and 87 such that the overall acoustic radiation due to leakage from the bounded regions is intentionally minimised and ultimately becomes zero away from all bounded regions by the method of cancellation in the art.

The acoustic apparatus comprising a set of half wave resonant structures of differing tuning and supporting an infinite series of resonant harmonic overtones, said resonant structures being so combined as to present an acoustic mismatch for each incident acoustic wave and so behaving as partially reflective whilst also behaving as partially transmissive in allowing part of the said acoustic wave to enter the structure and propagate there-through, and again behaving as partially reflective and partially transmissive in a frequency selective manner at the point of the incident acoustic wave subsequently leaving the apparatus, the overall effect including frequency dependent transmission and reflection components with the said impedance mismatch at the points of entry and exit being augmented by the interacting influence of the adjacent acoustic resonant structure and the rigid boundary parts there associated at the point of entry and exit for the said half wave resonant structure, said structures being in close proximity, and the resonances being related to the apparatus dimensions rather than any incident acoustic wave giving an amplitude and phase behaviour influence unrelated to the source, radiation from the or each half wave section acting as a source in itself placed at the location of the or each said half wave resonant section entry according to Huygen in the art, and being designed to provide the desired spectral and spatial acoustic energy distribution, and exit points and said half wave resonant structures being so designed as to avoid unwanted resonance behaviours in the desired band of frequencies of operation by suitably small choice of cross section dimension of the said resonant structures.

The apparatus according to claim 89 wherein the lengths and configuration of the half wave resonant structures is so chosen such that the overall spectral energy of the acoustic waves passing there-through and there-from is in accordance with the source wave but where the phase relationships of the original sound source are not preserved, the acoustic sound field emanating there-from being variously described as diffusive, dispersive, de-correlated, enveloping or immersing in the art.

The apparatus according to claim 90 wherein the various sections of half wave resonant structures are straight, bent, folded or curved.

The apparatus of claim 91 used in connection with other dispersive apparatus including but not restricted to quarter reflective diffusers, electronic multi-resonant panel loudspeaker apparatus and electronic signal processors providing dispersive effects in the art.

The apparatus according to claim 91 wherein the various lengths of the half wave acoustic resonators are so designed to have axial cross-sectional profiles that vary, chosen to provide the desired response.

Two or more of the apparatus according to claim 91 used in combination, such configuration being in series or in parallel or in combinations thereof with regard to the incident and propagated acoustic waves, said structure being designed to provide the desired spectral and spatial acoustic energy distribution and said dispersive combination being variously described as a leaky transmission line or structure or diffuser in the art.

The apparatus according to any one of claims 89, 90, 91, 92, 93 and 94, wherein the apparatus is so configured to take advantage of an acoustic reflective surface such as an environment boundary, said apparatus making use of the acoustic image thus created to provide the desired spectral and spatial response without the need for additional half-wave resonant structures.

A method of construction wherein a half wave resonant structure is made of suitable cross-section multi-tubular structure of circular, square, triangular or hexangular section and is fabricated or extruded in the art then shaped and cut to a profile that creates the desired spatial and spectral response, said ends of each resonant structure being either square or non-square cut profile and suitable end correction calculations being made for the resonant frequencies.

The apparatus according to claim 89 wherein the sound source is the or each electro-acoustic driver of suitable response capabilities described as a monopole source in the art and said apparatus is variously described as a diffusive source loudspeaker, diffusive loudspeaker, diffusive source or whiteroom loudspeaker.

The apparatus according to claim 91 wherein the sound source is an electro-acoustic transducer of suitable response capabilities described as a monopole source in the art and said apparatus is variously described as a diffusive source loudspeaker, diffusive loudspeaker, diffusive source or whiteroom loudspeaker.

The apparatus according to claim 91 wherein the sound source is an electro-acoustic transducer of suitable response capabilities described as a dipole source in the art and said apparatus is variously described as a diffusive source loudspeaker, diffusive loudspeaker, diffusive source or whiteroom loudspeaker.

The apparatus of claim 96 wherein the sound source is an electro-acoustic transducer of suitable response capabilities described as a dipole source in the art and said apparatus is variously described as a diffusive source loudspeaker, diffusive loudspeaker, diffusive source or whiteroom loudspeaker.

The apparatus according to claim 91 wherein the sound source is an electro-acoustic transducer of suitable response capabilities described as a monopole source in the art and said apparatus is used to correct frequency response anomalies as well as the claims made of dispersive or diffusive nature.

The apparatus of claim 95 wherein the sound source is an electro-acoustic transducer of suitable response capabilities described as a monopole source in the art and said acoustic apparatus is used to correct frequency response anomalies as well as the claims made for dispersive or diffusive nature.

A design apparatus so constructed to model the behaviour of the apparatus of any one of claims 89, 90, 91, 92, 93, 94, 95, 96, 97, 98, 99, 100, 101 or 102, and provide structure dimensions in response to the desired spatial and spectral design requirements, said apparatus also utilising the method of distributed parameter modelling and the method of residues to manage the higher order multi-resonances.

An audio apparatus using one or more of digital, analogue or active or passive signal processing of audio signals from channels of a multi-channel audio signal source so as to provide a summed signal representing all of the sound sources in the original sound field contributing to the reverberant sound field being suitable for feeding said signal to the reverberant apparatus described in claims 91 and 96 for reproduction.

An apparatus using the desired sound sources in conjunction with a parameters representing the desired reverberant field decay time and associated time variant spectrum to provide the correct source decay characteristic for the corresponding or derived channel of a multi-channel sound source so as to provide a summed signal representing all of the sound sources in the original sound field contributing to the reverberant sound field being suitable for feeding said signal to the reverberant apparatus herein described for reproduction, wherein reverberation parameters can be changed to provide audio reverberation scenes and scene change transition points, said apparatus described as parametric reverberation.

The use of the reverberant apparatus of claims 89, 90, 91, 92, 93, 94, 95, 96, 97, 98, 99, 100, 101, 102, 103 or 104 to actively mask the acoustic characteristics of a reverberant acoustic architecture.

A sound reproduction apparatus comprising at least two electro-acoustic transducers with suitable frequency response and covering the same range or frequencies so configured as to provide the ability to control the divergence a wave-front for reproduced sound thus effectively being able to place any point source sound of multi-tone or complex spectral nature at a set perceived distance from the listener area, said sound being perceived at a consistent point in space away from the listener area for all listeners, said electro-acoustic transducers not being equidistant from the listening area or any location therein.

A sound reproduction apparatus according to claim 107, comprising at least two electro-acoustic transducers with suitable frequency response and with the electro-acoustic transducers generally covering the same range or frequencies being so configured as to control the divergence of a wave-front of any reproduced sound source y means of electrical signal processing thus effectively being able to place, sounds at set locations in space generally at a distance from the listener area, said sound source being perceived at said location from the listener area for all listeners wherein the radiation pattern of all electro-acoustic transducers covers the entire desired listening area with all frequencies of interest without significant variation in frequency response of the art and said electro-acoustic transducers not being equidistant from the listening area or any location therein.

Two or more such apparatus comprising pairs of electro-acoustic apparatus according to claim 108 configured to reproduce sounds at a location in space perceived as having both direction and distance being in two dimensions, said configuration placing the apparatus at two or more angles in the region outside the listening area wherein the radiation pattern of the or each apparatus covers the entire desired listening area with all frequencies of interest without significant variation in frequency response of the art and the or each sound source is reproduced within the defined area between the two or more apparatus, the sound image in said space being correctly located in said region or area for all listeners in the listening area with each pair of electro-acoustic transducers not being equidistant from the listening area or any location therein.

Two such apparatus comprising pairs of electro-acoustic apparatus according to claim 109 above, so configured as to provide the ability to reproduce sounds at a location in space perceived as having both direction and distance in two dimensions, said configuration placing the apparatus at two angles to the listening area wherein the radiation pattern of the or each apparatus covers the entire desired listening area with all frequencies of interest without significant variation in frequency response of the art and the or each sound source is reproduced within the defined area between the two apparatus, the or each said sound image in said space being correctly located in said space for the and each listener in the listening area, and each electro-acoustic transducer of said pair not being equidistant from the listening area or any location therein.

Three or more such apparatus comprising pairs of electro-acoustic apparatus according to claim 108 above, so configured as to provide the ability to reproduce sounds at a location in space perceived as having both direction and distance in three dimensions, said configuration placing the apparatus at three or more angles to the listening area wherein the angles do not define a plane, the radiation pattern of the or each apparatus pair covers the entire desired listening area, with all frequencies of interest without significant variation in frequency response of the art and the or each sound source is reproduced within the defined area between the two apparatus, the or each said sound image in said space being correctly located in said space for the and each listener in the listening area and the or each said electro-acoustic transducer pair not being equidistant from the listening area or any location therein.

The control apparatus for the loudspeaker apparatus according to any one of claims 108, 109, 110 and 111, wherein the amplitude and phase of the signals fed to each electro-acoustic transducer in a pair is such that the resulting divergence of the overall vector acoustic wave so created places the resultant perceived sound at a set distance relative to the reproduction apparatus pair, said reproduction distance not being constrained to being an apparent source between said electro-acoustic transducers according to claims 108, 109, 110 and 111 but capable of render from well in front of said apparatus to well behind said apparatus as perceived from the listening area by appropriate control of said amplitude and phase with frequency for the or each electro-acoustic transducer pair according to the method.

The control apparatus and method according to claim 112 above wherein the control apparatus enables reduction of the physical separation between electro-acoustic transducers in a pair by processing the signal for said pair to provide apparent placement of said sound images from behind the rearmost electro-acoustic transducer to in front of the forward most electro-acoustic transducer and all locations in between, when perceived from the listening area.

The control apparatus and method according to claim 112 above wherein the control apparatus is able to receive electro-acoustic signals in a common or vector format according to claims 1, 2, 3, 4, 5, 6 and 7 and appropriately decode said signals for reproduction on said apparatus according to any one of claims 108, 109, 110 and 111 either locally or remotely wherein the location of the or each intended sound source is perceived as placed in space at the or each correct location according to the original intent of the electro-acoustic signal.

The control apparatus and method according to claim 114 wherein the control apparatus is able to receive electro-acoustic signals in a common or vector format and appropriately decode said signals either locally or remotely for reproduction on said apparatus according to any one of claims 108, 109, 110 and 111, wherein the perceived location of the or each intended sound source is able to be placed under user control at the point of use, such relative placement being at least partially preserved as required.

The control apparatus and method according to claim 114 above wherein the control apparatus is able to receive electro-acoustic signals in a common or vector format and appropriately decode said signals either locally or remotely for reproduction on said apparatus according to claims 108, 109, 110 and 111 wherein the perceived location of the or each intended sound source is able to be placed under remote director or other agent control at the point of use, such relative placement being able to be at least partially preserved as required.

The control apparatus according to claim 114 above wherein the control apparatus is able to receive electro-acoustic signals in a channel associated format and appropriately decode said signals for reproduction on said apparatus according to claims 108, 109, 110 and 111 to ensure backward compatibility with other formats of the art including equi-distant, said decoding able to either have or not have placement effects wherein the perceived location of the or each intended sound source is able to be placed under local user or remote director or other agent control at the point of use, such relative placement being able to be at least partially preserved as required.

A loudspeaker apparatus comprising one or more electro-acoustic transducer pairs where each electro-acoustic driver is not equidistant from the listening area or any listening location within said area and said apparatus has been designed to take advantage of the signal processing capability of a control apparatus according to claim 114 either locally or remotely to process said signals such that the render of the or each reproduced sound in space is correctly placed with respect to direction and particularly perceived distance and the apparatus is made in the desired shape and size, particularly with regard to controlling the separation between each of the electro-acoustic transducers of the said pair.

The use of the apparatus according to any one of claims 108, 109, 110, and 111 in isolation and according to any one of claims 112, 113, 114, 115, 116 and 117, such that the reproduction of the direct sound field in the listening area is correct for the or each listener in the listening area, said listening area being equal to or less than the bounded region of the listening environment, said reproduced sound field requiring no personal apparatus for the or each listener. Where no bounded area exists the reproduced sound field of this claim is spatially correct everywhere with no personal apparatus.

The use of the apparatus according to any one of claims 108, 109, 110 and 111 in isolation and according to any one of claims 112, 113, 114, 115, 116, 117, 118 and 119, such that the reproduction of the direct sound field in the listening area can be arbitrarily scaled for the or each listener in the listening area such that the reproduced image is smaller than, equal to or larger than the or each original sound source and placement, said listening area being equal to or less than the bounded region of the listening environment, said reproduced sound field requiring no personal apparatus for the or each listener. Where no bounded area exists the reproduced sound field of this claim is spatially correct everywhere with no personal apparatus.

The use of the apparatus according to any one of claims 108, 109, 110, 111 and 120 in isolation and according to any one of claims 112, 113, 114, 115, 116, 117 118 and 119, such that the reproduction of the direct sound field in the listening area can be arbitrarily scaled for the or each listener in the listening area such that the reproduced image is further from, equal to or nearer than the or each original sound source and placement, and special effects relating but not limited to translation, zooming, rotation and divergence is able to be undertaken under local or remote control, said listening area being equal to or less than the bounded region of the listening environment, said reproduced sound field requiring no personal apparatus for the or each listener. Where no bounded area exists the reproduced sound field of this claim is spatially correct everywhere with no personal apparatus.

The use of the apparatus according to any one of claims 108, 109, 110, 111, 112 and 119 in isolation and according to any one of claims 113, 114, 115, 116, 117 and 118 such that the reproduction of the direct sound field in the listening area can be arbitrarily scaled for the or each listener in the listening area such that the reproduced image is further from, equal to or nearer than the or each original sound source and placement, and special effects relating but not limited to translation, zooming, rotation, divergence or any combination thereof is able to be undertaken under local or remote control, said listening area being equal to or less than the bounded region of the listening environment, said reproduced sound field requiring no personal apparatus for the or each listener and in particular providing appropriately scaled perceived sound source behaviour when the listener is close to the reproduction apparatus, said configuration being referred to as being near field in the art.

The use of the apparatus according to any one of claims 108, 109, 110 111, 112 and 119 in isolation and according to any one of claims 112, 113, 114, 115, 116, 117 and 118, such that the reproduction of the direct sound field in the listening area can be arbitrarily scaled for the or each listener in the listening area such that the reproduced image is further from, equal to or nearer than the or each original sound source and placement, and special effects relating but not limited to translation, zooming, rotation, divergence or any combination thereof is able to be undertaken under local or remote control, said listening area being equal to or less than the bounded region of the listening environment, said reproduced sound field requiring no personal apparatus for the or each listener and in particular providing appropriately scaled perceived sound source behaviour when the listener remote from the reproduction apparatus, and including correct representation of the acoustic horizon at any location but particularly when the listener area is in the far filed in the art or when there is no bounded region.

A sound reproduction apparatus for personal use comprising at least two electro-acoustic transducers of the art for the or each ear of the listener with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and the said electro-acoustic transducers of the pair not being equidistant from the particular listeners ear.

A sound reproduction apparatus for personal use comprising at least two electro-acoustic transducers of the art in a pair for each ear with suitable frequency response and the or each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and the or each said electro-acoustic transducer of the said pair not being equidistant from the particular listener's ear.

Two such apparatus according to claim 124 above so configured as to provide the ability to reproduce sounds at a location in space perceived as having both direction and distance in two or three dimensions in space, said configuration utilising the apparatus of Head related Transfer Functions (HRTF) render but said HRTF being novel in that the or each HRTF are so determined and provided to convey spatially correct distance of the invention as well as direction in the art at all frequencies of interest, said electro-acoustic transducer pair not being equidistant from the particular listener's ear.

A control apparatus and method for the personal electro-acoustic transducer apparatus according to any one of claims 124, 125 and 126 wherein the amplitude and phase of the signals fed to the or each pair of electro-acoustic transducer such that the resulting divergence of the overall vector acoustic wave so created is treated as to place the image of the sound at a set distance relative to the or each reproduction apparatus pair, said reproduction distance or radius not being constrained to being an apparent source between said electro-acoustic transducers so arranged according to any one of claims 124, 125 and 126 but capable of render placing the image of the reproduced sound object from well in front of said apparatus thus being inside the listener head to well behind said apparatus to being at the acoustic horizon as perceived by the listener by appropriate control of said amplitude and phase with frequency for the or each electro-acoustic transducer pair according to the method.

A control apparatus and method according to claim 127 wherein the control apparatus enables reduction of the physical separation between the or each electro-acoustic transducer by processing the signal for the or each pair to provide apparent placement of said sound images from behind the rearmost electro-acoustic transducer to in front of the forward most electro-acoustic transducer and all locations in between, when perceived by the listener.

A control apparatus and method of claim 127 or 128 above wherein the control apparatus is able to receive electro-acoustic signals in a common or vector or divergent format and appropriately decode said signals for reproduction on said apparatus of claims 124, 125 and 126 either locally or remotely wherein the location of the or each intended sound source is perceived as placed in space at the or each correct location according to the original intent of the electro-acoustic signal, and particularly with regard to perceived distance.

A control apparatus and method according to claim 127 or 128 above wherein the control apparatus is able to receive electro-acoustic signals in a common or vector format and appropriately decode said signals either locally or remotely for reproduction according to claims 126, 127 and 128 wherein the perceived location of the or each intended sound source is able to be placed under user control at the point of use, such relative placement being at least partially preserved as required.

A control apparatus and method according to claim 127 or 128 above wherein the control apparatus is able to receive electro-acoustic signals in a common or vector format and appropriately decode said signals either locally or remotely for reproduction on said apparatus according to any one of claims 124, 125 and 126 wherein the perceived location of the or each intended sound source is able to be placed under remote director or other agent control at the point of use, such relative placement being able to be at least partially preserved as required.

A control apparatus and method according to claim 127 or 128 above wherein the control apparatus is able to receive electro-acoustic signals in a channel associated format and appropriately decode said signals for reproduction on said apparatus according to any one of claims 124, 125 and 126 to ensure backward compatibility, said decoding able to either have or not have placement effects wherein the perceived location of the or each intended sound source is able to be placed under local user or remote director or other agent control at the point of use, such relative placement being able to be at least partially preserved as required.

A personal sound reproduction apparatus comprising two or more electro-acoustic transducers each of which is not equidistant from the listener or any listening location within said area and said apparatus has been designed to take advantage of the signal processing capability of a control apparatus according to claim 127 or 128 either locally or remotely to process said signals such that the render of the or each reproduced sound in space is correctly placed with respect to direction and particularly perceived distance and the apparatus is made in the desired shape and size, particularly with regard to controlling the separation between the or each near and far electro-acoustic transducers.

The use of the apparatus according to any one of claims 124, 125 and 126 in isolation or in conjunction with each or any of the apparatus according to any one of claims 127, 128, 129, 130, 131, 132 and 133 such that the reproduction of the direct sound field for the listener can be arbitrarily scaled such that the reproduced image is smaller than, equal to or larger than the or each original sound source and placement, said reproduced sound field using personal apparatus for the or each listener and the or each sound source can be scaled as required by remote or user requirement.

The use of the apparatus according to any one of claims 124, 125 and 126 in isolation and according to any one of claims 127, 128, 129, 130, 131, 132 133 and 134 such that the reproduction of the direct sound field for the listener can be arbitrarily scaled such that the reproduced image is further from, equal to or nearer than the or each original sound source and placement, and special effects relating to translation, zooming, rotation, divergence or any combination thereof is able to be undertaken under local or remote control.

A sound reproduction apparatus for personal use comprising at least two electro-acoustic transducers of the art in a pair, each with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and the said electro-acoustic transducers of the pair not being equidistant from the listener, and being so designed to be placed in the or each ear canal of the listener, said apparatus being optionally able to provide some or a fair degree of unwanted external sound attenuation by physical and acoustic design.

A sound reproduction apparatus for personal use comprising at least two electro-acoustic transducers of the art as a pair each with suitable frequency response and the or each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and the or each said electro-acoustic transducer of the pair not being equidistant from the listener and being so designed to be placed in the or each ear canal of the listener, said apparatus being optionally able to provide some or a fair degree of unwanted external sound attenuation by physical and acoustic design.

A sound reproduction apparatus for personal use comprising at least two electro-acoustic transducers of the art in a group, each with suitable frequency response and each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and at least two electro-acoustic transducers of the group not being equidistant from the listener and being so designed to be placed in the or each ear canal of the listener, said apparatus utilising acoustic filter design associated with the or each electro-acoustic apparatus to deliver said required acoustic field components taking into account the or any presented acoustic load of the or each listener ear canal or pinnae, optionally created with the method of distributed parameters and with or without the use of electrical equalisation to achieve the desired frequency response, independently of or in conjunction with the use of further or other equalisation for other purposes, said apparatus being optionally able to provide some or a fair degree of unwanted external sound attenuation by physical and acoustic design.

A sound reproduction apparatus for personal use comprising at least two electro-acoustic transducers of the art in a group, each with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and at least two of the said electro-acoustic transducers in the group not being equidistant from the listener, and being so designed to be placed in the or each pinnae of the listener, and sometimes described as ear-buds in the art, said apparatus utilising acoustic filter design associated with the or each electro-acoustic apparatus to deliver said required acoustic field components taking into account the or any presented acoustic load of the or each listener ear canal or pinnae, optionally created with the method of distributed parameters and with or without the use of electrical equalisation to achieve the desired frequency response, independently of or in conjunction with the use of further or other equalisation for other purposes, said apparatus being able to provide minimal or some degree unwanted external sound attenuation by physical and acoustic design, and being optionally augmented with external protection of earmuffs helmets or the like.

A sound reproduction apparatus for personal use comprising at least two electro-acoustic transducers of the art in a group, each with suitable frequency response and the or each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and with at least two electro-acoustic transducers of the group not being equidistant from the listener, and being so designed to be placed in the or each pinnae of the listener, and sometimes described as ear-buds in the art, said apparatus utilising acoustic filter design associated with the or each electro-acoustic apparatus to deliver said required acoustic field components taking into account the or any presented acoustic load of the or each listener ear canal or pinnae, optionally created with the method of distributed parameters and with or without the use of electrical equalisation to achieve the desired frequency response, independently of or in conjunction with the use of further or other equalisation for other purposes, said apparatus being able to provide minimal or some degree unwanted external sound attenuation by physical and acoustic design, and being optionally augmented with external protection of earmuffs helmets or the like.

A sound reproduction apparatus for personal use comprising at least two electro-acoustic transducers of the art in a group, each with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and at least two of the said electro-acoustic transducers in said group not being equidistant from the listener, and being so designed to be placed over and encompassing the or each pinnae of the listener, and sometimes being generally described as headphones in the art, said apparatus utilising acoustic filter design associated with the or each electro-acoustic apparatus to deliver said required acoustic field components taking into account the or any presented acoustic load of the or each listener ear canal or pinnae, optionally created with the method of distributed parameters and with or without the use of electrical equalisation to achieve the desired frequency response, independently of or in conjunction with the use of further or other equalisation for other purposes, said apparatus being able to provide some or considerable degree of unwanted external sound attenuation by physical and acoustic design, and being able to utilise the spatial filtering behaviour of the or each pinnae of the listener at least to some degree.

A sound reproduction apparatus for personal use comprising at least two electro-acoustic transducers of the art in a group, each with suitable frequency response and the or each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and at least two of the said electro-acoustic transducers in a group not being equidistant from the listener, and being so designed to be placed over and encompassing the or each pinnae of the listener, and sometimes being generally described as headphones in the art, said apparatus utilising acoustic filter design associated with the or each electro-acoustic apparatus to deliver said required acoustic field components taking into account the or any presented acoustic load of the or each listener ear canal or pinnae, optionally created with the method of distributed parameters and with or without the use of electrical equalisation to achieve the desired frequency response, independently of or in conjunction with the use of further or other equalisation for other purposes, said apparatus being able to provide some or considerable degree of unwanted external sound attenuation by physical and acoustic design, and being able to utilise the spatial filtering behaviour of the or each pinnae of the listener at least to some degree.

A sound reproduction apparatus for personal use comprising at least two electro-acoustic transducers of the art in a group, each with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and at least two of the said electro-acoustic transducers of said group not being equidistant from the listener and being so designed to be mounted on or in association with the or a helmet construction, either placed near or over and encompassing the or each pinnae of the listener, and sometimes being generally described as headphones in the art, or personal apparatus worn in proximity to the head, neck or shoulders, said apparatus utilising acoustic filter design associated with the or each electro-acoustic apparatus to deliver said required acoustic field components taking into account the or any presented acoustic load of the or each listener ear canal, pinnae, head, or shoulders optionally created with the method of distributed parameters and with or without the use of electrical equalisation to achieve the desired frequency response, independently of or in conjunction with the use of further or other equalisation for other purposes, said apparatus being able to provide none, some or considerable degree of unwanted external sound attenuation by physical and acoustic design, and being able to utilise the spatial filtering behaviour of the or each pinnae of the listener at least to some degree.

A sound reproduction apparatus for personal use comprising at least two electro-acoustic transducers of the art in a group, each with suitable frequency response and the or each electro-acoustic transducer covering the same range or frequencies being so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener wherein the radiation pattern covers all frequencies of interest without significant variation in frequency response of the art and at least two of the said electro-acoustic transducers in the said group not being equidistant from the listener and being so designed to be mounted on or in association with the or a helmet or other related personal construction, either placed near or over and encompassing the or each pinnae of the listener, and sometimes being generally described as headphones in the art, said apparatus utilising acoustic filter design associated with the or each electro-acoustic apparatus to deliver said required acoustic field components taking into account the or any presented acoustic load of the or each listener ear canal, pinnae, head, shoulders, neck or torso, optionally created with the method of distributed parameters and with or without the use of electrical equalisation to achieve the desired frequency response, independently of or in conjunction with the use of further or other equalisation for other purposes, said apparatus being able to provide none, some or considerable degree of unwanted external sound attenuation by physical and acoustic design, and being able to utilise the spatial filtering behaviour of the or each pinnae of the listener at least to some degree.

A microphone apparatus so constructed to capture and output distance information as well as direction for any sound source, said apparatus comprising an array of microphone elements arranged so as to simultaneously capture directional and wave-front divergence information at a point or surface from the or each sound source of interest at the point or surface of capture, said apparatus utilising electronic signal processing to extract directional and distance information in a usable form.

A microphone apparatus according to claims 1, 2, 3, 4, 5, 6 and 7 so configured to capture distance as well as direction information for any sound source said apparatus comprising an array of microphone elements arranged so as to simultaneously capture directional and wave-front divergence information at a point or surface from said sound source of interest, said microphone elements each comprising at least two points of reception of the sound field emanations from said sound source of interest, said points being non-equi-distant, said apparatus utilising some from of electronic signal processing to extract directional and distance information in a usable form.

A microphone apparatus according to claims 1, 2, 3, 4, 5, 6 and 7 so configured to capture distance as well as direction information for said sound source and comprising at least two microphone elements arranged in conjunction with an acoustically rigid boundary construction of the apparatus to so as to simultaneously capture directional and wave-front divergence information at a point or surface from the or each sound source of interest, said apparatus used in conjunction with electronic apparatus using signal processing to extract said directional and wave-front divergence information for the or each sound source of interest, and some from of electronic signal processing to extract directional and distance information in a usable form.

A particle velocity microphone apparatus so configured to capture distance information as well as direction for any sound source said apparatus comprising at least two microphone elements arranged so as to simultaneously capture directional and wave-front divergence information at a point or surface from the or each sound source of interest, said apparatus utilising some from of electronic signal processing to process directional and wave-front divergence information and further to extract directional and distance information in a usable form.

The use of a plurality of said apparatus according to claims 145, 146, 147 and 148 in order to capture said wave-front characteristics at a plurality of points and suitably process said information to extract directional and distance information in a usable form.

An electronic signal processing apparatus capable of receiving electrical or electro-optic or other form of signals according to claims 145, 146, 147 and 148, said apparatus then processing said signals to largely or totally preserve the or each of the directional and divergence information whilst resolving said signals into a minimum set of vector signals described as orthogonal in the art, said apparatus having the necessary capability to equalise said signal in suitable form for subsequent use in the or any suitable storage, distribution or reproduction apparatus, said apparatus optionally having the necessary capability to supply the operational requirements of said microphone elements.

An electronic signal processing apparatus capable of receiving electrical or electro-optic or other form of signals from the or each apparatus of claims 145, 146, 147 and 148, said apparatus then processing said signals to largely or totally preserve the directional and wave-front divergence information relating to the distance and direction of the or each source whilst resolving said signals into a minimum set of vector signals described as orthogonal in the art, said group of vector signals being less than or equal to seven, said apparatus having the necessary capability to equalise the or each said signal in suitable form for subsequent use in the or any suitable storage, distribution or reproduction apparatus and said apparatus optionally having the necessary capability to supply the operational requirements of said microphone elements.

An electronic signal processing apparatus for audio post-production of the art capable of receiving the electrical or electro-optic or other form of signals from said apparatus of claims 145, 146, 147 and 148, said apparatus then processing said signals to largely or totally preserve the or each of the directional and divergence information whilst resolving said signals into a minimum set of vector signals described as orthogonal in the art, said apparatus also capable of receiving signals from other microphone elements and apparatus or from any element of the apparatus of claims 145, 146, 147 and 148, or from the apparatus according to claims 149, 150 and 151, said apparatus then being able to manipulate said sounds to vary the or each apparent direction and the apparent distance thus enabling addition, removal, translation, rotation divergence, zooming and contraction of each sound source as in the art or of the resultant sound field comprising the result of combination of the or each sound source when subsequently rendered or reproduced on suitable apparatus preserving in particular the distance as well as the direction of the or each sound source, said apparatus also having the necessary capability to equalise the or each said signal in suitable form for subsequent use in the or any suitable storage, distribution or reproduction apparatus, and said apparatus being able to take signals from other sound sources and storage devices being prior art and process said sources to provide additional information presenting distance and direction information as desired to the said sound source and storage devices of the prior art, and said apparatus optionally having the necessary capability to supply the operational requirements of said microphone elements, said apparatus being variously described as a mixing desk or production suite in the art.

The use of the apparatus of the or each claim 145, 146, 147, together with the apparatus of claims 148, 149, 149, 150, 151 and 152 in conjunction with or intended for use with any point of use render apparatus according to claim 5.

A signal processing apparatus whereby any incidental or intentional sound made by a listener in a listener area is detected, received, processed and rendered back into the or each electro-acoustic transducer reproducing sound over the whole of the listener area wherein the sweet spot of the art has been extended to the whole listening area a by point of use render apparatus according to claims 5 to 21 inclusive, such that the listener perceives a presence not of the reproduction environment acoustic but consistent with in the original acoustic wave-field scene or capture environment, said signal processing apparatus comprising a means of detecting said incidental or intentional sound for each listener in the listener area and said apparatus including but not limited to a of personal microphone apparatus with or without some information of listener location in the listening area relative to the or each electro-acoustic transducer creating the sound field or part thereof, a location distance and direction microphone capture apparatus according to any of claims 145, 146, 147, and 148 in or near the listening area placed at a location relative to the or each said electro-acoustic transducer creating the sound field or part thereof and said location being conveyed or otherwise known by the said signal processing apparatus and said signal processing apparatus including the ability to place or render any early reflection and reverberant sound field components according to claim 55 and according to any of claims 88, 89, 90, 91, 92, 93 94 and 95 respectively, appropriately for perception by the listener, the information on the acoustic behaviour of the source environment being conveyed by pre-programmed or parametric or other means, and said parametric or other means being able to be changed in accordance with any source acoustic scene changes whether being accompanied by any acoustic scene visual information such as video or not.

A signal processing apparatus whereby any incidental or intentional sound source outside a listener area and incident on the listener area is detected with an apparatus according to claims 145, 146, 147, 148 and 149, received, processed and rendered back into the or each electro-acoustic transducer through point of use render apparatus according to claims 5 to 21 inclusive, so as to use the methods of partial or complete annihilation and masking in the art to treat said external sound source such the that the listener perception of said sound source is lessened or eliminated, said signal processing apparatus comprising said means of detecting said sound source originating outside the listener area and said apparatus including but not limited to a listener area boundary microphone apparatus of said claim with or without some information of said microphone location on the boundary of the listening area relative to the or each electro-acoustic transducer creating the sound field and parts there-of, said location distance and direction microphone capture apparatus in or near the listening area located at a place relative to the or each electro-acoustic transducer creating the sound field or part thereof and said location being conveyed or otherwise known by the said signal processing apparatus and said signal processing apparatus including the ability to place or render any early reflection and reverberant sound field components according to claims 54 and according to claims 88, 89, 90, 91, 92, 93, 94 and 95 respectively, appropriately in space including distance and direction, the information on the acoustic behaviour of the listener area environment being conveyed by pre-programmed or parametric or other means, and said parametric or other means.

A signal processing apparatus comprising hardware and software in the art and able to be carried by, or the capability otherwise delivered to, any user in the art wherein facility is provided for a microphone apparatus of claims 145, 146, 147 and 148 so configured to capture distance information as well as direction for any sound source simultaneously capturing directional and wave-front divergence information at a point or surface from the or each sound source of interest, said apparatus used in conjunction with the apparatus of any of claims 49, 50, 51 52, 53 and 54 offering signal processing to extract said directional and distance information from wave-front divergence ad direction information for the or each sound source of interest in a usable form, and a sound reproduction apparatus comprising at least two electro-acoustic transducers of any of claims 124, 125 and 126, and any of claims 133 to 144 inclusive with suitable frequency response and covering the same range or frequencies so configured as to provide the ability to control the divergence of the or any wave-front of the or any reproduced sound source thus effectively being able to place, recreate or render the or each sound point source of multi-tone or complex spectral nature with minimum width and height or any sound source generally at a perceived distance from the listener area, said sound source being perceived at said distance from the listener area for the or each listener and at least two of the said electro-acoustic transducer groups or pairs not being equidistant from the listeners ears, said signal processing apparatus also having capability for the entry, storage and use of rule-sets associated with the operation of the said microphone capture apparatus, the said render apparatus and potentially a user interface, a communications and input and output including burst, packet spread spectrum and other radio or optical communications capability of the art, either generally of limited range or directional, a proximal Identification of Friend or Foe, the or each proximal audio microphone with distance or direction capability or both according to said claims or without, a logic processor, a persistent storage, a visual display, a programming and operation override device, a time and day/night and light/dark perception device with adaptive behaviour, a audio processing device according to claims 1 to 10 inclusive and again claims 107 to 123 inclusive, a 3 degrees of freedom orientation sensing device of the art with suitable output, a 3 degrees of freedom location sensing device, a satellite or other position location update and input device, a directional audio microphone according to claims 145, 146, 147, 148 and 149 with distance or ranging capability being able to provide enhanced audio display and including the capability for specific sound recognition and location in direction and distance, a security facility apparatus including validation, verification, authentication and have-and-know strategies of the art covering the listener and the communications facility incoming and outgoing, and with said rule-sets either being pre-programmed, casually entered or deduced or any combination thereof, and being suitably portable and suitably powered and with managed general emissions of heat and other electromagnetic radiation and sound.

The use of two or more such apparatus according to claim 156.

A sound reproduction apparatus for personal use comprising the apparatus according to claims 124, 125 and 126, claims 127 to 132 inclusive, and 133 to 144 inclusive, for any user ear with suitable frequency response and covering the same range or frequencies so configured as to provide the ability to control the divergence of the or any wave-front of the or any sound source thus effectively being able to place, recreate or render the or each sound point source of multi-tone or complex spectral nature with minimum width and height or any sound source generally at a perceived distance from the listener, said sound source being perceived at said distance from the listener and the said electro-acoustic transducers not being equidistant from the listener and a suitable control apparatus and method for the said personal electro-acoustic transducer apparatus according to claims 112, 113, 114, 115, 116, and 117 wherein the amplitude and phase of the signals fed to the or each pair of electro-acoustic transducers is such that the resulting divergence of the overall vector acoustic wave so created is so treated as to place the sound at a set distance relative to the or each reproduction apparatus pair, said perceived reproduction distance or radius not being constrained to being an apparent source between said electro-acoustic transducers so arranged but capable of render from well in front of said apparatus thus potentially being perceived as inside the listener head to well behind or away from said apparatus being at the acoustic horizon as perceived by the listener by appropriate control of said amplitude and phase with frequency for said electro-acoustic transducers of the pair according to the method, wherein the apparatus forms a suitable conformant seal with the or each user ear canal, thus excluding or reducing the level of sounds not generated by the said apparatus as required.

A microphone apparatus according to claims 145 to 149 inclusive so configured to capture distance information as well as direction for the or each sound source in conjunction with the acoustically rigid boundary constructions associated with the apparatus so as to simultaneously capture directional and wave-front divergence information at a point or surface from the or each sound source of interest, said apparatus used in conjunction with electronic apparatus according to claims 150 to 153 inclusive offering signal processing to extract said directional and distance information for a sound source of interest in a usable form, and being able to convey sound sources in the or each sector or range of interest or both, and further said electronic signal processing being able to recognise sounds and sound sources by their acoustic signature of the art being suitable for highlighting or alerting to their presence and location in range and direction buy some differentiating means including but not limited to the variation of the perceived rendered distance.

An apparatus able to sense the orientation of the user or listener and in particular the orientation of the user or listener head in the three axes of up/down, left right and forward/back relative to a reference orientation in a suitable from being suitable for presenting the placement of sounds in a consistent manner with respect to distance and direction whilst the user is moving, rolling and turning, said output from apparatus also being used to process, place and convey sound sources consistently in a sector or range of interest or both to a sound reproduction apparatus for personal use according to claims 124, 125 and 126, claims 127 to 132 inclusive, and 133 to 144 inclusive for each ear with suitable frequency response and each covering the same range or frequencies so configured as to provide the ability to control the divergence or vector behaviour of any acoustic wave-front of a real or virtual sound source thus effectively being able to place, recreate or render the or each sound point source of multi-tone or complex spectral nature generally at a perceived distance in a perceived direction from the listener or user, said sound source being perceived at said distance from the listener and the said apparatus not being equidistant from the listener and a suitable control apparatus and method for the said personal electro-acoustic transducer apparatus wherein the amplitude and phase of the signals fed to the or each pair of electro-acoustic transducers is such that the resulting divergence of the overall vector acoustic wave so created is so treated as to place the sound at a set distance relative to the or each reproduction apparatus pair, said reproduction distance or radius not being constrained to being an apparent source between said electro-acoustic transducers so arranged but capable of render from well in front of said apparatus to well behind or away from said apparatus to being at the acoustic horizon as perceived by the listener by appropriate control of said amplitude and phase with frequency for the or each electro-acoustic transducer of the pair, and at the same time the direction of the or each sound source is able to be placed as required according to the method of head related transfer functions and related impulse response, referred to as HRTF in the art, but said HRTF being derived taking into account both distance and direction aspects, said distance aspects of the HRTF being a subject of the innovation of the present patent.

An apparatus able to sense the location of the desired object including the user or listener and in particular said location in either relative or absolute location terms in a suitable form being suitable for presenting and controlling the placement of sounds in a consistent manner with respect to distance and direction, said apparatus also utilising some from of electronic signal processing to extract directional and distance information in a usable form, and being able to process, place and convey sound sources in any sector or range of interest or both, to a sound reproduction apparatus for personal use according to claims 124, 125 and 126, claims 127 to 132 inclusive, and 133 to 144 inclusive for each ear with suitable frequency response and said apparatus so configured as to provide the ability to control the divergence or vector behaviour of the or any wave-front of the or any real or virtually placed sound source thus effectively being able to place, recreate or render the or each sound point source of multi-tone or complex spectral nature generally at a perceived distance from the listener, said sound source being perceived at said distance from the listener and a suitable control apparatus and method for the said personal electro-acoustic transducer apparatus according to claims 124, 125 and 126, claims 127 to 132 inclusive, and 133 to 144 inclusive wherein the amplitude and phase of the signals fed to the or each pair of electro-acoustic transducers is such that the resulting divergence of the overall vector acoustic wave so created is so treated as to place the sound at a set distance relative to the or each reproduction apparatus pair, said reproduction distance or radius not being constrained to being an apparent source between said electro-acoustic transducers so arranged but capable of render from well in front of said apparatus thus being perceived inside the listener head to well behind or away from said apparatus to being at the acoustic horizon as perceived by the listener by appropriate control of said amplitude and phase with frequency for the or each electro-acoustic transducer of the said group, and at the same time the direction of the or each sound source is able to be placed as required according to the method of head related transfer functions and related impulse response, referred to as HRTF in the art, but said HRTF being derived taking into account both distance and direction aspects, said distance aspects of the HRTF being a subject of the innovation of the present patent, and said apparatus being able to utilise the facilities of the or any regional global location and presentation service including but not limited to GPS satellite, GPRS, GSM tower based or the or a multitude of other user location based.

A signal processing apparatus whereby the each or any incidental or intentional sound source of the desired listening area is detected, received, processed and selectively rendered back into the or each electro-acoustic transducer through point of use render apparatus so as to present those sounds desired or of pre-determined interest with special treatment, said treatments including augmentation, attenuation or elimination, said signal processing apparatus comprising a means of detecting said sound source originating outside the listening area and said apparatus including but not limited to the or each of listening area boundary microphone apparatus with or without some information of said microphone location on the boundary of the intended listening area relative to the or each electro-acoustic transducer creating the sound field or part thereof, location distance and direction microphone capture apparatus according to claims 145 to 149 inclusive in or near the listening area located at a place relative to the or each electro-acoustic transducer creating the sound field or part thereof and said location being conveyed or otherwise known by the said signal processing apparatus and said signal processing apparatus including the ability to place or render early reflection and reverberant sound field components appropriately in space including distance and direction, the information on the acoustic behaviour of the listener area environment being conveyed by pre-programmed or parametric or other means, and said parametric or other means.

An apparatus whereby received and transmitted communication of information including but not limited to audio information is transported by any means in the art including but not limited to duplex of spread spectrum techniques utilising multi-media including but not limited to electromagnetic radiation, light, ultraviolet, infrared, by means including but not limited to burst packet encoding and decoding with general or directional emission over guided or unguided media and with encryption and decryption being suitable for reliable, secure, low visibility communications between the or each user, said communications including audio information distribution sufficient for the identification of distance and direction of the or all sources and the content of the or each audio stream message presented appropriately in distance as well as direction.

The provision of the apparatus capability of the or each claims 156, 157, 158, 159, 160 and 161 between two or more users or listeners, said users being able to converse over significant distances and through barriers but in a manner most similar to normal conversation by having the or each other user correctly represented in distance and direction and being able to turn towards the direction of the or each target sound including other users and prioritise conversing in an otherwise generally natural manner and wherein the distance or range information is generally proportional and thus generally able to be learnt by the or each user but said range considerably exceeding present communications capability of users without said apparatus.

### DETAILED DESCRIPTION OF THE FIGURES

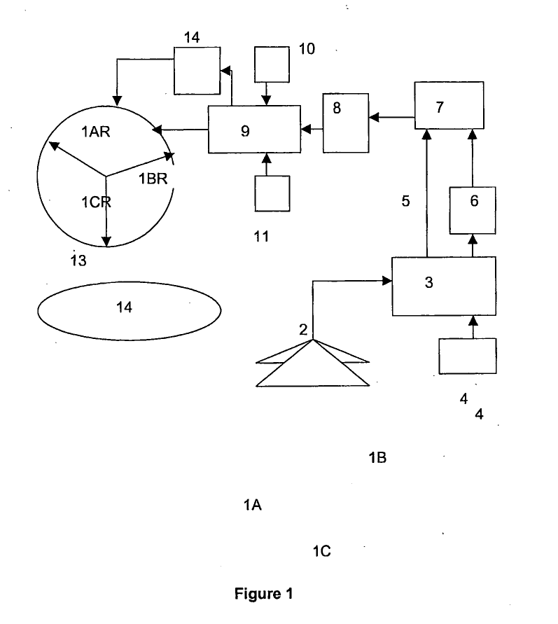

A. FIG. 1 shows the general configuration of the common vector wavefront source apparatus together with the point of use render apparatus, a general format encode/decoder for the user apparatus including the three formats of voyeur, bubble and immersive virtual reality and the unified formats as of the description considered, and a general electro-acoustic transducer apparatus encompassing the controlled directivity wide-range, the apertured vector wavefront directional source and equalisation, the vector wavefront omni-directional source, the vector wavefront sectored source and equalisation.

1A, 1B and 1C represent three sound sources at different locations in three dimensions in the original environment, 2 shows the microphone apparatus schematically, said microphone apparatus being able to capture both distance and direction information based on the divergence of the or each arriving wavefront from the or each said source, with the directional properties being emphasised as represented. 3 shows the signal processing apparatus with 4 the source render control and authorisation input, 5 the output source electrical signals going to either 6 being the production and distribution steps and then on to distribution channels being 7 or directly to 7 being the decoder, 9 the point of use render, with user control input 10 and manual or auto-reproduction environment discovery 11, the amplifiers as necessary 12 feeding to the reproduction apparatus in the reproduction region 13. Optionally, where an apertured source is used for directivity control, 14 shows the equalisation apparatus for correcting the frequency response to give the desired output. The reproduction region has a listening area 14 and said reproduced sound sources are shown as consistently reproduced in three dimensional space relative to but not located at the reproduction apparatus, when observed from the listening area 14.

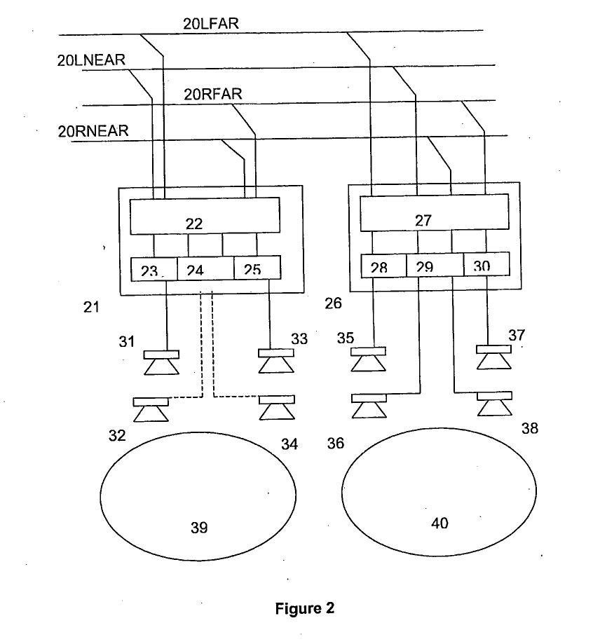

FIG. 2 shows the detail of deriving multiple reproduction or render signals simultaneously from the common electrical vector wavefront format, with 20LFAR being the vector wavefront information most generally associated with the left far corner of the listening environment relative to the capture location 20LNEAR being the electrical vector wavefront information most generally associated with the acoustic field towards the left near or alternatively the front corner of the source environment 20RFAR being the electrical vector wavefront information most generally associated with the acoustic field towards the right far corner of the source environment and 20RNEAR being the electrical vector wavefront information most generally associated with the acoustic field towards the right near or alternatively the front corner of the source environment, 21 is one decoder and render device at point of use, 22 is the decoder part, 23 is one render configuring apparatus, 23 is another render configuring apparatus and 24 is a third render configuring apparatus within said Point of use apparatus. 26 is another decoder and render device at point of use, 27 is the decoder part, 28 is one render configuring apparatus, 29 is another render configuring apparatus and 30 is a third render configuring apparatus within said Point of use apparatus, said apparatus not being limited in any way with respect to the nature and number of said devices, but said arrangement serving to demonstrate the principle. Both point of use render apparatus receive the same vector wavefront electrical signals, 23, 24 and 25 being associated with one reproduction environment and listener area and associated configuration and 28, 29 and 30 being associated with the reproduction environment and listener area and associated configuration. In the example shown the configuration of both environments is voyeur format, though the general layout of the two may differ in aspects of placement and listener area. Apparatus 31, 32, 33 and 34 are available in the first listening environment serving listener area 39 and apparatus 35, 36, 37 and 38 are available in the second serving listener area 40.

In the example shown, the first apparatus is set by the source controller to render to a stereo pair, either by reason of the source material being of the stereo equidistant channel format or the authorisation for the vector Wavefront format not being provided. In this situation it is a user choice which loudspeakers are used or indeed which speakers have been provided. Accordingly render apparatus 23 is configured for direct feed of summed left side signals and render apparatus 25 is configured for direct feed of summed right side signals, and render apparatus is off, the example being chosen to clearly illustrate the principle.

The second apparatus and loudspeakers is set by the source controller to render to vector wavefront format by authorisation under control of the source independently of the source material format but most logically for the vector wavefront source. In this situation it is expected that a full vector wavefront configuration is available. Accordingly render apparatus 28 is configured for feed of the vector resolved left side far signal of the source vector wavefront and render apparatus 29 is configured for feed of the vector resolved left side far signal of the source vector wavefront, with render apparatus 29 being set to render the left and right near vector signals the example being chosen to clearly illustrate the principle. It is noted that the render platforms embodied in 21 and 26 could be the same device with differing source and user control settings.

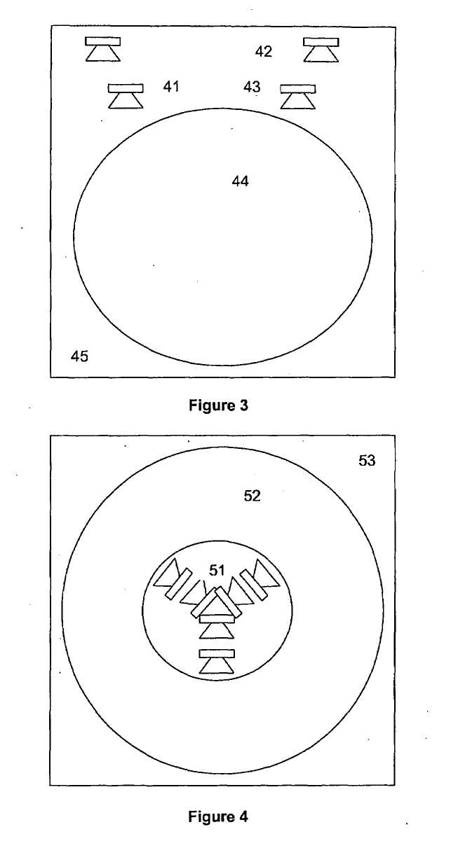

FIGS. 3, 4 and 5 show the three formats of voyeur, bubble and immersive virtual reality.

FIG. 3 shows the arrangement of a voyeur format and the corresponding directional vector wavefront loudspeakers with the far electro-acoustic apparatus shown as 40 and 42 and the near apparatus shown as 41 and 43. The voyeur format provides a region of correctly perceived sound sources as observed from anywhere in the listening area 44 of the reproduction environment 45. More apparatus can be used to provide improved resolution either vertically or horizontally shown here with two pairs 40/41, and 42/43 though more can be used, the example being chosen to clearly illustrate the principle.

FIG. 4 shows the use of the bubble format in a listening environment 53 where 51 is three pairs of electro-acoustic apparatus forming the directional vector wavefront apparatus each covering a sector and the listener area 52 is restricted to being outside the apparatus area 51 and inside but marginally away from the region boundaries of the region 53 as shown. Additional pairs of apparatus providing better resolution can be used, the example being chosen to clearly illustrate the principle.

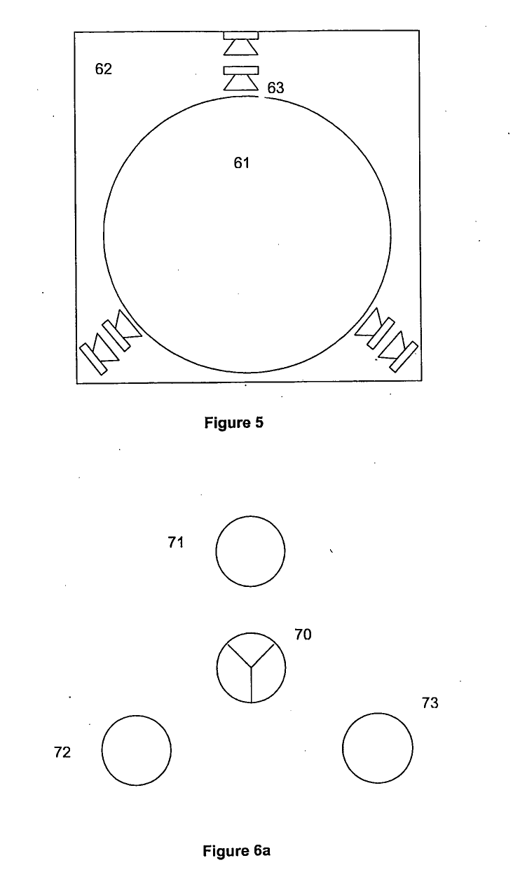

FIG. 5 shows the use of the immersive virtual reality format in a listening environment 62 where 63 is three pairs of electro-acoustic apparatus forming the directional vector wavefront apparatus each covering the listening area 61 said listening area being restricted to being inside the boundary described by the apparatus area. Additional pairs of apparatus providing better resolution can be used, the example being chosen to clearly illustrate the principle.

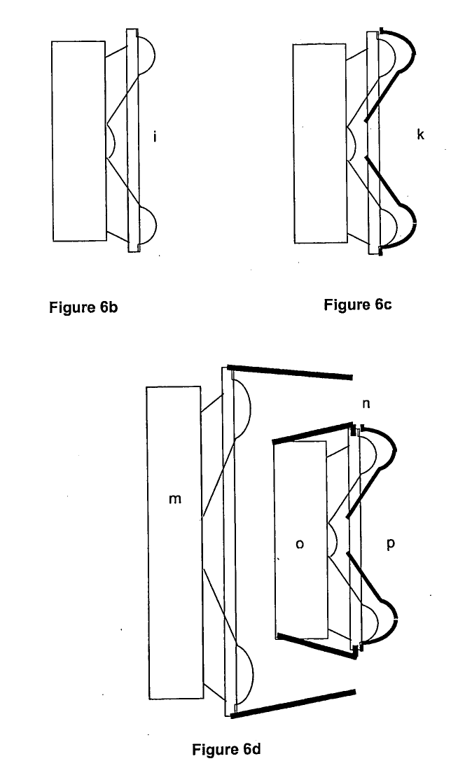

FIG. 6a shows the plan view of a unified format apparatus of three sectors each covering 120 degrees wherein the centre apparatus 70 is a sectored omni and the outer apparatus 71, 72 and 73 are omni, said apparatus being so arranged to from the pairs of three vector wavefront apparatus for the purposes of render.

Said apparatus can be mounted at head height or with a design of omni suitable for use of the boundary reflections can be boundary mounted.

FIG. 6b shows the use of controlled apertures electro-acoustic sources where the choice of electro-acoustic active surface diameter is made.

FIG. 6c shows an apparatus of the present invention wherein a suitable electro-acoustic transducer (j) is modified by the placement of a cover with aperture between the active surface and the intended listening area and in close proximity to the active surface either as an add-on device or as a new composite electro-acoustic transducer.

FIG. 6d shows two such apparatus co-axially mounted wherein the aperture n of electro-acoustic apparatus m and associated orifice structure is in part formed by electro-acoustic transducer and orifice o and p respectively, said apparatus having they desired outer diameter of said orifices to control the radiation pattern.

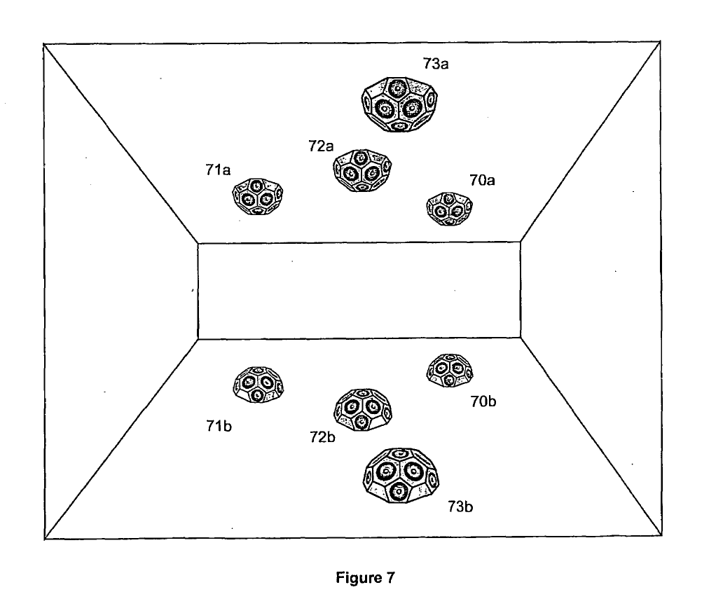

FIG. 7 shows a schematic of such omni loudspeakers being mounted in the ceiling and floor, thus forming an image at listening height. 72a and 72b are the centre sectored omni apparatus and 71a/71b, 70a/70b and 73a/73b are the omni sources all apparatus being so placed as to form three pairs of vector wavefront apparatus on the ceiling, each covering 120 degrees and a duplicated and corresponding set on the floor. The point of use render signals fed to the ceiling/floor corresponding pairs are the same with the ability to adjust relative level to give the correct vanishing point for the recreated sound field. In some applications, the need for some or all of the floor mounted apparatus can be considered relative to the effectiveness of the sound field created. More than three sets of pairs of apparatus can be used, each covering a smaller angle than 120 degrees to improve the resolution, the example being chosen to clearly illustrate the principle.

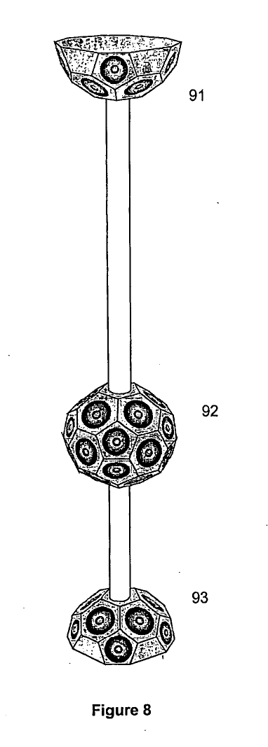

FIG. 8 shows the combination of a sectored omni 91 mounted on a ceiling a full sphere omni 92, optionally being sectored or un-sectored and being mounted at listening height and 93 being mounted on the floor, all apparatus being mounted on a pole for convenience where wiring is within the pole and the units can be rotated around the pole to align sector pairs.

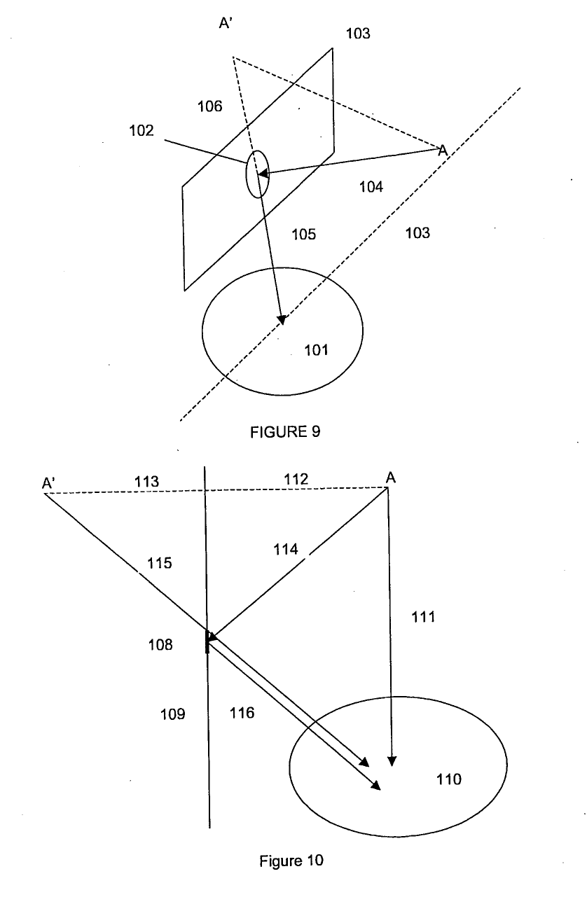

FIG. 9 shows the general configuration of the early reflection event associated with a sound source therein showing a sound source A radiating sound in all directions including directly towards a listening area 101 generally along path 103, said direct sound being phase coherent in the art, a listening environment construction 103 being a wall or an object capable of specular or diffuse reflection of sound or both, said reflection being of specific characteristics in a boundary portion 102, said boundary portion being of sufficient extent or from to cover all or a fair portion of the listening area 101 with said reflected sound, and said reflected sound having two components being the diffuse reflection behaving as a source located at the portion 102, having been delayed by the propagation time of the distance 104 from the source to the said boundary relative to the or each sound being uttered, and specular reflection emission 106 having the vector wavefront characteristics of a source located at the generally inaccessible point A′, said point A′ being referred to as a virtual source in the art, and aid reflection being delayed by the same amount of time as the diffuse source by the time it has propagated to the said portion relative to the original source A or alternately the virtual source A′.

FIG. 10 shows the plan view and geometry of an example of the arrangement of FIG. 1 wherein the source A propagates in all directions including directly towards the listening area 110 and towards the portion of interest for the particular early reflection 108 of the boundary construction 109 along the path 114.

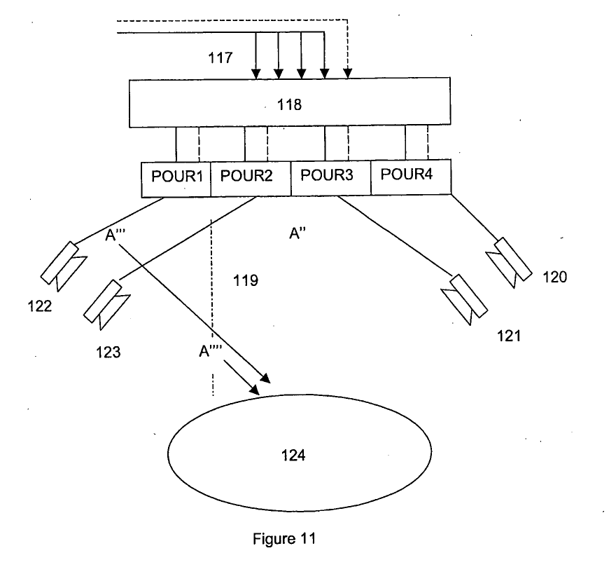

FIG. 11 shows the common distribution format of the invention 117, comprising the electrical vector wavefront signals and the metadata particularly containing information regarding early reflections and render authorisation being received by a point of use apparatus including a decoder able to receive the common format and extract the metadata 118, and a suite of render apparatus POUR1, POUR2, POUR3 and POUR4, together being able to present the vector wavefront audio sounds at any desired or specified relative location in space including A″, A′″, and A″″ as observed from anywhere in the listening environment 124, using four suitable electro-acoustic apparatus 120, 121, 122, and 123.

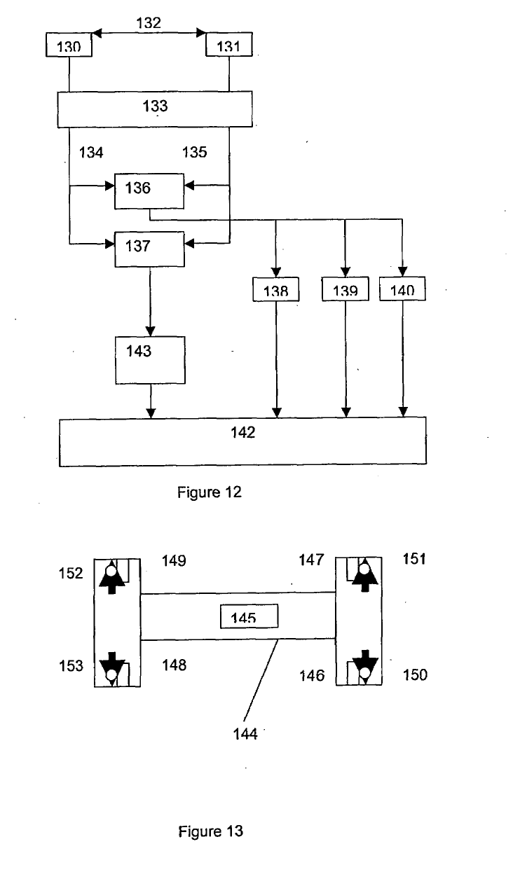

FIG. 12 shows the general configuration of the mode finder apparatus used for low frequencies wherein the particle velocity of a local region is deduced from the alternating pressure at two points as measured by two point pressure microphones 130 and 131 being separated by a set distance 132, said particle velocity having direction being determined by the difference signal of the microphones and being related to the pressure at two points by the characteristic impedance of the medium of propagation.

A filter block 133 enables the selective extraction of the frequencies of interest either discretely by analogue or digital circuitry or continuously using digital processing of the art. The signals from the two microphones are simultaneously passed to essentially a phase differencing apparatus or circuit indicating that the signal from one microphone leads 138, or lags 139 the other or is coincident to within the sensitivity of the apparatus at the frequency of interest, and an amplitude circuit indicating the presence of signal at the frequency of interest, essentially by summing the two microphone outputs so filtered.

The outputs of the two processing apparatus or circuits is then passed to a display device 142 constructed as part of the device or separately.

FIG. 13 shows the so-called “dogbone” apparatus part of the invention 144 wherein a signal processing apparatus or circuit, having capability to support more than one apparatus according to FIG. 12, has four microphone elements 150, 151, 152 and 153 grouped in pairs diagonally across the apparatus such that 150 and 152 form a pair and 151 and 153 form a pair, said pair being as far away from each other as possible on the apparatus. The signal processing then operates display devices indicating the direction needed to move the apparatus in order to approach or move away from the equi-phase condition, thus enabling the user to move the apparatus towards a node or anti-node according to the art in a room or other environment having direct and reflected low frequency energy.

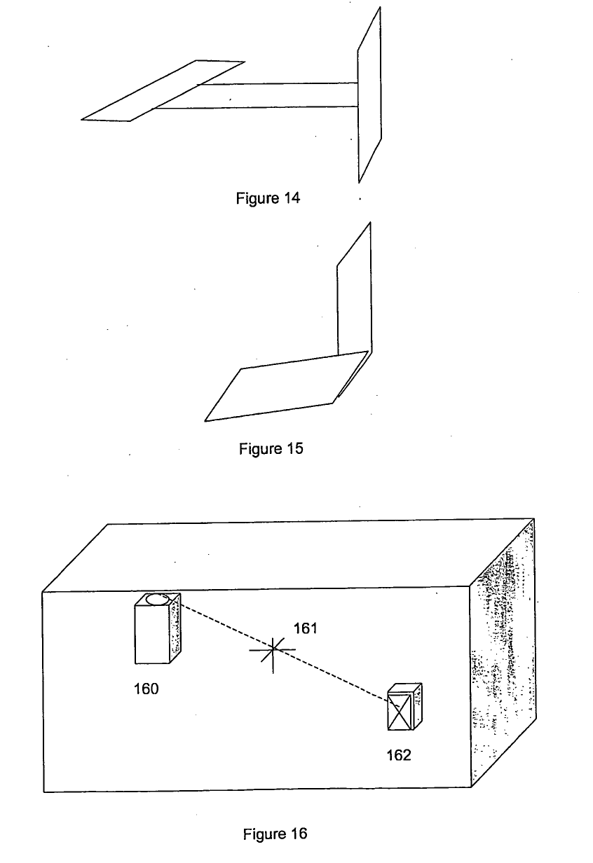

FIG. 14 shows the variant of the apparatus wherein the microphones are as far away from each other as possible, and area arranged such that the node or anti-node point can be determined by translation of the apparatus only by way of the crossed sensors, noting that the sensors are paired between and diagonally across ends such that the axes so formed are orthogonal.

FIG. 15 shows a variant of the “dogbone” apparatus wherein advantage is taken of using one microphone element as common to the two axes of the apparatus, the microphone pairs thus formed being on each leg of the apparatus 155 and 156, but the desired behaviour being deduced from the crossed axes.

FIG. 16 shows a room or other environment wherein the boundary is not necessarily rectangular as is schematically shown and wherein a low frequency loudspeaker source having suitable frequency response and small radiating area 160 is located in the room and the “dogbone” meter (163) is used to locate the appropriate desired point of node or anti-node behaviour wherein all sound energy is divergent or convergent at the or each frequency of interest, said location being a wave focussed coupling point taking into account the effects of reflections of the boundaries of the room, and alternatively a location of a room mode, these two locations not necessarily being the same. The centroid or centre of mass on the gas confined within the boundary is indicated by the point 161.

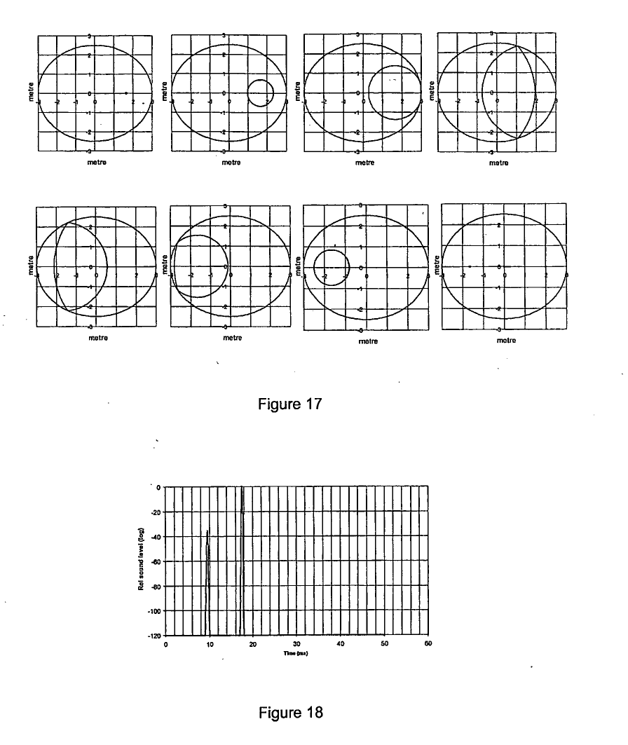

FIG. 17 shows the modelling of wave propagation in an ideal ellipsoidal room where the propagating wave is launched from one of the two focus points of the ellipsoid in the art. The series of time sequenced graphs starting top left and progressing row by row show the direct wave and the influence of the boundary on propagation. The wave sequence continues from the bottom right corner graph back through the sequence as the wave subsequently passes the focus and diverges and converges back to the original focus point after two propagation periods.

FIG. 18 shows the integrated acoustic energy density over a spherical space the size of a human head and located at the second focus point. The initial spherical component arriving early and the main boundary or wave focused component can be seen.

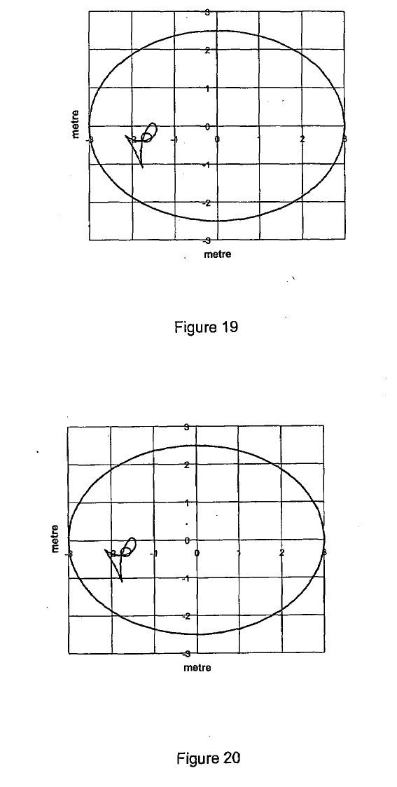

FIG. 19 shows the effect of moving the source location by 300 mm up from the first focus point on the arrival wave after the said one elapsed propagation period. The graph shows the de-focusing effect of moving the source a small distance.

FIG. 20 shows the integrated energy density observed at the integration point a and indicating that the early arrival wave is largely unchanged but lowering of coupling efficiency and temporal smearing has occurred.

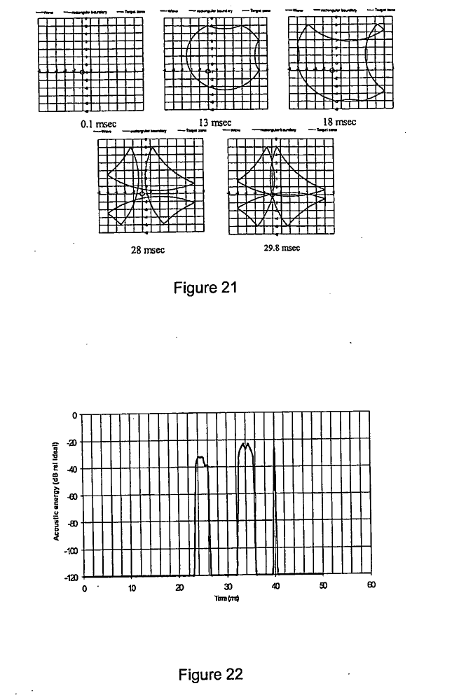

FIG. 21 indicates the propagation of a spherical wave in a rectangular room in a series of elapsed time graphs. The source is located at the point one metre up and one metre to the right relative to the centre of the room. The point of convergence of the propagating wave influenced by the boundary is at the location one metre down from the centre and one meter to the left being the same distance through the centre of mass of gas in the room.

FIG. 22 shows the integrated energy density observed at the integration point being the image point and indicating that the early arrival wave is as expected and that the boundary reflected or wave focussed energy is both temporally smeared and of lower level but that the level is not greatly different to that achieved in the ideal ellipsoidal room case when the source is moved 300 mm. lowering of coupling efficiency and temporal smearing has occurred.

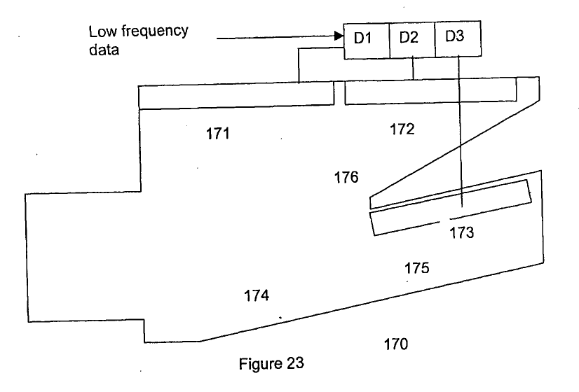

FIG. 23 shows the cross section or elevation through a cinema 170 having a main seating area 174, a balcony seating area 176 and stalls seats below the balcony 175. Arrays of low frequency apparatus each generating a largely plane wave, though with unavoidable spherical component, are mounted such that the wave so generated is orthogonal to the floor section under the seats for the corresponding regions 172 for 176, 174 for 171 and 170 for 173. The signal delay for each array is adjusted such that all patrons receive simultaneous arrival of low frequency content, said sound arrival also being advanced overall in time as to match any visual signals or said visual signals being relatively delayed, whilst the low frequency transducers are fed an appropriately time delayed inverse signal with the intent of removing the reflected energy from the whole cinema after delivery to the listeners and thus avoiding the establishment of modes as much as possible.

FIG. 25 labelled 185 shows the general configuration of the low frequency coupler plate apparatus comprising a plate sealing one surface of each of two electro-acoustic transducers except for the said aperture of the art in an enclosure. An acoustic low pass filter of the art so formed by the cavity towards the active surface of each driver so formed is designed such that it offers little resistance to alternating gas flow over the desired range of frequencies. In a design example the electro-acoustic transducers are of nominal diameter 300 mm the enclosure is of 60 litres internal volume excluding the apparatus of the invention and the associated electro-acoustic transducer the aperture is of 80 mm diameter, the internal volume of the filter so formed is 4 litres and the desired response is to 250 Hz.

The comparison of the apparatus of the invention to the enclosure without the invention reveals an increase in output of over 2 dB over the enclosure without the apparatus when driven by an amplifier of low output impedance said effective output being achieved by removal of the in-phase back pressure of each of the drivers by the other over the pass-band, said increase being effectively an efficiency gain as the opposing force on each driver is being reduced during motion.

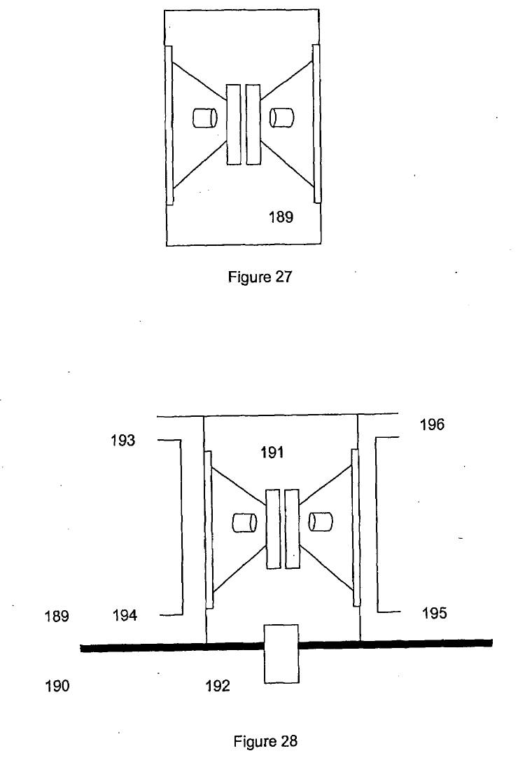

FIG. 28 shows an electro-acoustic transducer 187 according to the invention wherein the aperture plate and aperture have been included in the manufacture thus making a new apparatus, the aperture plate being formed by what is normally the rear basket and the aperture being the only means of alternating gas velocity leaking the apparatus from the active surface on one side and the cone as normally for the other active surface.

FIG. 28 shows two leaky environments 192 and 193 with the apparatus between wherein the gas from one side of the active surface of each electro-acoustic apparatus of the invention is coupled to the listening area through aperture 192 and the other side of the active surface of the apparatus of the invention is coupled to the other leaky environment through one or more apertures 193, 194, 195 and 186.

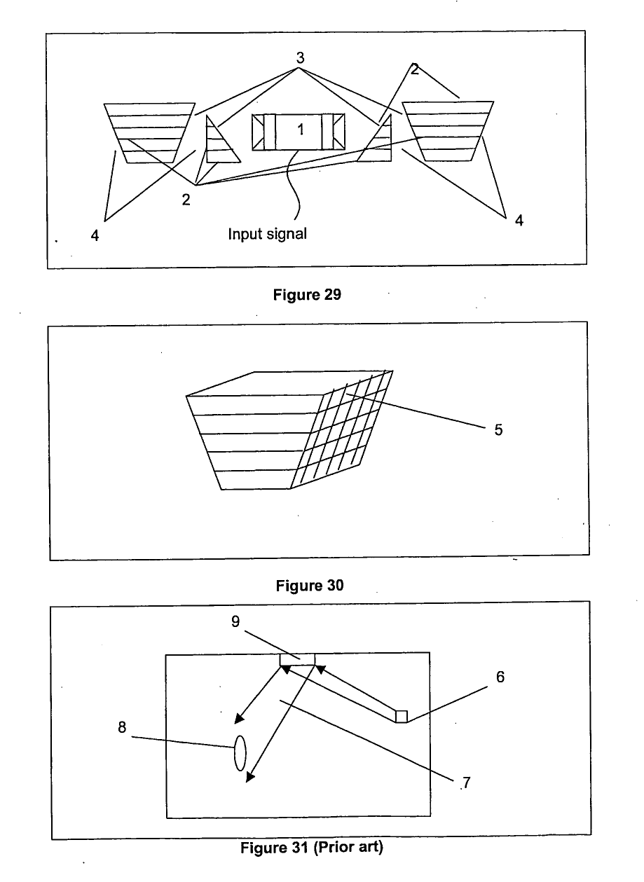

FIG. 29 shows the general configuration of the diffusive source apparatus wherein a sound source 1 comprising a dipole loudspeaker 1 in the art has output coupled to a series of transmissive acoustic resonant structures with spatial location and response of resonant eigentones designed so as to in part provide the desired acoustic frequency response and directivity. A group of such filters 2 provide characterised reflection of acoustic energy 3 and transmission of said frequency and spatially modified sound to a cavity radiating toward the target environment 4.

FIG. 30 shows one block of transmissive acoustic resonant structures with spatial location and response of resonant eigentones and also showing each resonant structure 5 in the block.

FIG. 31 shows the placement of one prior art source 6, one dominant specular reflection 7 to one listening position 8. also shown is the prior art treatment of a diffusive treatment by a large wall diffuser at 9.

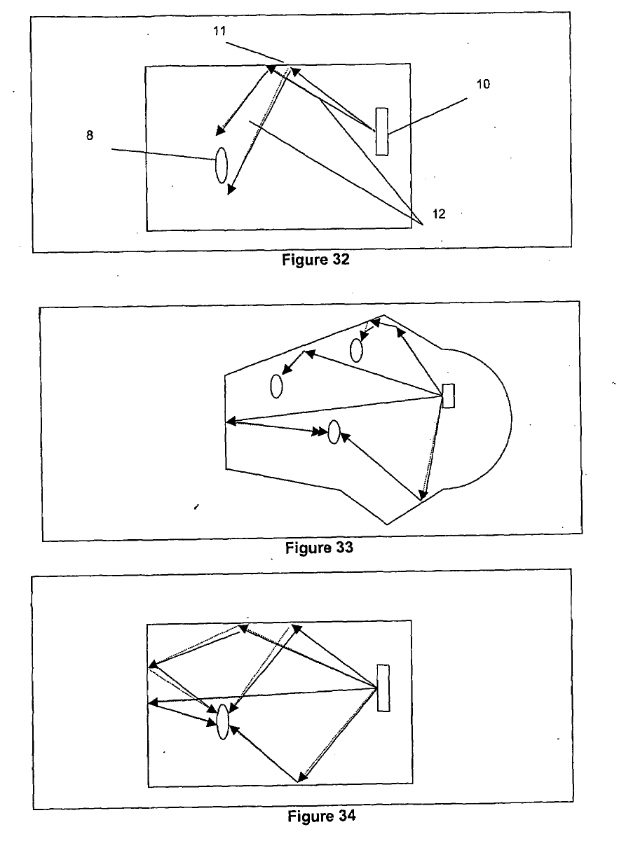

FIG. 32 shows the use of the invention 10 to provide a diffusive source 12 toward such specular reflection surface 11 and the resultant sound at the listener location 8.

FIG. 33 shows the extension of the approach to cover all troublesome specular reflections at all locations in the room.

FIG. 34 shows a general room geometry.

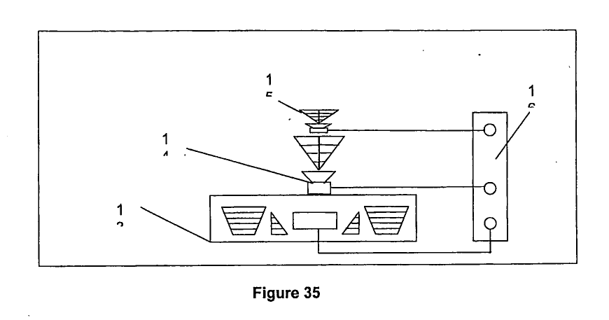

FIG. 35 shows the use of the invention in conjunction with two or more electro-acoustic transducers each covering a specific band or direction of coverage or both. In this figure, electro-acoustic transducers 13, 14 and 15 each have their own instance of the invention with the signals having been split one or more passive or active crossovers 16 as known in the art.

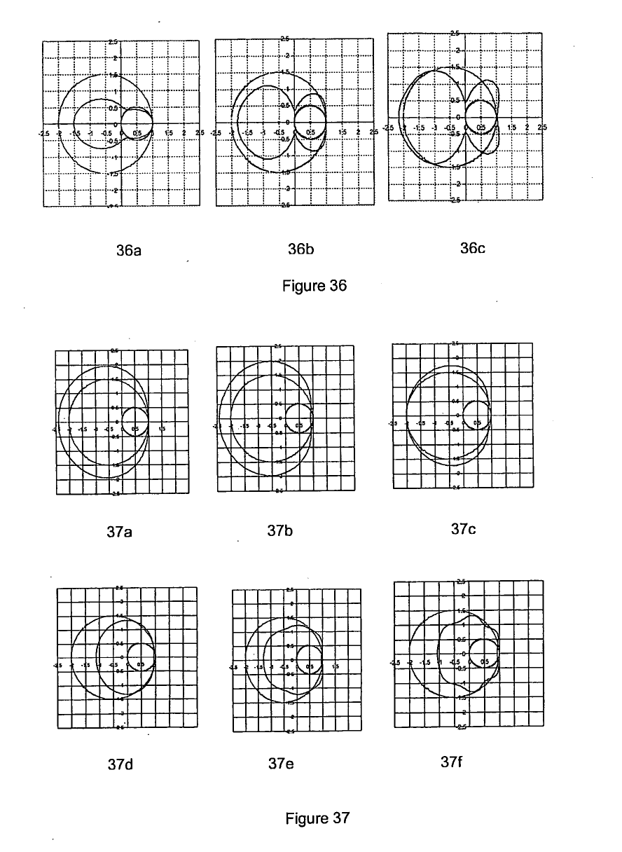

F. FIG. 36 shows graphs 36a, 36b and 36c being representation of the propagation of a wavefront at an instant of time after the initiation of waves from two electro-acoustic omnidirectional apparatus located at the points (0.5,0) to the right of the origin and (−0.5,0) to the left of the origin, and each being fed with a signal wherein the amplitude and phase of the signals can be adjusted as desired for any frequency, said graph representing a section of the 3-dimensional sound field there-from by virtue of the axial symmetry about the x axis.

FIG. 37a to 37f shows the graphs of the wavefronts for the corresponding frequencies of 500 Hz, 1 kHz, 2.5 kHz, 5 kHz, 15 kHz and 20 Khz where the amplitude and phase processing for the devices has been so adjusted as to present no curvature on the wavefront, said reproduction representing the acoustic horizon and said apparatus being able to reproduce sound sources containing all frequency components at accurate distances from the acoustic horizon forward towards the listener.

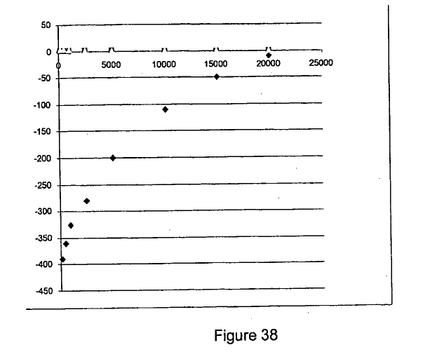

FIG. 38 shows the corresponding relative frequency—phase and frequency—amplitude requirements for the two devices of FIG. 37.

39 shows the general configuration of the personal vector wavefront capture, coding and reproduction invention for the simple case described above, wherein two sources SOURCE1 And SOURCE2 are at distances D1 and D2 and are captured on the apparatus elsewhere described in the invention utilising four cardioid microphone elements, said signals then being directly distributed to the point of use decoder where the metadata has been preset or is now set to being the direct channel render case. The point of use render apparatus POUR1, POUR2, POUR3 and POUR4 then being set to directly connect each channel to the appropriate electro-acoustic devices of the shown ‘voyeur’ configuration solely.

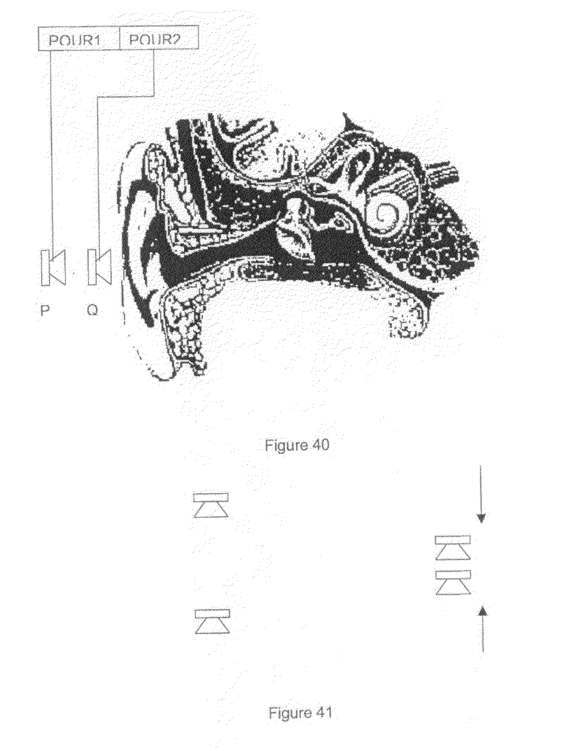

FIG. 40 shows the general configuration of the vector wavefront in-ear in pinnae and represents the general form of the over ear apparatus wherein the decoder apparatus POUR1 and POUR2 set the desired render distances and acoustic horizon.

FIG. 41 shows the general configuration of the vector wavefront electro-acoustic apparatus wherein the preferred embodiment features the collapsing of the spacing of the two devices in each group with the vector wavefront render processing adjusting with a set amplitude and phase correction for the apparatus being implemented in the Point of use decoders.

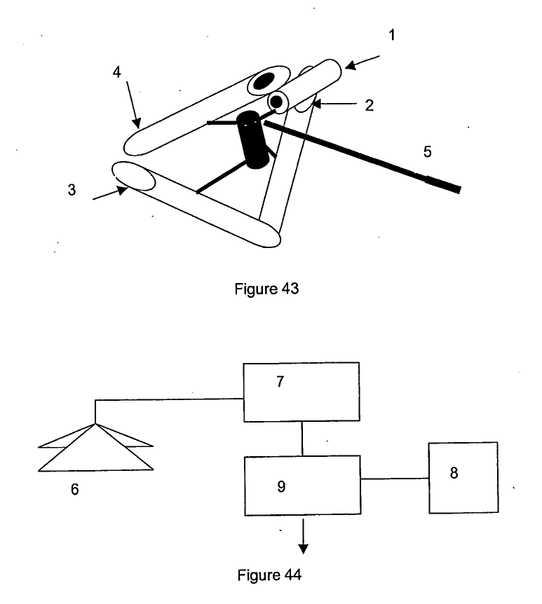

FIG. 43 shows a schematic of the apparatus but without cables for clarity. The four cardioid microphones 1, 2, 3 and 4 of the art are shown with the identifying arrows pointing to the cable connector end of each microphone being away from the active end.

FIG. 44 shows signals from said microphones 6 are then fed to a controller part of the invention 7 and on to the encoder 9 combining the or any authorisation and render metadata 8 for transmission by the common electrical vector wavefront format.

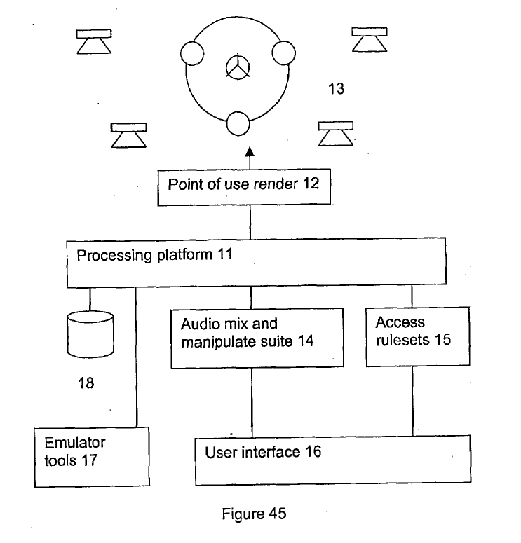

FIG. 45 shows the electrical vector wavefront signals from the or each vector wavefront apparatus of FIG. 44 are received by the processing platform that can be all digital or partly analogue and partly digital, and are stored in the persistent data store 18. wherein the signals are able to be both rendered or reproduced on a suitable format apparatus 12 and 13 as described elsewhere in the invention for the purposes of auditioning the resulting output, said facilities including all required formats including legacy. A suite of tools for audio object mix and manipulation is provided with access through a user interface 16 that also supports the entry of authorisation data for the authorisation rule-set generator 15. Emulator toolsets providing automated production, test and verification capability, 17 are also shown in the figure.

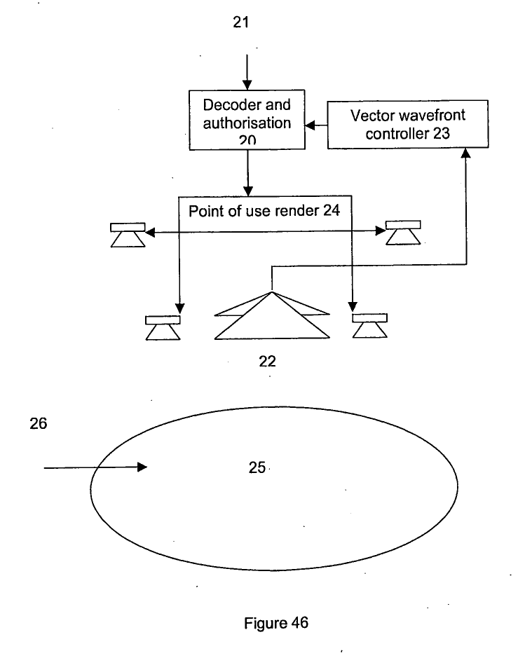

FIG. 46 shows the preferred embodiment having an electrical vector wavefront source including authorisation and parametric data descriptions for early reflections and reverberant field components 21 being received by the decoder and point of use render apparatus shown as 24 for presentation to the voyeur format of electro-acoustic apparatus in this case and being presented for the listeners in the listener area 25. The listener area or the immediately surrounding region has a vector wavefront microphone apparatus 22 that receives signals representing the sound listener area selectively with regard to distance and direction and the vector wavefront controller 23 presents these signals suitably processed to the point of user render apparatus 24 for inclusion in the render back to the room,

Additionally, undesirable sounds 26 including low frequency sounds originating from outside the listener area are shown in schematic form.

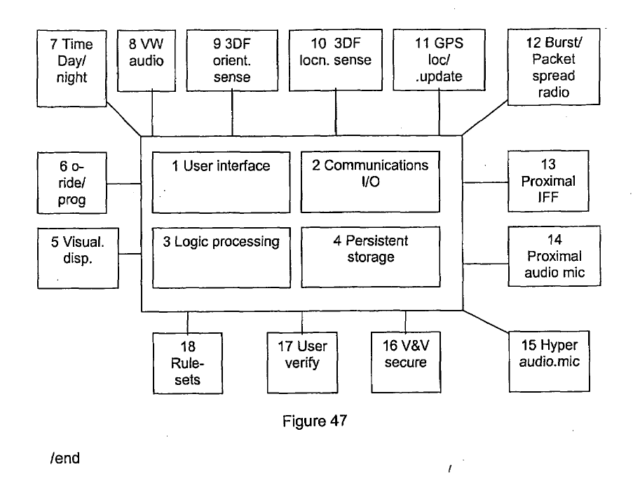

FIG. 47 shows the general configuration of the audio apparatus wherein a central electronic capability including a user interface for programming and display (1), a communications and input/output (2), a core logic processing part which may be a central processing unit or distributed processing units (3) and some form of persistent storage capability (4) is provided. A visual display part (5) is provided. An override and program facility (6) is provided. Some means of determining the ambient light level and the time including day/night lighting situation (7) is provided.

The apparatus for vector wavefront audio render including decoder capability and point of use render with metadata support as described elsewhere in the invention is provided (8).

Two sensors or sensor sets or other apparatus of the art being either of accelerometer or other orientation and location sensing being GPS or packet base station timing and trigonometry basis, (9) being the rotation or orientation sensing and (10) being the absolute or relative location determination are provided.

Communications facilities (12) including a diversity of means including burst packet spread spectrum and omni-directional and directional via radio or optical means is provided.

Some form of proximal based identification of friend or foe (13) is provided. A proximal audio microphone (14) being either of the type described in the invention or other is provided for the capture of the ipso-sound of the invention from the user. This facility may or may not be provided together with a so-called hyper-audio microphone of the invention (15) enabling enhanced forward hearing and or zoned hearing with distance capability.

Verification and validation security facilities are provided to identify the valid user (17) and the valid other users able to communicate with the user, (16) said authorisation also ensuring appropriate levels of access and access denial.

A suite of rule-sets (18) generally defining the programmed and learnt behaviours required is also provided said rule-sets applying to the management of the overall apparatus as well as its use.

### PREFERRED EMBODIMENT OF THE INVENTION

A. In a preferred embodiment of the common format vector wavefront source apparatus part of the invention, a quad of suitable directional cardioid microphone capsules having directional characteristics derived from the scalar and gradient field components being implicit in their construction is used to capture distance and direction information for a number of sound objects by placing the said quad as close as practicable to a single location, but so oriented as to have pair of elements generally in a plane to the left side of the intended capture region, one element of the pair generally oriented towards the rear left of the intended capture region over the top of the objects and one oriented to the front.

A similar pair is used generally in a plane to the right, again with one element towards the rear and one towards the front, with the angles chosen such that the 3 dB points on the directional patterns in the chosen direction of the sound field correspond for all microphones. This is not a common format of microphone element orientation and placement. By said means the simplest capture of a vector wave-front field in electrical terms is achieved, with the electrical signals from said microphones representing the sound field forward and back and left and right components directly, and with 4 signals being required.

The said signals are then transmitted directly or stored for later transmission to the listener environment, being accompanied by an appropriate format structure code and separately and authorisation code for use by the point of use render equipment in enabling the render of said sounds. It is noted that the sum of the left channel microphone signals and the right channel microphone signals represents an averaged stereo pair signal in this case.

In a preferred embodiment of the Point Of Use Render apparatus part of the invention, the vector wavefront electrical signals are received and stored for later transmission or directly transmitted or connected to an apparatus located at the point of use, and referred to herein as the Point of use render apparatus. The vector wavefront signals are accompanied by an authorisation code of the public and private key type in the art, intended to restrict decoding and render formats to those authorised and further detailing intended end configurations and features for reproduction by way of electro-acoustic apparatus render. In the preferred simplest embodiment, said authorisation being by, but not restricted to the authorised placement and presence of the digital decoding software Dolby AC3 in the art in the render apparatus, said apparatus being under direct control of the source by nature of the format availability and allocated audio channels by protected menu access. The point of use render apparatus then decodes the said signals to provide audio strings fed to the reproduction apparatus being of a non-equidistant nature, and suitably located to reproduce a scaled version of the source, said apparatus consisting of four two way aperture filtered directional loudspeakers in the vector wave format and able to cover the whole of the listener area, the far set being placed at approximately listener ear height and presenting an angle of 60 degrees to each other and thus thirty degrees to the centre of the listener area and approximately 3 metres away from said centre of the listening area, location also including immediately adjacent to the boundary of the region including the listening area, and the near set again being placed on the floor boundary of the listening area and again at an angle of 60 degrees to each other but at a distance of 1.5 metre from the said centre of the listening area, and each said apparatus being of small profile so as not to obstruct the sound field emanating from the far or rear set, said electro-acoustic apparatus presenting in left and right array pairs of the invention, and said point of use render apparatus reproducing the channel signals by direct connection to the derived format channels and said sound images then being reproduced in space with attributes of beside, above behind and in front of being preserved from all locations in the listening area, said reproduced objects behaving as consistently located objects in space as observed from the listening area when stationary and when moving without the need for personal apparatus for each listener.

In a preferred embodiment of the three format encoder/decoder part of the invention, the recording and encoding and distribution format is as described and the said POUR apparatus is used in a consistent manner as described, the format of the electro-acoustic apparatus as described is referred to as the format described as ‘voyeur’, and presenting a consistent reproduced image in a restricted space as observed from the listener area, and the sound reproduction being optionally accompanied by static or moving images of suitable from.

The reproduction format then being changed to provide three sets of paired near and far devices arranged radiating out from a point and at listening height to a radius line separated by 1.5 metre and an angle of 120 degrees and at floor level, and the point of use apparatus being altered to derive the amplitude and phase signals corresponding to the three vector wavefront directions of the reproduction apparatus, said signals being derived from the source electrical signals in the simplest manner by summing of all the said electrical signals then being configured to be fed to all far loudspeakers of the pairs in the centre of the configuration, and the directional signals corresponding to the desired directions being at 120 degrees being obtained by simple addition subtraction and feeding through of the electrical signal pairs, taking advantage for the vector wavefront nature of the said electrical signals. This configuration of the reproduction apparatus is referred to as ‘bubble’ and the listening area being restricted to being anywhere around the said apparatus outside the radius described by the said near apparatus.

The reproduction format then being changed to provide three sets of paired near and far devices now arranged radiating in from a radius and at listening height to a radius line in 1.5 metre towards the listening area and an angle of 120 degrees and at floor level, and the point of use apparatus being altered to derive the amplitude and phase signals corresponding to the three vector wavefront directions of the reproduction apparatus, said signals being derived from the source electrical signals in the simplest manner by summing two of the said electrical signals then being configured to be fed to one far unit of the three pairs of the configuration, the remaining two far units of the pairs being fed a vector mixed combination of the closest aligned capture signal and the scaled nearest modifier electrical signal to provide the required decoded vector angle signal for presentation or render, and the directional signals corresponding to the corresponding near unit of each set being likewise derived from scaled sums to represent the electrical signals in the general desired direction for each unit taking advantage for the vector wavefront nature of the said electrical signals. This configuration of the reproduction apparatus is referred to as ‘immersive virtual reality’ and the listening area being restricted to a bounded region inside the radius of the nearest units or apparatus.

In a preferred apparatus using the omni-directional electro-acoustic apparatus the previously described bubble format replaces the three centre directional apparatus with the single omni apparatus having the desired radiation characteristics covering the listener area.

In a preferred embodiment of the controlled directivity wide range loudspeaker improvements part of the invention, the electro-acoustic apparatus unit of the pairs are the improved apparatus, thus enabling larger listening areas with improved fidelity.

In a preferred embodiment of the apertured controlled directivity, FIG. 6b shows the use of controlled apertures electro-acoustic sources where the choice of electro-acoustic source (i) effective size is made based on the desired angle of uniform sound emission at the highest frequency of interest based on the aperture based dispersion of the art. Multiple said electro-acoustic transducers are then mounted in suitable geometry structures such that overall uniform coverage can be achieved, and including but not limited to truncated icosahedrons. FIG. 6c shows an apparatus of the present invention wherein a suitable electro-acoustic transducer (j) is modified by the placement of a cover with aperture between the active surface and the intended listening area and in close proximity to the active surface, said aperture diameter being chosen to provide the desired angle of uniform sound emission at the highest frequency of interest based on the aperture based dispersion of the art. Said combination of electro-acoustic transducer and apertured cover of the patent being separate parts or a new and combined apparatus of the patent and effecting an immediate improvement in dispersion angle or highest dispersed frequency of interest or both in addition to the distortion reduction and output level increases of the invention, said apparatus of the invention having electrical equalisation to achieve the desired frequency response according to the claims. The preferred embodiment consists of a 50 mm piston electro-acoustic apparatus having a wide range of frequency response. An apertured structure following the contour of the active surface such that at extremes of travel no contact is made, is sealed over the apparatus and a hole of 18 mm used separately or in combination in conjunction with a truncated icosahedron or “buckyball” shape having 32 said devices mounted there-through, said apparatus achieving controlled directivity up to 20,000 Hz in all directions, having reduced distortion and increased output capability at some frequencies and achieving a uniform output level between 200 Hz and 20,000 Hz with a suitable equaliser of the art, other geometries and combinations being possible, including so-called half-buckyballs or “buckycups” providing they desired radiation pattern when mounted on a boundary.

In a preferred embodiment of the apertured vector wavefront directional source and equalisation apparatus part of the invention, the electro-acoustic apparatus unit of the pairs are all replaced by the improved apparatus, thus enabling larger listening areas with improved fidelity and higher output with lower distortion in a smaller package as required.

In a preferred embodiment of the vector wavefront omni-directional source part of the invention, the electro-acoustic apparatus of the far pairs are replaced with the said apparatus, thus enabling larger listening areas with improved fidelity, and enabling the use of the listening region boundaries.

In a preferred embodiment of the vector wavefront sectored source part of the invention, the centre or far apparatus of the said bubble format is replaced with the said apparatus with the option of separately deriving the desired vector wavefront signals for each of the said sectors, or in the case of the unified format following the centre units are the said sectored source units and the signals are decoded and fed appropriately.

In a preferred embodiment of the apertured vector wavefront sectored source and equalisation apparatus part of the invention, the vector wavefront sectored source is replaced with the sectored source to provide increased listener area and improved fidelity with higher output and reduced distortion in a smaller package as required.

In a preferred embodiment of the unified vector wavefront format part of the invention, the said POUR decoder derives vector signals corresponding to the closest desired point of the render, and the furthest or vanishing points in the appropriate direction, and said vector wavefront electrical signals are fed to a configuration of loudspeakers comprising duplications of the sectored omni unit on the ceiling and floor of the listening region on a vertical axis, and duplications of the omni or sectored omni radially separated by approximately 1.5 metre on the ceiling and floor but depending on the desired image size.

The detailed descriptions and preferred embodiments of the apparatus used in each of the formats are described elsewhere in the patent. The claims here described relate to the format and the coding and decoding.

In a preferred embodiment of the early reflection capture and encoding aspect of the invention, referring to FIG. 9 and more particularly FIG. 10, the sound simultaneously emitted by a virtual source at A′ as at the source at A will present the same resultant field to the listener area as would be presented by the specular reflection from the said portion, and this when combined with any diffuse reflection from the portion both being suitably spectrally modified by the characteristics of the propagation distance and more particularly the reflection components will replicate the conditions of the said early reflection. If an apparatus capable of creating multiple sound sources in space at specific relative locations were then used, the sound field representing the behaviour of both the direct sound and the said early reflection could be faithfully reproduced for the or each listener simultaneously. By this means the reproduction of multiple early reflections in conjunction with a direct source can be accurately reproduced for multiple listeners and listener locations and listener movements.

In this embodiment, and again according to FIG. 10, let 111 equal 2 metres, 112 and 113 together being 2 metres also and 109 being the listening area boundary parallel to the line from the source A generally to the listening area, 114, 115 and 116 then being 1.414 metre.

In a preferred embodiment of the reproduction part of the invention, referring to FIG. 11 showing the common distribution format of the invention together with metadata particularly containing information regarding early reflections 117 being received by a point of use apparatus including a decoder able to present the vector wavefront audio and including the configuration for render of the direct sound correctly placed at A″, and the specular sound source from the decoded metadata to point A′″ appropriately scaled and spectrally treated and the diffuse sound source from the decoded metadata to point A″″ again appropriately scaled and spectrally treated including turning off the diffuse component to in this case four point of use render apparatus POUR1, POUR2, POUR3 and POUR4, said render configuration being set in this case to utilise a voyeur vector wavefront configuration in this case including electro-acoustic apparatus 120, 121, 122, and 123 to the listener area 124 said decoding detail being described elsewhere in the invention.

In this embodiment and again according to FIG. 11, the relative locations of the reproduced sources are scalable but the preferred embodiment shows exact scaling. In this case, taking A″ as the reference and fixing the locations of the electro-acoustic transducers such that all are in front of the listening area for the used voyeur format and the extreme lateral positions of 122 or 120 are beyond the required lateral location of the extreme virtual sources herein described, the parameters of POUR1 to POUR4 are set to reproduce the sources for the forwarded parametric specifications at the locations according to the original source.

There also exists a configuration of recording capture and reproduction apparatus enabling direct render of the vector wavefront signals to the respective electro-acoustic apparatus enabling correct reproduction of the direct and reverberant sound fields also, though this is restricted to a single configuration and listening location and is considered too restrictive for a preferred embodiment clearly establishing the scope of the invention.

Where the electro-acoustic transducer locations are not able to be beyond the lateral extremes of the required virtual images, the transfer function render of the invention elsewhere described will also be required in the point of use render apparatus POUR1 to POUR4.

In a preferred embodiment of the mode finder part of the invention, according to FIG. 12 at low frequencies wherein the particle velocity of a local region is deduced from the alternating pressure at two points as measured by two point pressure microphones 130 and 131 being separated by a set distance 132, said particle velocity having direction being determined by the difference signal of the microphones and being related to the pressure at two points by the characteristic impedance of the medium of propagation.

A filter block 133 enables the selective extraction of the frequencies of interest either discretely by analogue or digital circuitry or continuously using digital processing of the art. The signals from the two microphones are simultaneously passed to essentially a phase differencing apparatus or circuit indicating that the signal from one microphone leads 138, or lags 139 the other or is coincident to within the sensitivity of the apparatus at the frequency of interest, and an amplitude circuit indicating the presence of signal at the frequency of interest, essentially by summing the two microphone outputs so filtered.

The outputs of the two processing apparatus or circuits is then passed to a display device that indicates the presence of an in-band signal and the phase co-incidence or otherwise, said display utilising arrows on the device displaying the direction the device should be moved in 1 dimension by turning about the axis through the centre of the two microphones such that one microphone moves through the fiend gradient relative to the other by determining the minimum phase error at the desired frequency.

In a preferred embodiment of the dogbone part of the invention, FIG. 13 shows a signal processing apparatus or circuit 145 having capability to support more than one apparatus according to FIG. 12 with four microphone elements 150, 151, 152 and 153, grouped in pairs diagonally across the apparatus such that 150 and 152 form a pair and 151 and 153 form a pair, said pair being as far away from each other as possible on the apparatus in order to maximise the sensitivity of the apparatus at the lowest frequency of interest. The signal processing then operates display devices indicating the direction needed to move the apparatus in order to approach or move away from the equi-phase condition, thus enabling the user to move the apparatus towards a node or anti-node according to the art in a room or other environment having direct and reflected low frequency energy. Two such apparatus are included in the apparatus of FIG. 15, wherein advantage is taken of using one microphone element as common to the two axes of the apparatus, the microphone pairs thus formed being on each leg of the apparatus 155 and 156, but the desired behaviour being deduced from the crossed axes. Other geometries of apparatus and displays are possible.

In a preferred embodiment of the wave focus room apparatus part of the invention, FIG. 17 shows the modelling of a wave propagation in an ideal ellipsoidal room where the propagating wave is launched from one of the two focus points of the ellipsoid in the art. The series of time sequenced graphs starting top left and progressing row by row show the direct wave and the influence of the boundary on propagation. The wave sequence continues from the bottom right corner graph back through the sequence as the wave subsequently passes the focus and diverges and converges back to the original focus point after two propagation periods.

FIG. 18 shows the integrated acoustic energy density over a spherical space the size of a human head and located at the second focus point. The initial spherical component arriving early and the main boundary or wave focused component can be seen.

FIG. 19 shows the effect of moving the source location by 300 mm up from the first focus point on the arrival wave after the said one elapsed propagation period. The graph shows the de-focusing effect of moving the source a small distance.

FIG. 20 shows the integrated energy density observed at the integration point a and indicating that the early arrival wave s largely unchanged but lowering of coupling efficiency and temporal smearing has occurred.

FIG. 21 indicates the propagation of a spherical wave in a rectangular room in a series of elapsed time graphs. The source is located at the point one metre up and one metre to the right relative to the centre of the room. The point of convergence of the propagating wave influenced by the boundary is at the location one metre down from the centre and one metre to the left being the same distance through the centre of mass of gas in the room.

FIG. 22 shows the integrated energy density observed at the integration point being the image point and indicating that the early arrival wave is as expected and that the boundary reflected or wave focussed energy is both temporally smeared and of lower level but that the level is not greatly different to that achieved in the ideal ellipsoidal room case when the source is move 300 mm. lowering of coupling efficiency and temporal smearing has occurred. Thus, the invention has achieved a reduction in room mode influence and an improvement in source to listener coupling by taking into account the room boundary wave focussing effect according to the general rule of the method of centroids, and the said “dogbone” apparatus has been used to provide the location tool for fine tuning of any acoustic environment for low frequency reproduction listening location. It is further noted in the preferred embodiment that the method of reciprocity allows the transposing of the source and the listening locations thus enabling the “dogbone” apparatus to locate the best woofer location given a chosen listening location as is usually the case. According to the method of the invention, the low frequency source is located at the listening location and the said meter used to locate the ideal coupling point. The woofer is then fetched.

In a preferred embodiment of the low frequency annihilation part of the invention, combined for the purposes of a preferred embodiment of the zoned mode control part of the invention, but not necessarily being so in the general use, FIG. 23 shows the cross section or elevation through a cinema 170 having a main seating area 174, a balcony seating area 176 and stalls seats below the balcony 175. Arrays of low frequency apparatus each generating a largely plane wave, though with unavoidable spherical component are mounted such that the wave so generated is orthogonal to the floor section under the seats for the corresponding regions 172 for 176, 174 for 171 and 170 for 173. The signal delay for each array is adjusted such that all patrons receive simultaneous arrival of low frequency content, said sound arrival also being advanced overall in time as to match any visual signals or said visual signals being relatively delayed, whilst the low frequency transducers are fed an appropriately time delayed inverse signal with the intent of removing the reflected energy from the whole cinema after delivery to the listeners and thus avoiding the establishment of modes as much as possible. The said “dogbone” meter provides a tool for adjustment of said environment according to the method.

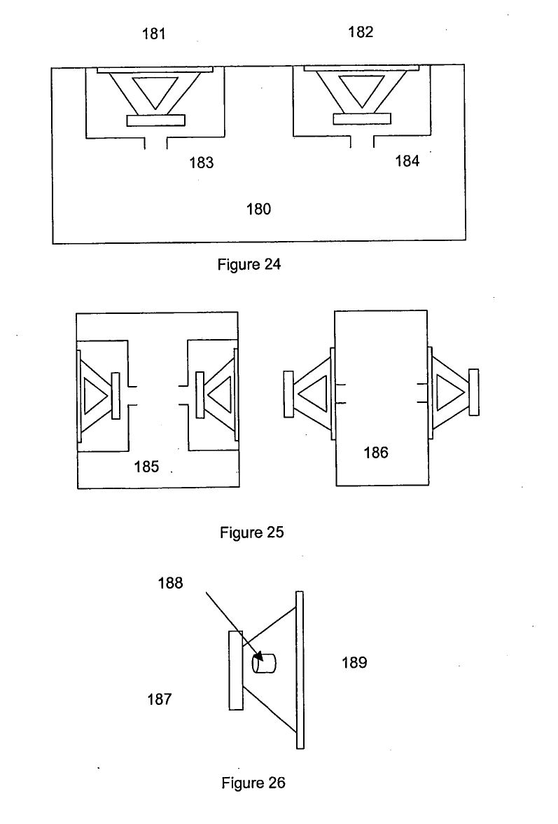

In a preferred embodiment of the low frequency coupler plate part of the invention, FIG. 24 shows the general configuration of the low frequency coupler plate apparatus together with an enclosure containing two electro-acoustic transducers of the art. 181 and 182, each having one active surface facing outward from enclosure 180. Within the enclosure coupler plates 183 and 184 are placed such that the only means of volume velocity from the other active surface is through the said aperture and the apparatus forming a cavity towards the other active surface such that the acoustic low pass filter so formed offers little resistance to alternating gas flow.

In a preferred embodiment of the leakage compensator part of the invention together with a preferred embodiment of the zero acceleration part of the invention and the controlled source impedance low frequency part of the invention and the leakage compensation part of the invention, FIG. 28 shows two leaky environments 192 and 193 with the apparatus between wherein the gas from one side of the active surface of each electro-acoustic apparatus of the invention is coupled to the listening area through aperture 192 and the enclosure, said enclosure and aperture together providing the desired frequency response when driver design parameters are taken into account using Thiele/Small as in the art and said response is largely unchanged by the orifice plates of the invention. The aperture 192 providing a relatively small aperture being approximately 25% of the diameter of each transducer active surface in this embodiment and thus suiting wave focus delivery for the listening environment as described elsewhere in the invention. The other side of the active surface of the transducers is each coupled to the other leaky environment that could include an enclosure or another room or the outside world or such through one or more apertures 193, 194, 195 and 186 that are so placed as to be as far away from each other as possible yet satisfying the design requirement of offering little restriction to alternating gas flow in the frequency range of interest. Further, the placement of the two transducers generating opposing forces in use serves to minimise any structure borne accelerations or forces that could otherwise be transferred to surrounding structures.

In the embodiment, the electro-acoustic transducers of the invention are 380 mm in effective surface diameter, the aperture 192 is 150 mm in diameter, the enclosure is overall 450 mm by 450 mm by 450 mm, the apparatus orifice is each 100 mm and 150 mm long and so placed as to take advantage of the wave focus effect within the cabinet being placed opposite the tube 192 and the spread apertures are each as lose as possible to the corners of the overall enclosure.

The behaviour of the wave propagation within the listening region and the adjacent region is also in accord with the wave focus part of the invention previously described, but advantage is taken of the boundaries in the listening room to focus the energy of the small source area there presented for the delivery to the intended listening area and advantage is simultaneously taken of the temporal spreading of the wave focus in the adjacent region to minimise high acoustic energy locations said spreading allowing for acoustic impedance differences between the two said leaky environments whilst still ensuring equal total alternating gas volume velocity to ensure best overall attenuation from the overall structure in the far field. Noting that the apparatus of the aperture plate suits all enclosures with two or more electro-acoustic transducers whether of the invention or of the art and with the invention of the coupling plate.

In a preferred embodiment, a new acoustic apparatus is provided that uses a sequence of transmissive multi-resonant acoustic structures cascaded in a leaky structure. Such a structure is interposed between a sound source and the acoustic path to the listener area and any associated specular or diffuse room boundaries.

A sound source 1 comprising a dipole loudspeaker 1 in the art has output coupled to a series of transmissive acoustic resonant structures with spatial location and response of resonant eigentones designed so as to in part provide the desired acoustic frequency response and directivity. A group of such filters 2 provide characterised reflection of acoustic energy 3 and transmission of said frequency and spatially modified sound to a cavity radiating toward the target environment 4 that also couples to one or more additional transmissive acoustic resonant structures with spatial location and response of resonant eigentones designed so as to provide the desired acoustic frequency response and directivity. This process is repeated so as to achieve the overall acoustic response.

FIG. 2 shows one block of transmissive acoustic resonant structures with spatial location and response of resonant eigentones designed so as to provide the desired acoustic frequency response and directivity, without any unwanted resonances. Each resonant structure 5 in the block is so designed as to provide a series of transmission and reflection peaks and dips in response such that the overall response of the block achieves the desired frequency energy density and spatial radiation pattern.

FIG. 3 shows the prior art placement of one source 6; one dominant specular reflection 7 to one listening position 8. In the prior art, the only available diffusive treatment would be a large wall diffuser 9.

FIG. 4 shows the use of the invention 10 to provide a diffusive source 12 toward such specular reflection surface 11 and the resultant sound at the listener location 8. The nature of the direct and reflected sound at the listener is diffusive and so minimal combing effects are evident. By this means the specular reflection is rendered as a diffusive reflection from the point of view of the or each listener.

FIG. 5 shows the extension of the approach to cover all troublesome specular reflections at all locations in the room.

FIG. 6 shows extension is possible to a general room geometry.

FIG. 7 shows the use of the invention in conjunction with two or more electro-acoustic transducers each covering a specific band or direction of coverage or both. In this figure, electro-acoustic transducers 13, 14 and 15 each have their own instance of the invention with the signals having been split one or more passive or active crossovers 16 as known in the art. With this embodiment, placement of the various drivers relative to each other is not as critical as would be the case with a coherent multi-driver loudspeaker.

Specific applications of the invention include capture and treatment of live sound sources including air conditioning duct and other intrusive or unwanted noise sources, and with performers and instruments to control the spectrum, diffusive nature and frequency response of the reflected and transmitted sound, use of apparatus including the invention and one or more electro-acoustic transducers in conjunction with electronic signal processing of the source signal by reception through one or more microphones, use of the invention for treatment of reproduced sound in the reproduction environment either with or without additional treatment of reverberation and spectral decay with or without an accompanying direct sound source or sources.

Finally it is to be understood that various alterations, modifications and/or additions may be introduced into the constructions and arrangements of parts previously described without departing from the spirit or ambit of the invention.

In a preferred embodiment of the vector wavefront capture, controller and reproduction apparatus part of the invention, a part of the invention, FIG. 36 shows the general configuration of the vector wavefront and controller apparatus wherein each of graphs 36a, 36b and 36c shows the propagation of a wavefront at an instant of time after the initiation of waves from two electro-acoustic omnidirectional apparatus located at the points (0.5,0) to the right of the origin and (−0.5,0) to the left of the origin, and each being fed with a signal wherein the amplitude and phase of the signals can be adjusted as desired for any frequency, said graph representing a section of the 3-dimensional sound field there-from by virtue of the axial symmetry about the x axis. The wavefront arriving at the or each listener will represent a divergence traceable back to a set point and this point is characterised by the radius of curvature of the said wavefront bathing the listener in the sound. The large circle represents the radius of propagation from the origin point arbitrarily at the point (0,0). From the graphs it can be seen that the radius of curvature of the wavefront in 36a is smaller than the radius of curvature of the wave propagating from the nearest device and hence the perceived distance of the wave is closer than the nearest device. In 36b the radius of curvature of the wavefront has been adjusted to represent a sound source infinitely far away by virtue of the lack of curvature of the wavefront towards the listener. By the adjustment of the amplitude and phase of the signals to the said devices, described in the invention as vector wavefront render, sound sources can be placed at desired distances at will, said distances being in essence from the acoustic horizon well behind the devices to well in front of the nearest device as far as the listener is concerned, and not just restricted to but also including between the devices in a consistent manner, determination of the appropriate amplitude and phase processing requirements for the said distances also taking into account the spacing of the said devices.

FIG. 36c shows a wavefront that represents a sound source either further than infinity away or yet to represent a point source. This wave provides some degree of confusion to the listener with regard to location, and provides for interesting effects.

FIG. 37a to 37f shows the graphs of the wavefronts for the corresponding frequencies of 500 Hz, 1 kHz, 2.5 kHz, 5 kHz, 15 kHz and 20 Khz where the amplitude and phase processing for the devices has been so adjusted as to present no curvature on the wavefront, said reproduction representing the acoustic horizon and said apparatus being able to reproduce sound sources containing all frequency components at accurate distances from the acoustic horizon forward towards the listener. By this strategy of amplitude and phase control any set distance can be presented by adjustment of amplitude and phase.

FIG. 38 shows the corresponding relative frequency—phase and frequency—amplitude requirements for the two devices of FIG. 37. The functions are seen to be continuous, having some degree of freedom to choose the device spacing and potentially the electrical and acoustic filtering for each device separately.

It is a further capability of the invention that because a constant time delay is equivalent to a linear phase shift with frequency, certain configurations of source capture point relative to source locations with correct divergence capability for the vector wave capture will provide the correct phase shift with frequency to allow the direct recreation of the source locations for appropriately located reproduction apparatus by direct connection of the apparatus with the simplest of coders being purely amplitude scaling, thus enabling simple apparatus and seamless compatibility, though this in no way conveys the true scope of the invention.

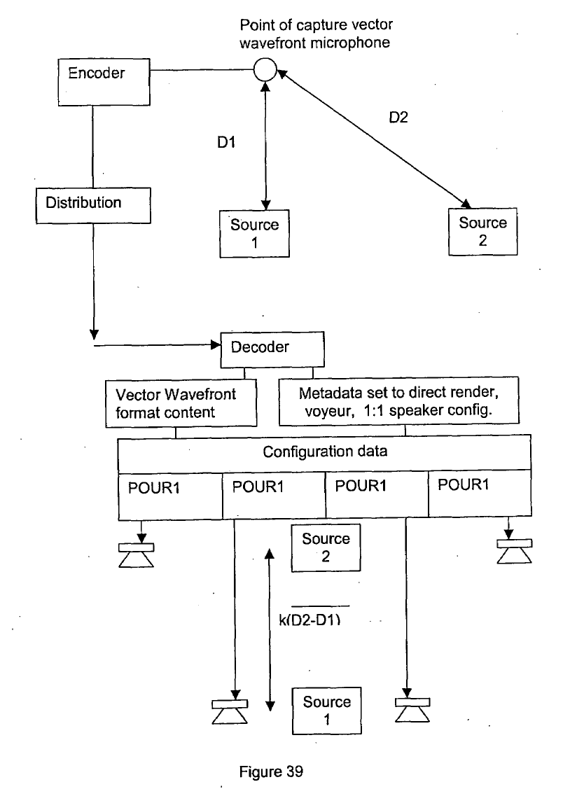

The preferred embodiment of FIG. 39 shows the general configuration of the personal vector wavefront capture, coding and reproduction invention for the simple case described above, wherein two sources SOURCE1 And SOURCE2 are at distances D1 and D2 and are captured on the apparatus elsewhere described in the invention utilising four cardioid microphone elements, said signals then being directly distributed to the point of use decoder where the metadata has been preset or is now set to being the direct channel render case. The point of use render apparatus POUR1, POUR2, POUR3 and POUR4 then being set to directly connect each channel to the appropriate electro-acoustic devices of the shown ‘voyeur’ configuration solely.

Considering just the relative distance of the reproduced or recreated sources and interpreting as phase shifts proportional to distance as previously described, the difference between the two perceived distance as perceived from the listening area is then simply a scaling constant times the vector difference between the sources according to the trigonometry of the source capture configuration, said arrangement being fully scalable to multiple sound sources for both the near field and the far field.

FIG. 40 shows the general configuration of the vector wavefront in-ear in pinnae and represents the general form of the over ear apparatus wherein the decoder apparatus POUR1 and POUR2 set the desired render distances and acoustic horizon.

FIG. 41 shows the general configuration of the vector wavefront electro-acoustic apparatus wherein the preferred embodiment features the collapsing of the spacing of the two devices in each group with the vector wavefront render processing adjusting with a set amplitude and phase correction for the apparatus being implemented in the Point of use decoders.

The general configuration of the vector wavefront over-pinnae apparatus includes the non equidistant feature of the invention but may utilise more than two electro-acoustic apparatus for each ear.

The percussive sound control is by conformal earplug including the said non-equidistant apparatus of the vector wavefront invention, and may or may not use additional external sound attenuation devices such as earmuffs.

In a preferred embodiment of the Vector wavefront capture microphone and production apparatus, FIG. 1 shows a drawing of the preferred embodiment of the microphone apparatus together with the supporting boom and the connecting cables. FIG. 2 shows a schematic of the same apparatus but with the cables removed for clarity. The four cardioid microphones 1, 2, 3 and 4 of the art are shown with the identifying arrows pointing to the cable connector end of each microphone being away from the active end. Being cardioid means having directional characteristics, though in this case being represented by a combination of pressure and pressure gradient elements internally in the art, thus being able to derive the particle velocity and satisfying the requirement of the invention for two non-equidistantly spaced elements for the purposes of a preferred embodiment and disclosure. The microphones also present the active general preferred direction of pickup axially from the end away from the cable connector. The dark structure being the mounting apparatus for the collection of microphones or array. The pairs of microphones 1/4 and 2/3 each form a crossed pair of elements as close as possible to a point, with the planes described by the pairs being at an angle of ninety degrees. The array being then mounted above the source area for the purposes of capture thus orienting each element to the further corner of the area.

Referring to FIG. 44, the signals from said microphones are then fed to a controller part of the invention 7 and on to the encoder combining the or any authorisation and render metadata for transmission by the common electrical vector wavefront format.

In a preferred embodiment of the vector wavefront production part of the invention, according to FIG. 45, the electrical vector wavefront signals from the or each Vector wavefront apparatus of FIG. 44 are received by the processing platform that can be all digital or partly analogue and partly digital, and are stored in the persistent data store 18. wherein the signals are able to be both rendered or reproduced on a suitable format apparatus 12 and 13 as described elsewhere in the invention for the purposes of auditioning the resulting output, said facilities including all required formats including legacy. A suite of tools for audio object mix and manipulation is provided with access through a user interface 16 that also supports the entry of authorisation data for the authorisation rule-set generator 15. By this means the operator is able to move, add and combine and treat sound sources, and can add to the metadata the necessary authorisation rules and the render rules including for the presentation in legacy formats such as channel associated stereo, 5,1, 6.1, 7.1, 10.2 and the like, providing the appropriate low frequency sound treatments, and the early reflections and reverberant capability including parametric specification where required and also producing said legacy output format in channel associated form and the encoded electrical vector wavefront audio signals. This capability being generally referred to as production in the art. Emulator toolsets providing automated production, test and verification capability, 17 are also include in the facilities.

In a preferred embodiment of the incidental sound treatment and ambient noise control part of the invention, FIG. 46 shows the preferred embodiment having an electrical vector wavefront source including authorisation and parametric data descriptions for early reflections and reverberant field components 21 being received by the decoder and point of use render apparatus shown as 24 for presentation to the voyeur format of electro-acoustic apparatus in this case and being presented for the listeners in the listener area 25. The listener area or the immediately surrounding region has a vector wavefront microphone apparatus 22 that receives signals representing the sound listener area selectively with regard to distance and direction and the vector wavefront controller 23 presents these signals suitably processed to the point of user render apparatus 24 for inclusion in the render back to the room, the said controller processing the said received signals with the acoustic characteristics of the source environment as received in parametric form or otherwise. Additional apparatus used may include other aspects of the invention such as the wave focus apparatus and the “whiteroom” controller for example.

By this means any intentional or unintentional noises made by the or each listener is presented back to the listener as if said listener was in the original environment and not the reproduction area.

Additionally, any sounds including low frequency sounds originating from outside the listener area also received and can be selectively treated with respect to their presence influencing the listener area undesirably, whether or not the listener is making any discernible noise.

In a preferred embodiment of the audio apparatus part of the invention according to FIG. 47, A central electronic capability including a user interface for programming and display (1), a communications and input/output (2), a core logic processing part which may be a central processing unit or distributed processing units (3) and some form of persistent storage capability (4) is provided n a compact packaging and with suitable power supply for portable use by the or each listener. Attention is paid to the or any emitted electromagnetic radiation with regard to both statutory requirements and said emissions being able to betray the location of the said apparatus.

A visual display part (5) is provided such that the requirements of the user are met, such display being heads up visor or goggle mounted, arm mounted or other means of the art.

An override and program facility (6) is provided enabling convenient change of status of the system for such factors as disable or stealth mode of the art. Some means of determining the ambient light level and the time including day night situation (7) is provided.

The apparatus for vector wave audio render including decoder capability and point of use render with metadata support as described elsewhere in the invention is provided (8). Two sensors or sensor sets or other apparatus of the art being either of accelerometer or other orientation and location sensing being GPS or packet base station timing and trigonometry basis, (9) being the rotation or orientation sensing and (10) being the absolute or relative location determination are provided.

Communications facilities (12) including a diversity of means including burst packet spread spectrum and omni-directional and directional via radio or optical means is provided.

Some form of proximal identification of friend or foe (13) is provided. A proximal audio microphone (14) being either of the type described in the invention or other is provided for the capture of the ipso-sound of the invention from the user. This facility may or may not be provided together with a so-called hyper-audio microphone of the invention (15) enabling enhanced forward hearing and or zoned hearing with distance capability.

Verification and validation security facilities are provided to identify the valid user (17) and the valid other users able to communicate with the user, (16) said authorisation also ensuring appropriate levels of access and access denial.

A suite of rule-sets (18) generally defining the programmed and learnt behaviours required is also provided said rule-sets applying to the management of the overall apparatus as well as its use.

By means of use of the said apparatus, the or each user is able to remain aware of the local environment audio, being able to enhance and control said audio views, whilst at the same time being aware of each and all other relevant users in an extended physical region.

Finally it is understood that the descriptions and embodiments in no way restrict the scope or ambit of the invention and that various alterations, modifications and/or additions may be introduced into the constructions and arrangements of parts previously described without departing from the spirit or ambit of the invention.

1.-164. (canceled)

165. An apparatus comprising an arrangement of one or more acousto-electric transducers for receiving and processing of acoustic information at a measuring location at or in the region of the apparatus said apparatus having associated electronic signal processing equipment to produce a set of mutually consistent electrical signals specifically containing a measure of the wave curvature, wave divergence or wave spreading of any direct wave propagating from any acoustic source as observed at the said measuring location in space, said electrical signals being suitable for further processing, combining, separation, storage, transmission or other processing specifically considering preservation or use of said wave curvature, divergence or spreading information either relatively or absolutely, said apparatus being often described as a vector wavefront capture apparatus and said electrical signals often being described as vector wavefront electrical format or vector format by the inventor.

166. An apparatus according to claim 165, generating a set of mutually consistent electrical signals representing the divergence of any direct wave from any acoustic source as radiated from each point of occurrence in space wherein said divergence information is used as the measure of the distance of each source and having been processed, stored transmitted or otherwise dealt with being suitable for later recreation of waves representing the said distance information of the sources whether consistently or otherwise with direction information or independently.

167. An apparatus according to claim 166 generating a set of mutually consistent electrical signals representing the divergence of the direct wave from any acoustic source as observed at the region of occurrence in space wherein said electrical signals specifically incorporate distance information being suitable for later recreating the said sources consistently when listened to from anywhere within a defined listening area.

168. An apparatus according to claim 166 generating a set of mutually consistent electrical signals representing the divergence of any direct wave from any acoustic source as observed at the region of occurrence in space wherein said electrical signals specifically incorporate distance information being suitable for later recreating each source consistently when the reproduction apparatus is not necessarily at the or any point of origin of the original occurrence of the sound source, particularly with respect to distance.

169. An apparatus for signal processing able to receive a set of mutually consistent electrical signals representing the divergence or distance of a direct wave from an acoustic source as observed at a region of occurrence in space according to claim 166 wherein said electrical signals specifically incorporate distance information being suitable for recreating each source consistently, said signal processing apparatus being located either locally or remotely for receipt of transmission of said electrical signals for processing and subsequent reproduction of each source consistently with regard to divergence or distance.

170. An apparatus according to claim 169 wherein multiple formats of source signals including channel associated or equidistant sources such as but not restricted to stereo, 5.1, 6.1, 7.1, 10.2 being equi-distant or surround systems of the art not specifically taking wave divergence or distance information of captured or reproduced sound sources into account are also catered for.

171. An apparatus according to claim 169 wherein the signal source may be from a direct or on-line source in the art or may be from a remote or local storage and retrieval system of analogue or digital form in the art such as tape recorder, CD, DVD, SACD, hard drive, flash drive or the like of the art.

172. An apparatus according to claim 169 wherein the control of operation for sound source decoding and reproduction preserving aspects of distance can be controlled or modified independently including by a form of separate source-associated authorisation accompanying the distributed audio information and specifically including aspects of sound source distance.

173. An apparatus according to claim 172 wherein aspects of user or listener control over the format of decoding is provided thus enabling control of placement of the acoustic sources to new vantage points in a listening area including aspects of zoom, pan, rotate reflect or translate consistently at or prior to the act of presentation for listening.

174. An apparatus according to claim 172 wherein control over the decoding is provided thus enabling the control of placement of the acoustic sources to form new vantage points in the listening area including aspects of zoom, pan, rotate, reflect or translate consistently either remotely or by the user or both and optionally being subject to control in part or totally by some form of source associated authorisation, having but not limited to the ability to operate without authorisation for channel associated decoding but requiring authorisation for paired electro-acoustic transducer decoding of the invention for example.

175. An apparatus according to claim 166 able to create a set of formatted electrical signals by suitable coding of a set of mutually consistent electrical signals representing divergence being a measure of distance of a direct wave from one or more acoustic sources at a point in space and so represents the distance of said source said formatted electrical signals representing the divergence of a direct wave being suitable for recreating any number of independent sound sources consistently by use of a set of electro-acoustic transducers, said formatted electrical signals being able to be produced at least in pairs with specified amplitude and phase between said pairs specifically designed for feeding to a set of electro-acoustic transducer pairs being of suitable form; and number of said electro-acoustic transducers, not directly linked to the number of source or distributed channels and not restricted in any manner other than to form said multiple pairs, but said decoding using the actual location of the electro-acoustic transducers in the reproduction environment in order to use the intrinsic divergence from said transducer pairs through air in the listening environment and so recreate the desired fields and reproduced source locations with respect to placement of the said electro-acoustic transducer pair of the invention.

176. An apparatus according to claim 175 wherein multiple formats of source signals including channel associated or equi-distant sources such as but not restricted to stereo, 5.1, 6.1, 7.1, 10.2 of the art that do not specifically take wave divergence or sound object distance into account are also catered for.

177. An apparatus according to claim 175 wherein the signal source may be from a direct or on-line source in the art or may be from a remote or local storage and retrieval system of analogue or digital form in the art such as tape recorder, CD, DVD, SACD, hard drive, flash drive or the like.

178. An apparatus according to claim 175 wherein operation with regard to sound object placement can be controlled or modified in part or wholly by a source associated authorisation, for example having the ability to operate without authorisation for channel associated decoding but requiring authorisation for the paired displacement decoding.

179. An apparatus according to claim 175 wherein the configuration of a set of electro-acoustic transducers can be discovered or otherwise determined by the apparatus and the decoding then configured for the number and layout of the electro-acoustic transducers or transducer pairs, subject to being also controlled or modified in part or wholly by some form of source associated authorisation, user control or both, having but not limited to the ability to operate without authorisation for channel associated decoding but requiring authorisation for the paired electro-acoustic transducer decoding.

180. An apparatus according to claim 175 wherein a form of user control over the decoding is provided thus enabling the control or modification of placement of the acoustic sources to form new or different acoustic views and vantage points in the listening area, including aspects of zoom, pan, rotate, reflect or translate consistently, and optionally including allowance for varied electro-acoustic transducer placement.

181. An apparatus according to claim 175 wherein user control over the decoding is provided thus enabling the control of placement of the acoustic sources to form new vantage points in the listening area subject to being controlled in part or totally by some form of source associated authorisation, for example having but not limited to the ability to operate without authorisation for channel associated decoding but requiring authorisation for the paired electro-acoustic transducer decoding, and optionally including allowance for varied electro-acoustic transducer placement.

182. An apparatus able to receive electrical signals according to claim 166 for the purpose of recreating wavefront divergence information representing source distances and utilising pairs of electro-acoustic transducers such that the desired sound field is reproduced consistently as in the original source when listened to or acoustically viewed from anywhere in the listening area thus enabling shared audio experiences for multiple listeners over an extended listening area without a need for any personal apparatus and thus making the whole or a substantial part of the listening area an accurate sweet spot of the art, even when turning or moving.

183. An apparatus according to claim 182, together with two or more pairs of electro-acoustic transducers of the invention placed outside a reproduction environment optionally in association with a picture or image of defined extent; said apparatus and electro-acoustic transducer pair location preserving the source locations of sound when listened to anywhere in the listening area and with any listener orientation thus enabling consistent shared audio experiences for multiple listeners over an extended listening area without a need for any personal apparatus and thus making the whole listening area an accurate sweet spot of the art even when turning or moving, said configuration of electro-acoustic transducers often being referred to as Voyeur format by the inventor.

184. An apparatus according to claim 182, together with three or more pairs of electro-acoustic transducers of the invention placed in the centre of a reproduction environment in a region of space of defined extent being excluded from the listening area, said region containing an image or object, said apparatus, and electro-acoustic transducer pair placements preserving the wavefront divergence and thus the perceived source locations of sounds when listened to from anywhere outside the said region and with any listener orientation, thus enabling shared audio experiences for multiple listeners over an extended area without the need for any personal apparatus and thus making the whole listening area an accurate sweet spot of the art even when turning or moving, said format optionally being referred to as Voyeur or bubble format by the inventor.

185. An apparatus according to claim 182, together with three or more pairs of electro-acoustic transducers of the invention placed in a region in space being outside the listening area so as to partition off the listening area in the centre of said region said placement of the electro-acoustic apparatus preserving the source locations of sound with regard to wavefront divergence or perceived distance when viewed from anywhere inside the listening region and with any listener orientation thus enabling shared audio experiences for multiple listeners over an extended area and whilst turning and moving without a need for any personal apparatus and thus making the whole listening area an accurate sweet spot of the art.

186. An sound reproduction apparatus for reproduction of signals according to claim 166 wherein the electro-acoustic transducers have directivity so created to present a uniform radiation of phase consistent acoustic energy over the full extent of an intended listening area at all frequencies of interest by use of a controlled source size or aperture formed by active surface area of said electro-acoustic transducer directly or a separate aperture of restricted size and shape or by use of phase controlling acoustic directivity filters, electrical response equalisers or any combination thereof said electro-acoustic apparatus enabling reproduction of sound anywhere throughout the whole of the said listening area without undue spectral phase or amplitude degradation.

187. Two or more sound reproduction apparatus according to claim 186 at least one of said apparatus being so designed as to present a minimised or a well defined acoustic obstruction to any similar unit placed generally behind or in front with regard to the listening area direction whilst maintaining uniformly controlled reproduction over the or any desired listening area, thus enabling the use of two or more such apparatus placed non-equidistantly to consistently reproduce sound with regard to amplitude and phase over the desired range of frequencies throughout the listening area.

188. An sound reproduction apparatus for reproduction of electrical signals as acoustic waves comprising the combination of an electro-acoustic transducer with an active surface referred to variously as a piston, diaphragm or cone in the art and a separate acoustic filter said acoustic filter comprising a gas volume in a cavity formed by the bounding of one side of the cone active surface by said acoustic filter with an aperture being the only means of conveying sound, and of restricted dimensions so as to present a controlled source size in a desired acoustic radiation direction independently of the active surface size thus controlling the polar amplitude and phase radiation pattern of the acoustic energy of the combined electro-acoustic transducer in each or all directions at all frequencies and in particular the highest frequency of interest, said apparatus also serving to increase the acoustic efficiency of the electro-acoustic transducer at certain frequencies and said acoustic filter providing a low pass filter function in the art thus also reducing harmonic distortion products outside the range of frequencies of interest the desired overall frequency response optionally being maintained or modified as desired by an electrical equalisation circuit, said apparatus being useful over a wide range of frequencies including infrasonic and ultrasonic taking into account the low pass filter nature of the apparatus in the dimensions of the apparatus.

189. An electro-acoustic transducer sound reproduction apparatus according to claim 188 comprising the combination of an active surface described as a piston or cone in the art, and an integral acoustic filter essentially comprising a cavity and an aperture being the only means of conveying sound, and being of restricted dimensions so as to present a controlled source size in each desired acoustic radiation direction thus controlling the polar amplitude and phase radiation pattern of acoustic energy in all directions at all frequencies of interest and in particular the highest frequency of interest, whilst the acoustic filter additionally acts as a low pass filter thus reducing harmonic distortion products outside the band of reproduction interest and may serve to increase the acoustic efficiency of the apparatus at certain frequencies whilst the desired frequency response is maintained by design of the electro-acoustic transducer and the added acoustic filter design said design optionally using an external electrical equalisation circuit as required for the desired overall frequency response.

190. An sound reproduction apparatus wherein two or more of the apparatus according to claim 188 are used each covering a separate band of desired frequencies, said total output being maintained by a crossover circuit of an electric, electronic acoustic or electro-acoustic nature, and an equalisation circuit in the art, said apparatus being co-axially mounted and each forming part of the acoustic filter cavity and the aperture so described.

191. An sound reproduction apparatus comprised of two or more electro-acoustic apparatus according to claim 180 so configured to provide a uniform radiation of phase consistent acoustic energy over an extended listening area at all frequencies of interest and with minimum variations in level over the extent of the said listening area wherein some or all transducers can simultaneously receive the same or different signals enabling the operation of each or groups of said electro-acoustic transducers independently thus varying the coverage of the listener area whilst still controlling wavefront divergence representing sound object distances, said overall apparatus sometimes being described as segmented or sectored by the inventor.

192. An electrical apparatus capable of decoding signals containing divergence and so specifically distance information used in conjunction with the apparatus of claim 187 said electrical apparatus being often described by the inventor as a vector format decoder and with render control and with amplifiers of the art as appropriate.

193. An electrical apparatus capable of decoding signals containing divergence and so specifically distance information used in conjunction with the apparatus of claim 192 said electrical apparatus having a user interface enabling static preset or dynamic adjustment of the rendered sound characteristics particularly with regard to relative distance of any source of the resultant reproduced sound field.

194. An electrical apparatus capable of decoding signals containing divergence and so specifically distance information used in conjunction with the apparatus of claim 192 said electrical apparatus being fed said or any set of signals by loudspeaker channel associated or other means, whether or not being transmitted, recreated or decoded by any electronic means of the art.

195. A sound reproduction apparatus comprising at least two electro-acoustic transducers according to claim 187 with suitable frequency response including maintaining this response over the desired field of listeners, said apparatus configuration also being described as being paired, each transducer covering approximately the same range of frequencies, said two transducers being so configured as to be non equidistant from the listener area and with the means to control the signals fed to an electro-acoustic transducer enabling control of the overall divergence a wave-front for reproduced sound over the intended listening area thus effectively being able to control the perceived or measured distance of An sound source originally comprising the sound field being of any nature including multi-sources multi-tone or complex spectral nature whilst covering the entire desired listening area with all frequencies of interest without significant variation in frequency or phase response and so consistently presenting said wave divergence behaviour said sound sources thus being able to be perceived observed or measured as being at consistent distances in space relative to the listener or listener area for all listeners anywhere in the listening area and whilst turning and moving, and wherein said consistent distances range from being in front of the nearest apparatus to being well behind the apparatus including being at the acoustic horizon or acoustic vanishing point as often described by the inventor when such sources are reproduced utilising parallel wavefronts covering the extent of the listening area, said non-equidistant configuration of said electro-acoustic transducers with regard to the listening area sometimes being described as end-fire arrays by the inventor.

196. Two apparatus according to claim 195 comprising at least pairs of electro-acoustic apparatus configured to reproduce sounds at a location in space perceived as having both direction and distance being in two dimensions, said configuration placing the apparatus at two or more angles in a location addressing the desired listening area and wherein the radiation pattern of the apparatus covers the entire desired listening area over all frequencies of interest without significant variation in frequency response of the art and An sound source is reproduced within the defined area between the two or more apparatus, the sound image in said space being correctly located in two dimensions said region or area for all listeners in the listening area even whilst turning or moving and with each pair of electro-acoustic transducers not being equidistant from the listening area or any location therein.

197. Three or more apparatus according to claim 195 comprising at least pairs of electro-acoustic apparatus so configured as to provide the ability to reproduce sounds at locations in space perceived as having both direction and distance in two dimensions, said configuration placing the apparatus at differing angles to the listening area wherein the radiation pattern of An apparatus covers the entire desired listening area with all frequencies of interest without significant variation in frequency response of the art and a sound source is reproduced within the defined area between the two apparatus, said reproduced sound image in space being correctly located in three dimensions for a listener anywhere in the listening area even whilst turning and moving, and each electro-acoustic transducer of said pair not being equidistant from the listening area or any location therein.

198. Three or more pairs of electro-acoustic apparatus according to claim 191 so configured as to provide the ability to reproduce sounds at set locations in space perceived as having both direction and distance in three dimensions, said configuration placing the apparatus at three or more angles to the listening area wherein the angles do not define a plane, the radiation pattern of An apparatus pair covers the entire desired listening area, with all frequencies of interest without significant variation in frequency response and a sound source is reproduced within the defined area between the two apparatus, said reproduced sound image being correctly located in space for a listener in the listening area and each said electro-acoustic transducer pair not being equidistant from the listening area or any location therein.

199. A sound reproduction apparatus comprised of two electro-acoustic apparatus sets according to claim 191 configured to have at least three sectors and to provide a uniform radiation of phase consistent acoustic energy over an extended listening area at all frequencies of interest and with minimum variations in phase and amplitude over the extent of the said listening area when all transducers are operated and also enabling the independent operation of the each any or all of the said sectors of electro-acoustic transducer sets. being so placed to form electro-acoustic transducer set pairs about the apparatus and being placed in correspondence with each sector thereof, each said sound reproduction apparatus reproducing acoustic wave-fields for sound objects that are everywhere consistent for a listener at any location and for any orientation in the said listening area said apparatus capable of reproducing controlled divergence wavefronts when used in conjunction with other suitable apparatus.

200. A sound reproduction apparatus according to claim 191 being so placed to form electro-acoustic transducer set pairs with an apparatus being placed in correspondence with each sector thereof without restriction, each said sound reproduction apparatus reproducing acoustic wave-fields for sound objects that are everywhere consistent for a listener of at any location and for any orientation in the said listening area and being able to render sound fields with distance as well as direction of placed sound objects being preserved when provided with appropriate signals, said placement being consistent throughout the listening area for all listeners even when turning or moving and not requiring worn apparatus.

201. An electro-acoustic apparatus according to claim 191 wherein consistent presentation of a direct sound of An reproduced acoustic object in three dimensional space can be achieved throughout a desired listening area for any listener in all directions at all frequencies of interest being maintained in front of, when passing and behind the axis of any of the electro-acoustic apparatus without the need for any worn apparatus for An listener.

202. An electro-acoustic apparatus according to claim 201 wherein the consistent presentation of the direct sound of a reproduced acoustic object in space throughout a listening environment for a listener in all directions at all frequencies of interest is maintained with a minimum of three sectors, each of one pair of electro-acoustic transducers said apparatus capable of providing uniform sound radiation pattern in all directions of interest or to all locations in the listening area.

203. An electro-acoustic apparatus according to claim 201 used for restricted listener area coverage, whether in bounded or unbounded environments, or used for reproduction of sound fields not constructed from or based on wave divergence or source or reproduced distance information of the invention whether knowingly or unknowingly.

204. An electro-acoustic apparatus according to claim 196 wherein the consistent presentation of the direct sound of a reproduced acoustic object in space throughout a listening environment for a listener in all directions at all frequencies of interest is maintained with a minimum of three sectors each comprising a pair of electro-acoustic apparatus, and wherein each any or all of the said apparatus utilise one or more listening region boundaries including but not restricted to the floor and ceiling as well as walls, partitions or other structures and the meeting lines and points thereof to form An controlled sound field often referred to as a point source image in the art.

205. An electrical apparatus capable of decoding the common set of signals according to claim 166 for render to any particular set of apparatus previously, and also being able to be used to decode signals for any other electro-acoustic apparatus including those of the prior art such as mono, stereo, surround and the like.

206. An electrical apparatus capable of decoding signals according to claim 166, said control unit having a user interface enabling static or dynamic adjustment of the rendered sound characteristics particularly with regard to relative placement at a distance in a direction including aspects of zoom, rotate, pan, tilt, reflect or translate at the point of use or remotely or aspects of both.

207. An electrical apparatus capable of decoding signals according to claim 166 said control unit being fed a set of channel associated signals in the art, whether or not being transmitted, recreated or decoded by any electronic means in the art, and also including backward compatibility of the art or otherwise.

208. An electrical apparatus that optionally includes digital processing that measures the acoustic response of any defined environment containing one or more sources and produces signals according to claim 166 representing the parameters of location in particular including wavefront divergence representing distance as well as direction for said sources, and optionally the specular and diffusive component parts and spectrum behaviour with time for an early reflection in a source environment said signals being in a suitable form for subsequent recreation or render at the point of use optionally including early reflection and reverberant field of the art for the sources said apparatus thus enabling characterisation of the said environment for consistent reproduction of the early reflection components from the direct sound of sources in a listening environment enabling correct perception of said early reflections by a listener anywhere and at any orientation in a listener area even when turning or moving without any worn apparatus being required for the listener.

209. An acousto-electronic apparatus that produces electrical signals according to claim 166 specifically including distance information of all the waves from sound sources being directly received from sources or waves from early reflections of sound waves from said sources being described as virtual sources in the art or reverberant sound field components of sound waves from said sources or any combination thereof for transmission and subsequent recreation or render at the point of use, used in conjunction with a signal processing apparatus capable of reproduction of the direct sound of said early reflection placed in space in a listening environment for correct perception by a listener anywhere and at any orientation in a listener area without any worn apparatus being required.

210. An acousto-electronic apparatus according to claim 209 that captures wavefront information for early reflection with regard to location, specular and diffusive directional component parts and spectrum behaviour with time and produces electrical signals representing these early reflections for transmission and subsequent recreation or render at the point of use, with a signal processing apparatus capable of reproduction of sound source placed at a distance and in a direction including creating the placed virtual sources of said early reflections placed in space in a listening environment for correct perception by a listener anywhere and at any orientation in a listener area without any worn apparatus being required for a listener, and including consistent spatial behaviour when interacting with the waves directly form the placed sources themselves.

211. An electronic apparatus for transmission of electrical signals representing parameters according to claim 166 for subsequent recreation or render at the point of use, with a signal processing apparatus capable of reproduction of direct sound, early reflection or reverberant sound fields placed in space particularly with regard to distance in a listening environment for correct perception by a listener anywhere and at any orientation in a listener area without any worn apparatus being required.

212. An acoustic apparatus according to claim 187, rendering and so placing virtual sources for the early reflections of the art as a reproduced acoustic object placed anywhere in space throughout a listening environment representing virtual apparent sources within and beyond the boundaries of the listening environment according to the parameters of an early reflection each said object to be correctly perceived by a listener anywhere in a listening area and at any orientation without any worn apparatus being required for said listener and including correct spatial behaviour when interacting with the direct waves from the reproduced sources.

213. An acoustic measuring apparatus according to claim 166 placed in any partially or fully reflective sound field environment experiencing sound waves comprising microphone elements of the art whereby regions of predominantly divergent or convergent acoustic field particle velocity or pressure waves in a particular direction in a sound field can be indicated at any particular frequency of interest by movement of the said apparatus in the sound field, said apparatus thus indicating said node or anti-node points at the corresponding frequency for the said reflective environment using a suitably varying display and said apparatus being suited to location of optimised low frequency coupling locations for sources and the listener area for the initial or early or early reflected wave focused by a barrier to sound of the said reflective environment.

214. An wave modelling apparatus that considers the wave focussing effect of any partial or fully reflecting boundaries of a building, room, wall, pillar or any other sound influencing structure and so determines the early sound field wave delivery to any point or through any region in space with time according to the rule of centroid moments or rule of centroids of the inventor, so identifying the corresponding pairs of locations for first or early wave convergence, said model be used to alter improve optimise or otherwise change the geometry of the said structure for wave delivery to any point or region in time and space in the listening region by variation of the nature and geometry of the listening area boundaries, and said rule of the method of centroids stating that the first region of reflected wave convergence from a placed source corresponds to resolving the first moment of the source location about the centroid of the influenced gas within the said partially or fully enclosing acoustically reflecting structure

215. An apparatus for determining low frequency acoustic loss in or from a partially or fully acoustically reflective bounded listening area over a range of frequencies by comparison of the modelled predicted intensity of the focussing of the early sound field wave at the listening location according to claim 214 and comparing the result to the measured coupling utilising the sound field apparatus of claim 214 or other means, said loss being the difference of the two results when considered at any desired frequency.

216. An apparatus according to claim 213 used to determine the location of and so avoid room mode locations with source to listener coupling according to the method of centroids of the inventor to thus provide minimal influence from room modes at the desired listening locations.

217. An electro-acoustic reproduction apparatus that reduces or eliminates low frequency mode influence in a partially or fully reflectively bounded reproduction environment by the mechanism of annihilating reflected sound recognising the boundary focussing capability identified in claim 214 for source and listening area location in any partially or fully bounded environment, taking into account the reflective nature of the environment and where the low frequency loudspeaker source is fed a signal that is initially the desired sound to be reproduced and then uses suitable signal processing to create a time delayed signal that partially or fully annihilates the on-reflected wave returning from the listening environment to the low frequency loudspeaker source according to the rule of the method of centroids of the invention after two propagation periods by the means of anti-phase signal of suitably scaled magnitude and phase, said apparatus thus being able to dynamically remove acoustic energy from the reproduction environment prior to excitation of modes.

218. An electro-acoustic reproduction apparatus that reduces or eliminates low frequency room modes in a partially or fully reflectively bounded reproduction environment by use of the method of centroids according to claim 214 for any fully or partially reflecting boundary by the mechanism of partially or completely annihilating reflected sound independently of listening area location wherein a bounded listening environment having a largely reflecting acoustic boundary for the boundary opposite the loudspeaker sources has electro-acoustic transducer or loudspeaker sources so designed, arrayed and fed signals to produce a largely plane wave low frequency sound field over all of the reproduction environment including the target listening area, said sound field propagating past all listeners, being plane reflected and returning to the source loudspeaker array as a largely planar wave which is then annihilated by the original source loudspeakers with suitable signal processing including inverted delayed versions of the original signal.

219. An apparatus according to claim 218 wherein the source is located at or near the ceiling or roof and the reflecting boundary is the floor, a listener seated or standing in the listening area thus receiving two passes of the low frequency wave in quick succession below the level of perception of the waves as separate events and all listeners receiving simultaneous arrival of the wave field, the arrival time of which can also be adjusted by the apparatus controlling the degree of annihilation and wherein the listening environment may be zoned, with each zone having its own suitably placed source array and local floor as reflector, the arrival time of which can also be adjusted independently for each zone by the apparatus controlling the annihilation for each zone separately, thus enabling simultaneous arrival for all listeners in all zones.

220. An electro-acoustic apparatus comprising multiple electro-acoustic transducers with at least one active radiating diaphragm or cone surface, each said apparatus covering the same band of frequencies, said transducers mounted so as to couple the wave from one side of the electro-acoustic transducer active surface to a common chamber by whatever means, wherein a restriction in the form of an orifice is introduced in acoustic proximity to each said active surface thus forming a chamber acoustically towards said active surface with respect to the said common chamber the combination forming a generally low-pass filter in the art so designed as to allow generally unrestricted alternating gas flow in the pass-band of the art towards the common chamber, said orifice then presenting a restriction to alternating gas flow in the art for said alternating gas flow from said active surface towards the, each or all other electro-acoustic transducer active surface accessing the common chamber being suitable for increasing the effectiveness or efficiency of the overall apparatus for the reproduction of sound in the desired pass-band by reduction of cross transducer cone loading for the desired band of frequencies.

221. An electro-acoustic apparatus according to claim 220 comprising wholly or in part multiple electro-acoustic transducers, said transducers mounted so as to couple the wave from one side of An electro-acoustic transducer active surface to a common chamber, wherein a restriction in the form of an orifice of generally restricted size relative to the said active surface and being the only access path for alternating gas flow is constructed in acoustic proximity to said active surface of an electro-acoustic transducer as part or added to each said transducer to from a composite electro-acoustic transducer apparatus with a chamber acoustically towards said active surface with respect to the said common chamber said combination forming a generally low-pass filter in the art so designed as to allow generally unrestricted alternating gas flow in the pass-band towards the common chamber, said chamber being optionally so constructed to use the method of gas centroids of the inventor treating the enclosure as a bounded space in order to couple acoustic energy to an exit orifice from said chamber acoustically towards the listening area, wherein said gas centroid location so calculated is that for the said chamber being suitable for improving the efficiency and effectiveness of said apparatus over the desired frequency range by minimising the effects of chamber resonant modes.

222. An electro-acoustic apparatus according to claims 221 wherein there is direct coupling of the apparatus to the listening environment thus considering the listening room to be that described as the chamber and wherein a low frequency electro-acoustic transducer and associated resonant structure between one active surface and the listener area with restricted cross-sectional area is so designed to increase sound velocity and so increase the effective sound energy delivery to the acoustic load of the listening environment over a desired band of frequencies, said apparatus comprising a complementary electrical filter or equaliser of the art wherein the transfer function for the electro-acoustic apparatus response is designed to be equalised overall, said apparatus having any number of said electro-acoustic transducers, said apparatus being used in conjunction with the method of centroids of the inventor for the room or otherwise.

223. An electro-acoustic apparatus according to any one of claims 221 wherein the electro-acoustic transducers are so placed relative to each other whether in pairs or otherwise such that the net force on the overall apparatus from the movement of the active surfaces acting in concert is intentionally minimised, conveying minimum net acceleration force to the enclosure or the overall apparatus or surroundings of the apparatus, thus minimising undesirable vibrations.

224. An electro-acoustic apparatus of claim 221 wherein the other side of the active surfaces present to a region outside the listening region including the listening area and is acoustically treated differently by means of intentionally increasing the size of an aperture or orifice including but not restricted to the use of a tube, vent or port and intentionally increasing the separation between any two such orifices such that the subsequent concentration of acoustic energy in the region outside the boundary of the bounded region including the listening area is thus minimised in any bounded region thereon according the rule of gas centroids of the inventor or any region outside the boundary of the bounded region that includes the listening area, whilst still accurately preserving the total gas volume velocity in the art to be the same to both regions over the desired band of frequencies and where acoustic radiation due to leakage from the bounded region is intentionally minimised and may ultimately become zero away from all bounded regions by the method of cancellation of the overall volume velocity from the front and the rear of An electro-acoustic transducer in the art.

225. An electro-acoustic apparatus for reproduction of sound without having apparent perceived source direction according to a listener throughout a listening environment including fully, partially or unbounded or open environments and including when said listener is immediately adjacent to said apparatus, said apparatus comprising a set of transmissive half wave resonant structures of differing tuning and supporting large number of resonant harmonic overtones, said resonant structures being so combined as to present some degree of acoustic mismatch for each incident acoustic wave and so behaving as partially reflective whilst also behaving as partially transmissive in allowing part of the said acoustic wave to enter the structure and propagate there-through, and again behaving as partially reflective and partially transmissive in a frequency selective manner at the point of the incident acoustic wave subsequently leaving the apparatus, the overall effect including frequency dependent transmission and reflection components with the said impedance mismatch at the points of entry and exit being augmented by the interacting influence of the adjacent acoustic resonant structure and the rigid boundary parts there associated at the point of entry and exit for the said half wave resonant structure, said structures being in close proximity, and the resonances being related to the apparatus dimensions rather than any incident acoustic wave giving an amplitude and phase behaviour influence unrelated to the source, radiation from An half wave section acting as a source in itself placed at the location of any said half wave resonant section entry and being designed to provide the desired spectral and spatial acoustic energy distribution, and exit points and said half wave resonant structures being so designed as to avoid unwanted resonance behaviours in the desired band of frequencies of operation by suitably small choice of cross section dimension of the said resonant structures, said apparatus also being referred to as the whiteroom loudspeaker by the inventor.

226. An electro-acoustic apparatus according to claim 225 wherein the lengths and configuration of the half wave resonant structures is so chosen such that the overall spectral energy of the acoustic waves passing there-through and there-from is in accordance with the source wave but where the phase relationships of the original sound source are not preserved, the acoustic sound field emanating there-from being variously described as diffusive, dispersive, de-correlated, enveloping or immersing in the art said configurations including but not restricted to various sections of half wave resonant structures that are straight, bent, folded or curved.

227. An electro-acoustic apparatus according to claim 225 used in connection with other dispersive apparatus including but not restricted to quarter reflective diffusers, electronic multi-resonant panel loudspeaker apparatus and electronic signal processors providing dispersive effects in the art.

228. An electro-acoustic apparatus according to claim 225 wherein the various lengths of the half wave acoustic resonators are so designed to have axial cross-sectional profiles that vary and so provide the desired response.

229. Two or more of the apparatus according to claim 225 used in combination, such configuration being in series or in parallel or in combinations thereof with regard to the incident and propagated acoustic waves, said structure being designed to provide the desired spectral and spatial acoustic energy distribution and said dispersive combination being variously described as a leaky transmission line or structure or diffuser in the art.

230. An electro-acoustic apparatus according to claims 225 wherein the apparatus is so configured to take advantage of an acoustic specular, diffusive or other reflective surface such as an environment boundary, said apparatus making use of the acoustic image thus created to provide the desired spectral and spatial response without the need for additional half-wave resonant structures.

231. A method of construction of the apparatus of 226 wherein a half wave resonant structure is made of suitable cross-section multi-tubular structure of circular, square, triangular, hexangular or other regular cross-section structure and is fabricated or extruded in the art then shaped and cut to a profile that creates the desired spatial and spectral response, said ends of each resonant structure being either square or non-square cut profile and suitable end correction calculations being made for the resonant frequencies.

232. An electro-acoustic apparatus according to claim 226 wherein the sound source is an electro-acoustic transducer of suitable response capabilities forms a source of sound from the fed electrical signals described as a dipole source in the art and said apparatus is variously described as a diffusive source loudspeaker, diffusive loudspeaker, diffusive source un-locatable loudspeaker or whiteroom loudspeaker.

233. An electro-acoustic apparatus according to claim 226 wherein the sound source is an electro-acoustic transducer of suitable response capabilities and said acoustic filtering apparatus is used to correct frequency response amplitude and directivity anomalies as well as to support the claims made of dispersive or diffusive source nature.

234. An apparatus to model the behaviour of the apparatus of claim 226 in software or by other means and so provide any structure dimensions in response to entering of the desired spatial and spectral design requirements, said apparatus in part utilising any or all of the method of distributed parameter modelling and the method of residues for higher order multi-resonances.

235. An audio apparatus using one or more of digital, analogue or active or passive signal processing capabilities for audio signals from channels of a multi-channel audio signal source so as to provide a summed signal representing all of the sound sources in the original sound field contributing to the reverberant sound field being suitable for feeding said signal to the apparatus described in claim 226 for reproduction, said apparatus being with or without other electronic reverberation techniques of the art including but not restricted echo and said apparatus being also described as a reverberant sound field manager by the inventor.

236. An electrical apparatus according to claim 235 processing the signals from the desired sound sources having parameters representing the desired reverberant field decay time and associated time variant spectrum and used to provide the correct source decay characteristic for any corresponding or any derived channel of multi-channel electrical signals representing sound sources so as to provide a summed signal representing all of the sound sources present in the original sound field and so contributing to the reverberant sound field, said apparatus being suitable for feeding said signal to a reverberant sound field reproduction apparatus for reproduction, wherein reverberation parameters can be changed to provide audio reverberation scenes and scene change transition points, said apparatus also sometimes being described as a parametric reverberation manager by the inventor.

237. The apparatus of any of claims 226 used to actively mask the acoustic characteristics of any listening environment including open, partial or fully bounded spaces whilst optionally conveying useful acoustic information such as speech or music.

238. An electrical apparatus according to claim 187 wherein the amplitude and phase of the signals fed to each electro-acoustic transducer in a pair is such that the resulting divergence of the overall vector acoustic wave so created places the resultant perceived sound at appropriate distances relative to the reproduction apparatus in the listening environment and wherein the decoding and array conditioning parts for the signal processing provide separate processing to cater for an array pair of devices and their relative spacing to allow for local apparatus variations whilst providing a standardised or reference render decoding, said reproduction distance not being constrained to being an apparent source between said electro-acoustic transducers but capable of render from well in front of said apparatus to well behind said apparatus as perceived from the listening area by appropriate control of said amplitude and phase with frequency for an electro-acoustic transducer pair according to the method, including the generation of parallel wavefronts representing sources a long way behind the apparatus also referred to as the acoustic horizon or vanishing point by the inventor and said listening environments including fully, partially or unbounded or open environments.

239. An electrical apparatus according to claim 238 wherein the reference render placement is chosen to be the horizon or vanishing point and is often described as reference distance decoding by the inventor and with any local or array correction for wavefront divergence or distance render often described as the local or array correction or point of use render by the inventor, said approach enabling broadcast of standard material to many listeners.

240. A point of use render control apparatus according to claim 238 that enables correction of wavefront divergence or apparent source location for any array apparatus placement by adjustment of array divergence behaviour to move the apparent locations of rendered objects with regard to translation, rotation, zooming, reflection or other requirement thus enabling the movement or placement of array apparatus at locations convenient to the listener whilst retaining the ability to correctly establish a desired acoustic field over the intended listener area by this method of apparent source movement using to achieve this, whether manually or partially or fully automatically.

241. The apparatus according to claim 238 wherein the source material or part thereof does not have source distance information considered or preserved at capture, during distribution or at reproduction whether intentionally or not and including such formats as stereo, 5.1 and the like being equidistant or surround formats of the art and wherein these said formats are decoded to a set distance with or without user control thus ensuring both forward and backward compatibility of the art for all available material with the present invention.

242. The apparatus according to claim 238 wherein the source material or part thereof may have source distance information considered or preserved at capture, during distribution or at reproduction whether intentionally or not including such formats as wave field synthesis and the like being broad-fire array formats of the art or any other like formats presently and wherein these said formats can decode to a set distance by any means including with or without user or remote control for reproduction using any, some or all of the claims of this invention enabling capture, encoding, transmission or decoding render and reproduction thus ensuring both forward and backward compatibility of the art for this material and format with the present invention.

243. An electrical apparatus according to claims 238 wherein the control apparatus for render therein described in part enables reduction of the physical separation between any all or each electro-acoustic transducers in a pair as described and also enables adjustment to the relative location of said pairs by processing the signal for said pair or sets of pairs to allow for such variations whilst providing uniform or intended coverage of the intended listening area with apparent and measurable placement of said sound images from being well behind the rear-most to in front of the forward-most electro-acoustic transducer of An pair and any locations in between, when perceived from the intended listening area for An listening location.

244. An electrical apparatus according to claims 238 wherein the each or any electrical signals presented to said apparatus may be delivered by channel embedded means including being as part of the actual encoded or otherwise delivered audio, by channel associated means including but not limited to formats such as stereo, 5.1 or the like or delivered by non channel associated means or any one or more such means in combination and sometimes referred to as metadata by the inventor.

245. An electrical apparatus according to claim 238 receiving source material with or without wavefront divergence or distance coding.

246. An electrical apparatus according to any of claim 238 able to receive electro-acoustic signals in a common or vector format as described and appropriately decode said signals either locally or remotely or using aspects of both for reproduction on said apparatus wherein the perceived location of a reproduced sound source is able to be placed under user control at the point of use so as to enable manipulation of the rendered sound field including but not limited to aspects of panning, dollying, zooming, translation, reflection or rotation whilst retaining at least some consistency of sound source behaviour particularly with regard to relative location when the listener turns or moves anywhere in the listening area.

247. An electrical apparatus according to any of claims 238 wherein said apparatus is able to receive electro-acoustic signals and appropriately decode said signals either locally or remotely for reproduction on said apparatus and wherein the perceived or measured location of An intended sound source is able to be influenced or altered under remote director or other agent control or under local control or both at the point of use including but not limited to aspects of panning, dollying, zooming, translation, reflection or rotation whilst retaining at least some consistency of sound source behaviour particularly with regard to relative location when An listener turns or moves anywhere in the listening area, and specifically including such manipulation of source material containing some or not containing any relative source distance information.

248. An electrical apparatus according to claim 238 able to receive electro-acoustic signals in a channel associated format and appropriately decode said signals for reproduction on suitable apparatus taking distance into account and maintain backward compatibility with other formats including equi-distant or surround formats of the art, said decoding able to either have or not have placement effects wherein the perceived location of An intended sound source is able to be placed under local user or remote director or other agent control at the point of use, such relative placement being able to be at least partially preserved as required.

249. An electrical apparatus comprising amplitude and phase filters controlling spatial transfer function for any location on or with regard to an acoustically opaque object or defined collection of objects each with fixed relative location defined with respect to any impinging acoustic representing a wave qualified with respect to source distance including but not limited to a point source at a distance in a direction or a plane wave representing a source at the acoustic vanishing point in a direction, said filters often being referred to as acoustic object related transfer functions and sometimes abbreviated to ORTF by the inventor, said filters specifically considering distance as described and as qualified by the wave divergence, swelling or curvature as previously described, and said filters able to process signals to provide for or to compensate for said transfer function or elements of both, said collection of objects including the effect of one or more said objects obscuring, blocking or otherwise modifying sound in a particular direction by virtue of its shape or size or placement.

250. An electrical apparatus comprising filters according to claim 249 wherein advantage is taken of any acoustic symmetry of the said acoustically opaque object in order to simplify the filter structures or requirements.

251. An electrical apparatus according to claims 249 wherein the said acoustically opaque object is a human head and the point of interest is An ear with location being variously specified as the pinnae, canal or eardrum, said filters often being referred to by the inventor as ear related transfer functions or ERTF to distinguish said filter structures from head related transfer functions or HRTF of the art which are measured with regard to the centre of the head so do not consider the directional properties of the ear and head independently and do not intentionally or otherwise consider distance aspects of the transfer functions.

252. An electrical apparatus according to claim 249 used in conjunction with any apparatus to capture, process, encode, decode render or reproduce electrical signals representing sound sources taking distance into account through wave divergence. spreading or curvature.

253. An electrical apparatus according to claim 166 intended for personal use

254. An electrical apparatus according to claim 238 intended for personal use

255. An electro-acoustic apparatus according to claim 186 intended for single listener personal use wherein at least two electro-acoustic transducers are placed relatively to form a controlled acoustic field with respect to wavefront creation towards the listener,

256. Two or more such apparatus according to claim 255 each intended to provide acoustic signals to a particular listener ear and described as binaural in the art.

257. An apparatus of claim 255 intended to fit over the listeners pinnae, optionally offering some sound isolation by nature of acoustically opaque physical structure or by annihilation or both.

258. An apparatus of claim 255 intended to fit into the listener pinnae, optionally offering some sound isolation by nature of acoustically opaque physical structure or by annihilation in part.

259. An apparatus of claims 255 intended to fit into the listeners ear canal, optionally offering some sound isolation by nature of acoustically opaque physical structure obstructing said canal or by annihilation in part.

260. An electrical apparatus according to claim 238 for personal use with over pinnae, in pinnae or in canal electro-acoustic transducers wherein the apparatus decodes vector format of the invention or other signals and optionally corrects for the acoustic behaviour of the electro-acoustic pair and the influence of the local environment and the or any requirement for filtering whilst optionally enabling reduction of the physical separation between An electro-acoustic transducer of said pair by processing the signal for any pair said apparatus providing apparent placement of said sound images from well behind the rearmost electro-acoustic transducer to in front of the forward most electro-acoustic transducer and all locations in between, when perceived by the listener.

261. The each or any electrical apparatus according to claims 260 wherein the apparatus is controlled or modified locally at point of use, remotely or any combination thereof.

262. An apparatus according to claim 260 used with material not having regard to preservation of source distance information including but not limited to stereo, surround 5.1 and the like thus being described as backward compatible in the art.

263. An apparatus according to claim 260 providing facilities under either local, or remote or both control enabling panning, dollying, zooming, translation, reflection or rotation of the resultant rendered sound field of the invention.

264. An apparatus according to claim 260 used in conjunction with ear related transfer function filters specifically considering distance information of sound sources together with listener rotation or translation detecting devices that can alter the filtering in response to each or a combination of moving or turning and thus alter the rendered field placement in response to said movement or turning, said altering including the ability to place sound objects perceived as fixed in space irrespective of the said listener movement or turning.

265. An apparatus according to claim 249 for personal use wherein the filters are used in part to correct for the acoustic behaviours of external apparatus such as helmets, vests, suits, vehicles or the like and still present a sound field to the listener with consistent treatment of distance and direction.

266. An acousto-electric apparatus according to claim 166 so configured to capture distance as well as direction information for any sound source and comprising at least two microphone elements arranged in conjunction with an acoustically opaque boundary construction of the apparatus said apparatus used in conjunction with filters to compensate for said opaque structure and determine and extract wave divergence information representing source distance in each any or all directions, and specifically including the case where the apparatus is made small in comparison with the wavelengths of the frequencies of interest so as to minimise any said acoustically opaque body correction requirement said apparatus often being referred to as a vector wavefront microphone apparatus and optionally outputting vector format electrical signals of the invention.

267. Two or more apparatus according to claim 266 wherein the self scaling of the distance information for the any or all sources with regard to variation in apparatus location enables the simple combination of said distance related output signals from any number of said apparatus, thus being able to expand and improve the scope of the location capability of the apparatus with regard to any or an expansive sound field of objects without limit with regard to distance aspects only.

268. An electrical apparatus according to claim 166 capable of receiving electrical or electro-optic or other form of signals and processing said signals to largely or totally preserve the directional or divergence information for the each or every sound source of interest whilst resolving said signals into a minimum set of vector signals described as orthogonal in the art, said signals being treated either separately or in combination for distance and direction aspects, said apparatus having the necessary capability to process said signal in suitable form of the invention for subsequent use in the or any suitable storage, distribution or reproduction apparatus of the art said electrical apparatus optionally having the necessary capability to supply the operational requirements of any some or all said acousto-electric apparatus.

269. An electrical apparatus according to claim 268 capable of receiving electrical or electro-optic signals and suitably processing said signals in order to derive signals suitable for vector format distribution with or without remote agent or user point of use control and suitable for the formats of stereo, 5.1 surround and the like, either automatically or under operator control, the use of said apparatus being referred to as audio post-production of the art.

270. An electrical apparatus according to claim 269 for personal use able to receive information detailing placed sound sources from remote sound fields and render said information as sound objects amongst the placed sources of the local sound field of the listener and the local environment, either under remote control or local listener control or both, said placement being able to minimise disrupting awareness of the local sound field objects perceived by the listener simultaneously.

271. An apparatus according to claim 270 used in conjunction with local or wide area communications services enabling the bi-directional communication between two or more listeners each having appropriately placed source image locations consistent with their actual relative or absolute locations, said locations being under individual listener control and said service including regional or global location and presentation services of the art including but not limited to GPS satellite, GPRS, GSM tower based or the or a multitude of other user location based services said communications services enabling awareness of presence and position even in darkness or when not otherwise visible by virtue of building, foliage or other visual obstruction.

272. An apparatus according to claim 166 used to capture sound fields at all distances in all directions for either immediate or later analysis and post production activities including separation and tracking of individual sources either manually or automatically, said apparatus being useful for acoustic forensics of the art

273. An apparatus of claim 272 wherein non-distance audio or other signals are used or catered for thus providing backward compatibility with existing services of the art, said signals also being able to be placed and moved in space as perceived by the listener by remote or local control of render placement or both, but not necessarily preserving the or any relative placements of objects within the reproduced sound field of the original.

274. An apparatus according to claim 166 used to detect the location of any unwanted sound source particularly with regard to wave divergence or distance within or external to any listening environment and the associated spectral nature of said unwanted source and to create and place a suitable annihilating sound source for such unwanted source but still applicable where the noise source or the cancelling source or both are outside the bounded area, thus minimising or eliminating the unwanted source from all locations within the target listening area.
